(19) United States
(12) Patent Application Publication
(10) Pub. No.: US 2026/0117125 A1
(43) Pub. Date: Apr. 30, 2026

(54) LIQUID CRYSTAL COMPOSITION AND DISPLAY PANEL

(71) Applicant: TCL CHINA STAR OPTOELECTRONICS TECHNOLOGY CO., LTD., Shenzhen (CN)

(72) Inventors: Yali LIU, Shenzhen (CN); Xiao LIU, Shenzhen (CN)

(73) Assignee: TCL CHINA STAR OPTOELECTRONICS TECHNOLOGY CO., LTD., Shenzhen (CN)

(21) Appl. No.: 19/021,224

(22) Filed: Jan. 15, 2025

Related U.S. Application Data
(63) Continuation of application No. PCT/CN2024/137696, filed on Dec. 9, 2024.

(30) Foreign Application Priority Data
Oct. 25, 2024 (CN) 202411506354.3

(51) Int. Cl. C09K 19/30; C09K 19/12; C09K 19/20; C09K 19/32; G02F 1/1337; G02F 1/137

(52) U.S. Cl. CPC C09K 19/3003; C09K 19/2028; C09K 19/3068; C09K 19/32; G02F 1/133703; G02F 1/13706; C09K 2019/122; C09K 2019/123; C09K 2019/124; C09K 2019/2035; C09K 2019/2042; C09K 2019/2078; C09K 2019/301; C09K 2019/3016; C09K 2019/3019; C09K 2019/3025; C09K 2019/3075; C09K 2019/3083

(57) ABSTRACT

A liquid crystal composition includes a liquid crystal compound represented by the following formula I and a chiral agent. In formula I, R₁ and R₂ are independently selected from —H, —F, —Cl, —Br, —I, —CN, —SCN, —NCS, —SF₅, an alkyl group having 1-10 carbon atoms, an alkoxy group having 1-10 carbon atoms, an alkenyl group having 2-10 carbon atoms, an alkenyloxy group having 2-10 carbon atoms, an alkynyl group having 2-10 carbon atoms, or an alkynyloxy having 2-10 carbon atoms.

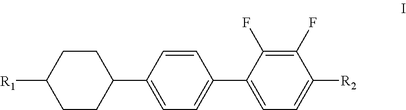

### CROSS-REFERENCE TO RELATED APPLICATIONS

This application is a continuation application of International Application No. PCT/CN2024/137696, filed on Dec. 9, 2024, which claims the priority to and benefit of Chinese Patent Application No. 202411506354.3, filed on Oct. 25, 2024, the disclosures of which are incorporated herein by reference in their entirety.

### TECHNICAL FIELD

The disclosure relates to the field of display, and in particular, to a liquid crystal composition and a display panel.

### BACKGROUND

Liquid crystal materials are widely used in various display devices such as mobile phones, televisions, and computers. Liquid crystals in a thin film transistor liquid crystal display panel (TFT-LCD) function as “light valves”, and the liquid crystals adjust the brightness of a display device by controlling the transmittance of backlight of the display device.

A traditional vertical alignment (VA) liquid crystal display panel is composed of a thin film transistor (TFT) substrate, a color filter (CF) substrate, and polyimide (PI) alignment layers and liquid crystals disposed between the TFT substrate and the CF substrate, in which vertical alignments of liquid crystal molecules are achieved through the PI alignment layers. When the voltage applied on the display device including the VA liquid crystal display panel that displays in a VA mode is 0 V, long axis directions of the liquid crystal molecules are perpendicular to the TFT substrate and the CF substrate. After passing through a polarizer disposed on the TFT substrate, natural light forms linearly polarized light. Since a polarization state and a polarization direction of the linearly polarized light cannot be changed by the liquid crystal molecules, the linearly polarized light will be absorbed by a polarizer disposed on the CF substrate, that is, incident light perpendicular to the TFT substrate and the CF substrate cannot pass through the display device, resulting in a dark display effect of the display device, and therefore, the display device in the VA mode has negative dielectric anisotropy (Δε) and high contrast.

Therefore, the transmittance of the liquid crystal display panel needs to be improved.

### SUMMARY

Embodiments of the disclosure provide a liquid crystal composition including a liquid crystal compound and a chiral agent, and the liquid crystal compound is represented by the following formula I:

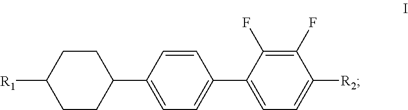

in which R₁ and R₂ are independently selected from —H, —F, —Cl, —Br, —I, —CN, —SCN, —NCS, —SF₅, an alkyl group having 1-10 carbon atoms, an alkoxy group having 1-10 carbon atoms, an alkenyl group having 2-10 carbon atoms, an alkenyloxy group having 2-10 carbon atoms, an alkynyl group having 2-10 carbon atoms, or an alkynyloxy having 2-10 carbon atoms;
one or more end groups in R₁ and R₂ are not replaced, or, one or more end groups in R₁ and R₂ are independently replaced by —CN or —CF₃;
one or more —CH₂— groups in R₁ and R₂ are not replaced, or, one or more —CH₂— groups in R₁ and R₂ are independently replaced by —O—, —S—, —CO—, —C(O)O—, —OC(O)—, —CF₂O—, —OCF₂—, —CH₂—CH₂—, —CH₂O—, —OCH₂—, —CH═CH—, or —C≡C—, and heteroatoms therein directly linked to C are not directly linked to each other; and
one or more H atoms in R₁ and R₂ are unsubstituted, or, one or more H atoms in R₁ and R₂ are independently substituted by F, Cl, Br, or I.

Embodiments of the disclosure further provide a display panel, including:
a first substrate;
a second substrate disposed opposite to the first substrate; and
a liquid crystal layer disposed between the first substrate and the second substrate, in which the liquid crystal layer is prepared from at least the liquid crystal compound and the chiral agent of the liquid crystal composition as described above.

### BRIEF DESCRIPTION OF THE DRAWINGS

In order to explain technical solutions in embodiments of the disclosure more clearly, the following will briefly introduce the drawings needed to be used in description of the embodiments. Apparently, the drawings in the following description are only some embodiments of the disclosure. For ordinary skilled in the art, other drawings can be obtained from these drawings without paying creative effort.

In order to understand the disclosure and beneficial effects thereof more completely, the following will be described in combination with the drawings. In the following description, the same reference characters indicate the same elements.

FIG. 1 is a schematic structural diagram of a display panel according to some embodiments of the disclosure.

FIG. 2 is a schematic diagram of an arrangement of a liquid crystal layer of the display panel according to some embodiments of the disclosure.

FIG. 3 is another schematic structural diagram of the display panel according to some embodiments of the disclosure.

### REFERENCE CHARACTERS

11, first substrate; 12, second substrate; 31, first alignment layer; 32, second alignment layer; 20, liquid crystal layer; 21, liquid crystal molecule; and 210, liquid crystal arrangement group.

### DETAILED DESCRIPTION

The following will provide detailed descriptions of the disclosure in conjunction with the drawings. It should be understood that the embodiments described herein are for the purpose of explaining the disclosure and are not intended to limit the disclosure. The order of description of the following embodiments below is not intended to limit the preferred order of the embodiments.

Unless otherwise specified, all terms (including technical and scientific terms) used herein have the same meanings as understood by an ordinary person skill in the art to which the inventive concept of the disclosure belongs. It can be understood that terms, such as those defined in commonly used dictionaries, should be construed to have the meanings consistent with their meanings in related art and the disclosure, and will not be construed in an idealized or overly formal sense unless clearly so defined herein.

In the disclosure, an aryl group, an aromatic group, and an aromatic ring system have the same meaning and may be interchanged.

In the disclosure, a heteroaryl group, a heteroaromatic group, and a heteroaromatic ring system have the same meaning and may be interchanged.

In the disclosure, a cycloalkyl group and a cyclic alkyl group have the same meaning and may be interchanged.

In the disclosure, “substituted” means that a hydrogen atom in a group to be substituted is substituted by a substituent group.

In the disclosure, a same substituent group at different substituent site may be independently selected from the same group or different groups. For example, if a formula includes multiple R groups, each of the R groups may be independently selected from the same group or different groups.

In the disclosure, “number of ring atoms” refers to a number of atoms constituting a ring of a structural compound obtained by atomic bonding, for example, a monocyclic compound, a fused ring compound, a cross-linked compound, a carbon ring compound, or a heterocyclic compound. In a ring substituted by a substituent group, the atoms contained in the substituent group are not included in the atoms forming the ring. The same applies to “number of ring atoms” described below unless otherwise specified. For example, the number of ring atoms in benzene is 6, the number of ring atoms in naphthalene is 10, and the number of ring atoms in thiophene is 5.

In the disclosure, “substituted or unsubstituted” means that a defined group may be substituted or not be substituted. When the defined group is substituted, it can be understood that the defined group may be substituted by one or more substituent R groups. The R groups are independently selected from, but not limited to, a deuterium atom, a cyanoyl group, an isocyanoyl group, a nitro group, a halogen atom (for example, F, Cl, Br, or I), an alkyl group having 1-20 carbon atoms, a heterocyclic group having 3-20 ring atoms, an aromatic group having 6-20 ring atoms, a heteroaromatic group having 5-20 ring atoms, —NR′R″, a silyl group, a carbonyl group, an alkoxycarbonyl group, an aryloxycarbonyl group, an aminoformyl group, a haloformyl group, a formyl group, an isocyanate group, a thiocyanate group, an isothiocyanate group, a hydroxyl group, or a trifluoromethyl group, and the groups may further be substituted by acceptable substituent groups in the art. Understandably, R′ and R″ in the NR′R″ are independently selected from, but not limited to, H, a deuterium atom, a cyanoyl group, an isocyanoyl group, a nitro group, a halogen atom (for example, F, Cl, Br, or I), an alkyl group having 1-10 carbon atoms, a heterocyclic group having 3-20 ring atoms, an aromatic group having 6-20 ring atoms, or a heteroaromatic group having 5-20 ring atoms. In some embodiments, R is selected from, but not limited to, a deuterium atom, a cyanoyl group, an isocyanoyl group, a nitro group, a halogen atom (for example, F, Cl, Br, or I), an alkyl group having 1-10 carbon atoms, a heterocyclic group having 3-10 ring atoms, an aromatic group having 6-20 ring atoms, a heteroaromatic group having 5-20 ring atoms, a silyl group, a carbonyl group, an alkoxycarbonyl group, an aryloxycarbonyl group, an aminoformyl group, a haloformyl group, a formyl group, an isocyanate group, a thiocyanate group, an isothiocyanate group, a hydroxyl group, or a trifluoromethyl group, and the groups may further be substituted by acceptable substituent groups in the art.

In the disclosure, “an aryl group or an aromatic group” refers to an aromatic hydrocarbon group derived from a basis of an aromatic ring compound removing one hydrogen atom. The aromatic hydrocarbon group may be a monocyclic aryl group, a fused ring aryl group, or a polycyclic aryl group. For a polycyclic ring type, at least one ring is an aromatic ring system. For example, “a substituted or unsubstituted aryl group having 6-40 ring atoms” refers to an aryl group having 6-40 ring atoms, a substituted or unsubstituted aryl group having 6-30 ring atoms, a substituted or unsubstituted aryl group having 6-18 ring atoms, or a substituted or unsubstituted aryl group having 6-14 ring atoms, and the aryl group is optionally further substituted. Suitable examples of the aryl group or the aromatic group include, but not limited to, a phenyl group, a biphenyl group, a triphenyl group, a naphthyl group, an anthracyl group, a phenanthryl group, a fluoranthenyl group, a triphenylene group, a pyrenyl group, a perylene group, a tetraphenyl group, a fluorenyl group, an acenaphthenyl group, and derivatives thereof. Understandably, multiple aryl groups may further be disconnected by short non-aromatic units (for example, a non-hydrogenium atom contenting less than 10%, such as C, N, or O). In some embodiments, a 9,9-diarylfluorene group, a triarylamine group, or a diaryl ether system may be further included in the definition of the aryl group.

In the disclosure, “a heteroaryl group or a heteroaromatic group” refers to a basis of an aryl group with at least one carbon atom replaced by a non-carbon atom, and the non-carbon atom may be N, O, S, or the like. For example, “a substituted or unsubstituted heteroaryl group having 5-40 ring atoms” refers to a heteroaryl group having 5-40 ring atoms, a substituted or unsubstituted heteroaryl group having 6-30 ring atoms, a substituted or unsubstituted heteroaryl group having 6-18 ring atoms, or a substituted or unsubstituted heteroaryl group having 6-14 ring atoms, and the heteroaryl group is optionally further substituted. Suitable examples of the heteroaryl group or the heteroaromatic group include, but not limited to, a thienyl group, a furyl group, a pyrrolyl group, an imidazolyl group, a diazole group, a triazole group, a pyridinyl group, a bipyridyl group, a pyrimidinyl group, a triazinyl group, an acridinyl group, a pyridazinyl group, a pyrazinyl group, a quinolinyl group, an isoquinolinyl group, a quinazolinyl group, a quinoxalinyl group, a phthalazinyl group, a pyridino pyrimidinyl group, a pyridino pyrazinyl group, a benzothiophenyl group, a benzofuranyl group, an indolyl group, a pyrrolo imidazolyl group, a pyrrolopyrrolyl group, a thiophenopyrrolyl group, a thiophenothiophenyl group, a furanopyrrolyl group, a furanofuranyl group, a thiophenofuranyl group, a benzoisoxazolyl group, a benzoisothiazolyl group, a benzimidazolyl group, an ortho-diazonaphthalyl group, a phenanthridinyl group, a berberine group, a quinazolinketone group, a dibenzothiophenyl group, a dibenzofuranyl group, a carbazolyl group, and derivatives thereof.

In the disclosure, “an alkyl group” refers to a linear alkyl group, a branched alkyl group, and/or a cyclic aliphatic hydrocarbon group. The number of carbon atoms in the alkyl group may range from 1 to 50, 1 to 30, 1 to 20, 1 to 10, or 1 to 6. The term having the alkyl group, such as “a C₁₋₉ alkyl group”, refers to an alkyl group having 1 to 9 carbon atoms. The C₁₋₉ alkyl group is independently selected from a C₁ alkyl group, a C₂ alkyl group, a C₃ alkyl group, a C₄ alkyl group, a C₅ alkyl group, a C₆ alkyl group, a C₇ alkyl group, a C₈ alkyl group, or a C₉ alkyl group at each occurrence. Examples of the alkyl group include, but not limited to, methyl, ethyl, n-propyl, isopropyl, n-butyl, sec-butyl, tert-butyl, isobutyl, 2-ethylbutyl, 3,3-dimethylbutyl, n-pentyl, isopentyl, neopentyl, tert-pentyl, cyclopentyl, 1-methylpentyl, 3-methylpentyl, 2-ethylpentyl, 4-methyl-2-pentyl, n-hexyl, 1-methylhexyl, 2-ethylhexyl, 2-butyhexyl, cyclohexyl, 4-methylcyclohexyl, 4-tert-butylcyclohexyl, n-heptyl, 1-methylheptyl, 2,2-dimethylheptyl, 2-ethylheptyl, 2-butyl-heptyl, n-octyl, tert-octyl, 2-ethyloctyl, 2-butyl-octyl, 2-hexyl-octyl, 3,7-dimethyloctyl, cyclooctyl, n-nonyl, n-decanyl, an adamantine group, 2-ethyldecyl, 2-butyldecyl 2-hexyldecyl, 2-octyldecyl, n-undecyl, n-dodecyl, 2-ethyldodecyl 2-butyldodecyl, 2-hexyldodecyl, 2-octyldodecyl, n-tridecyl, n-tetradecyl, n-pentadecyl, n-hexadecyl, 2-ethylhexadecyl, 2-butylhexadecyl, 2-hexylhexadecyl, 2-octylhexadecyl, n-heptadecyl, n-octadecyl, n-nonadecyl, n-eicosyl, 2-ethyleicosyl, 2-butyeicosyl, 2-hexyleicosyl, 2-octyleicosyl, n-heneicosyl, n-docosyl, n-tricosyl, n-tetracosyl, n-pentacosyl, n-hexacosyl, n-heptacosyl, n-octacosyl, n-nonacosyl, n-triacontyl, and the like.

In the disclosure, abbreviations of substituent groups are as follows: normal (n), secondary (sec), iso (i), tertiary (tert), ortho (o), meta (m), para (p), methyl (Me), ethyl (Et), propyl (Pr), butyl (Bu), n-amyl (Am), hexyl (Hx), and cyclohexyl (Cy). and a tert-butoxy group (—O—C(CH₃)₃ or —OtBu).

In the disclosure, “an amino group” refers to a derivative of the amine and has a structural feature of a group represented by formula —N(X)₂, in which X is independently selected from —H, a substituted or unsubstituted alkyl group, a substituted or unsubstituted cycloalkyl group, a substituted or unsubstituted heterocyclic group, or the like. Examples of the amino group include, but not limited to, —NH₂, —N(alkyl)₂, —NH(alkyl), —N(cycloalkyl)₂, —NH(cycloalkyl), —N(heterocyclic)₂, —NH(heterocyclic), —N(aryl)₂, —NH(aryl), —N(alkyl)(aryl), —N(alkyl)(heterocyclic), —N(cycloalkyl)(heterocyclic), —N(aryl)(heteroaryl), —N(alkyl)(heteroaryl), and the like.

In the disclosure, “a cycloalkyl group” or “a cyclic alkyl group” refers to a monovalent group having one or more saturated rings in which all ring atoms are carbon atoms. “Alkyl groups” in the “cycloalkyl group” and the “cyclic alkyl group” have the same meaning as the “alkyl group” as defined above.

In the disclosure, “a heterocyclic group” or “heterocyclic” refers to a non-aromatic cyclic group that is fully saturated or partially unsaturated. The non-aromatic cyclic group has one or more heteroatoms, such as an oxygen atom, a sulfur atom, a silicon atom, or a nitrogen atom, in which the nitrogen atom and the sulfur atom are optionally oxidized and the nitrogen atom is optionally quaternized. In some embodiments, the heterocyclic group is connected to any atom or any carbon atom in a ring or a ring system, and the heterocyclic group is unsubstituted or substituted by one or more aryl groups as described above.

In the disclosure, unless otherwise specified, a hydroxyl group refers to —OH, a carboxyl group refers to —COOH, a carbonyl group refers to —C(═O)—, an amino group refers to —NH₂, a formyl group refers to —C(═O)H, a haloformyl group refers to —C(═O)Z (Z refers to a halogen atom, such as F, Cl, Br or I), a carbamoyl group refers to —C(═O)NH₂, an isocyanate group refers to —NCO, and an isothiocyanate group refers to —NCS.

In the disclosure, “an alkoxy group” refers to a group having a structure of “—O-alkyl”, that is, the alkyl group as defined above is connected to other groups through an oxygen atom to form the alkoxy group. Suitable examples of the alkoxy group include, but not limited to, a methoxy group (—O—CH₃ or —OMe), an ethoxy group (—O—CH₂CH₃ or —OEt), and a tert-butoxy group (—O—C(CH₃)₃ or —OtBu).

In the disclosure, “*” connected to a single bond indicates a linking site or a fused site.

In the disclosure, when a linking site in a group is not specified, it means that any of connectable sites in the group may be selected as the linking site.

In the disclosure, when a fused site in a group is not specified, it means that any of fusible sites in the group may be selected as the fused site. For example, two or more adjacent sites in the group form a fused site.

In the disclosure, when there are more than one substituent groups with the same symbol on the same group, the substituent groups may be the same or different. For example, in formula

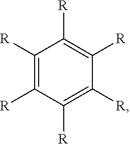

six R groups in a benzene ring may be the same or different.

In the disclosure, a single bond connected to a substituent group and penetrated a corresponding ring indicates that the substituent group may be connected to any site of the ring. For example,

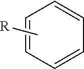

means that R may be connected to any substituent site of the benzene ring, and

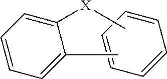

means that

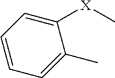

may be connected to any substituent site of

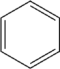

to form two rings connected to each other.

In the disclosure, “adjacent two groups” refer to two groups absent of substitutable sites between the two groups.

In the disclosure, “adjacent two R₁, adjacent two R₃, or adjacent two R₅ form a ring with each other” indicates that adjacent two R₁, adjacent two R₃, or adjacent two R₅ are connected to each other to form a ring system. In some embodiments, the ring system is selected from an aliphatic hydrocarbon ring, an aliphatic heterocyclic ring, an aromatic hydrocarbon ring, or an aromatic heterocyclic ring. For example, the ring system is

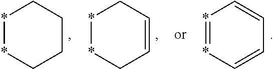

In the disclosure, one or more end groups in a group are not replaced, or one or more end groups in the group are independently replaced by a substituent group, indicating that, one or more end groups in a group are not replaced at each occurrence, or one or more end groups in the group are independently replaced by a substituent group at each occurrence. For example, one or more end groups in R are not replaced, or, one or more end groups in R are independently replaced by —CN or —CF₃, indicating that, one or more end groups in R are not replaced at each occurrence, or, one or more end groups in R are independently replaced by —CN or —CF₃ at each occurrence.

In the disclosure, one or more H atoms in a group are unsubstituted, or one or more H atoms in the group are independently substituted by a substituent group, indicating that, one or more H atoms in a group are unsubstituted at each occurrence, or one or more H atoms in the group are independently substituted by a substituent group at each occurrence. For example, one or more H atoms in R are unsubstituted, or, one or more H atoms in R are independently substituted by F, Cl, Br, or I, indicating that, one or more H atoms in R are unsubstituted at each occurrence, or, one or more H atoms in R are independently substituted by F, Cl, Br, or I at each occurrence.

In the disclosure, one or more —CH₂— groups in a group are not replaced, or one or more —CH₂— groups in the group are independently replaced by a substituent group, indicating that, one or more —CH₂— groups in a group are not replaced at each occurrence, or one or more —CH₂— groups in the group are independently replaced by a substituent group at each occurrence. For example, one or more —CH₂— groups in R are not replaced, or, one or more —CH₂— groups in R are independently replaced by —O—, —S—, —CO—, —C(O)O—, —OC(O)—, —CF₂O—, —OCF₂—, —CH₂—CH₂—, —CH₂O—, —OCH₂—, —CH═CH—, or —C≡C—, indicating that, one or more —CH₂— groups in R are not replaced at each occurrence, or, one or more —CH₂— groups in R are independently replaced by —O—, —S—, —CO—, —C(O)O—, —OC(O)—, —CF₂O—, —OCF₂—, —CH₂—CH₂—, —CH₂O—, —OCH₂—, —CH═CH—, or —C≡C— at each occurrence.

Some embodiments of the disclosure provide a liquid crystal composition, the liquid crystal composition includes a liquid crystal compound and a chiral agent, and the liquid crystal compound is represented by the following formula I:

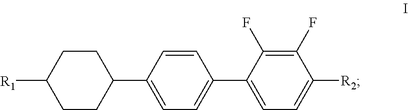

in which R₁ and R₂ are independently selected from —H, —F, —Cl, —Br, —I, —CN, —SCN, —NCS, —SF₅, an alkyl group having 1-10 carbon atoms, an alkoxy group having 1-10 carbon atoms, an alkenyl group having 2-10 carbon atoms, an alkenyloxy group having 2-10 carbon atoms, an alkynyl group having 2-10 carbon atoms, or an alkynyloxy having 2-10 carbon atoms;
one or more end groups in R₁ and R₂ are not replaced, or, one or more end groups in R₁ and R₂ are independently replaced by —CN or —CF₃;
one or more —CH₂— groups in R₁ and R₂ are not replaced, or, one or more —CH₂— groups in R₁ and R₂ are independently replaced by —O—, —S—, —CO—, —C(O)O—, —OC(O)—, —CF₂O—, —OCF₂—, —CH₂—CH₂—, —CH₂O—, —OCH₂—, —CH═CH—, or —C≡C—, and heteroatoms therein directly linked to C are not directly linked to each other; and
one or more H atoms in R₁ and R₂ are unsubstituted, or, one or more H atoms in R₁ and R₂ are independently substituted by F, Cl, Br, or I.

In some embodiments, the liquid crystal composition has an optical anisotropy Δn greater than or equal to 0.12.

In the embodiments of the disclosure, the liquid crystal compound and the chiral agent provide chiral centers for the liquid crystal composition, so that liquid crystal molecules of the liquid crystal layer prepared from the liquid crystal composition can generate a horizontal spiral deflection under the action of voltage, thereby improving the transmittance of the display panel including the liquid crystal layer.

In the embodiments of the disclosure, the optical anisotropy Δn of the liquid crystal composition can be effectively improved by adding the chiral agent to the liquid crystal composition. In some embodiments, the optical anisotropy Δn of the liquid crystal composition is less than or equal to 0.17, for example, 0.12, 0.13, 0.14, 0.15, 0.16, or 0.17.

In some embodiments, R₁ is selected from an alkyl group having 1-5 carbon atoms, and R₂ is selected from an alkoxy group having 1-5 carbon atoms.

In some embodiments, the liquid crystal compound is selected from at least one of a group consisting of compounds represented by the following formula I-1 to I-25:

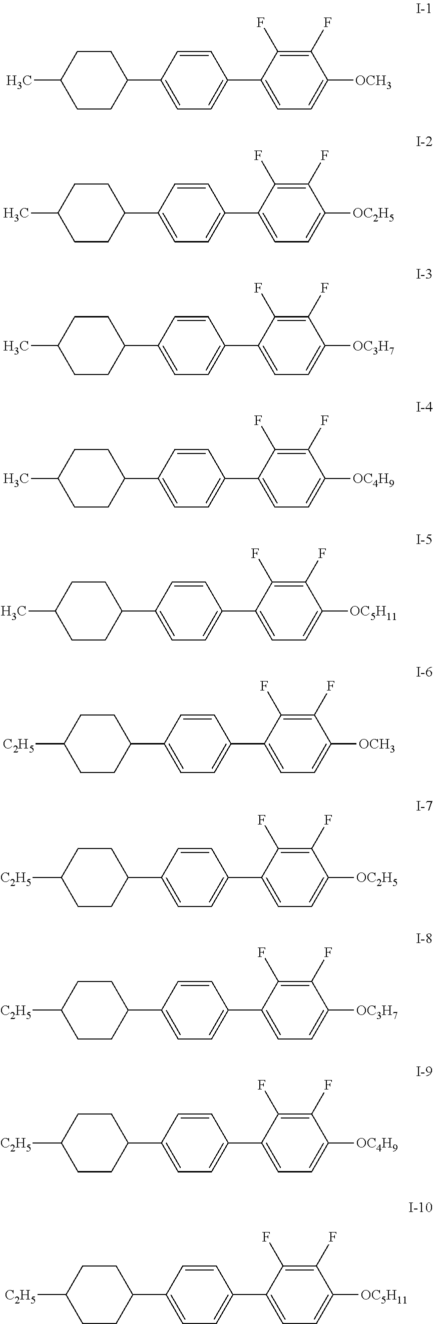

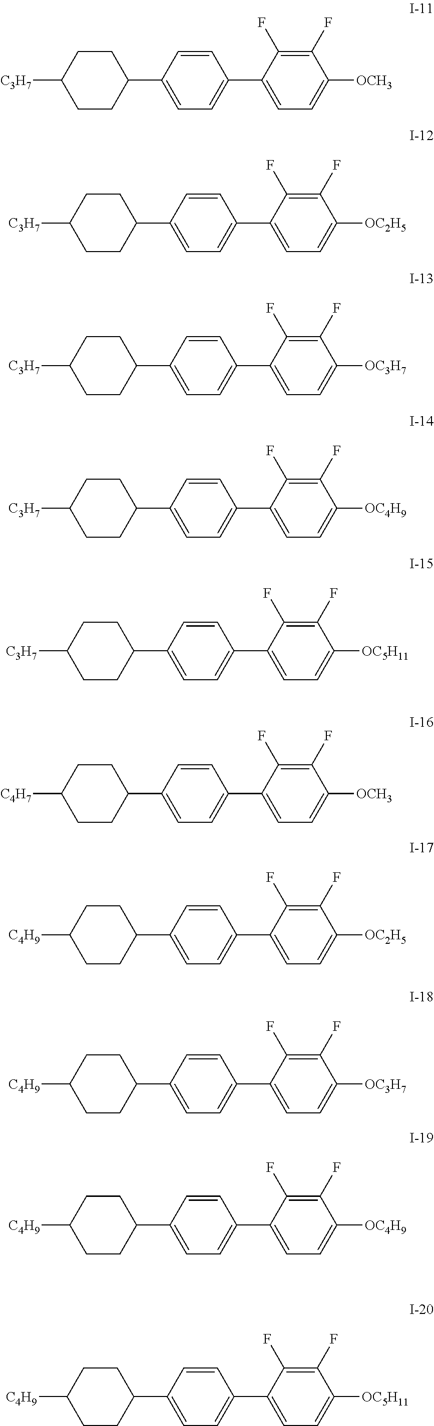

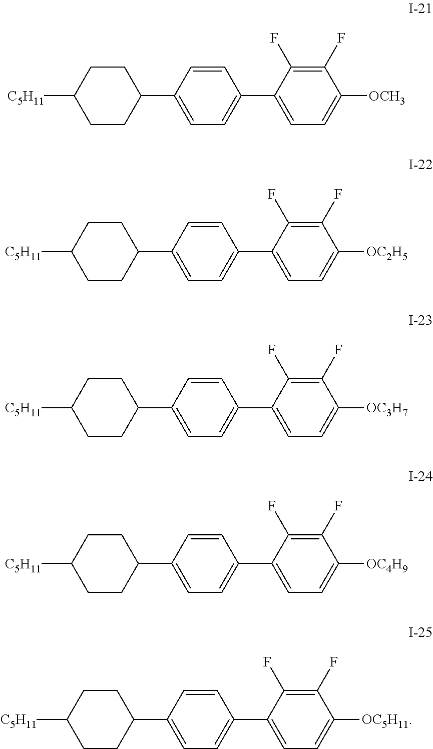

In some embodiments, the chiral agent is selected from at least one of a group consisting of compounds represented by the following formulae C-1 to C-27:

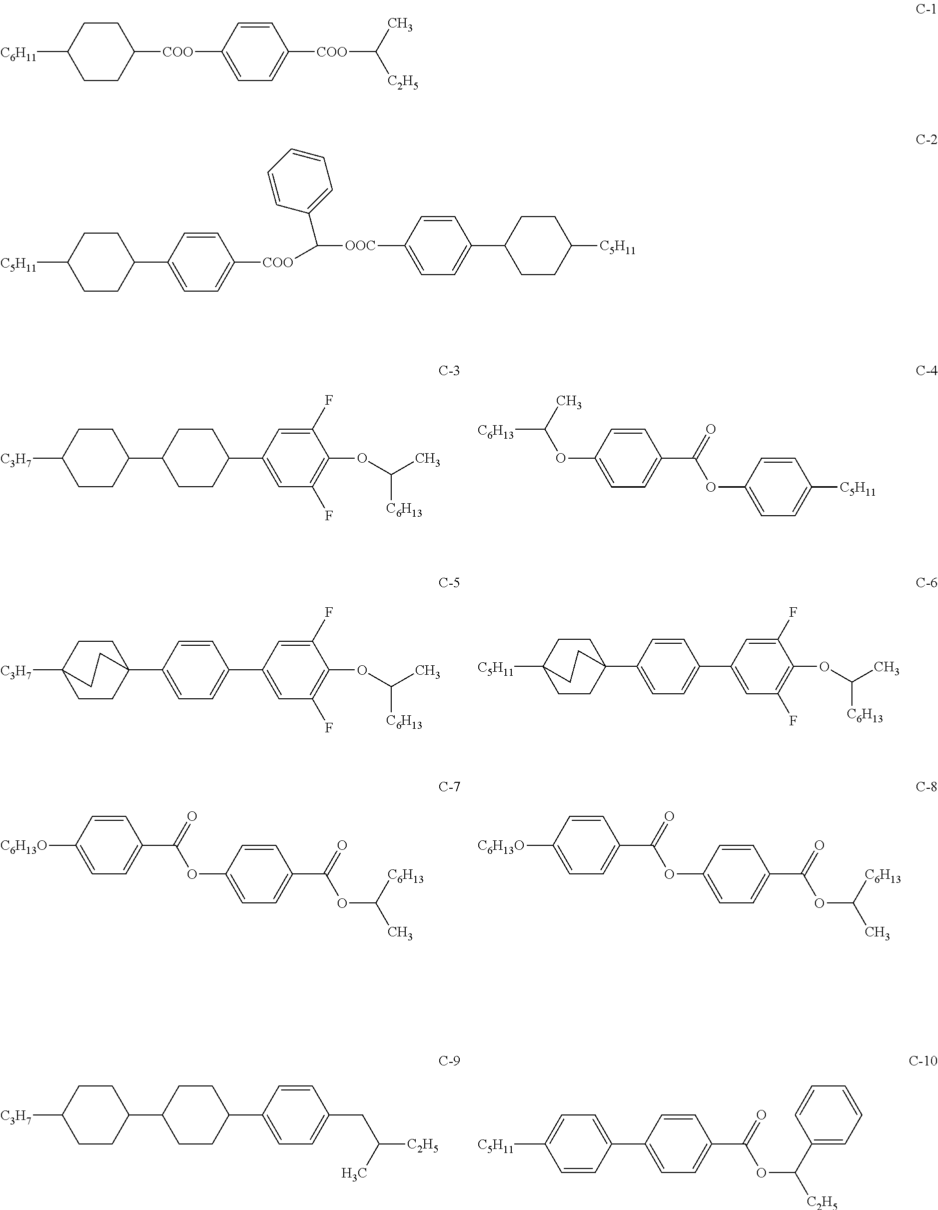

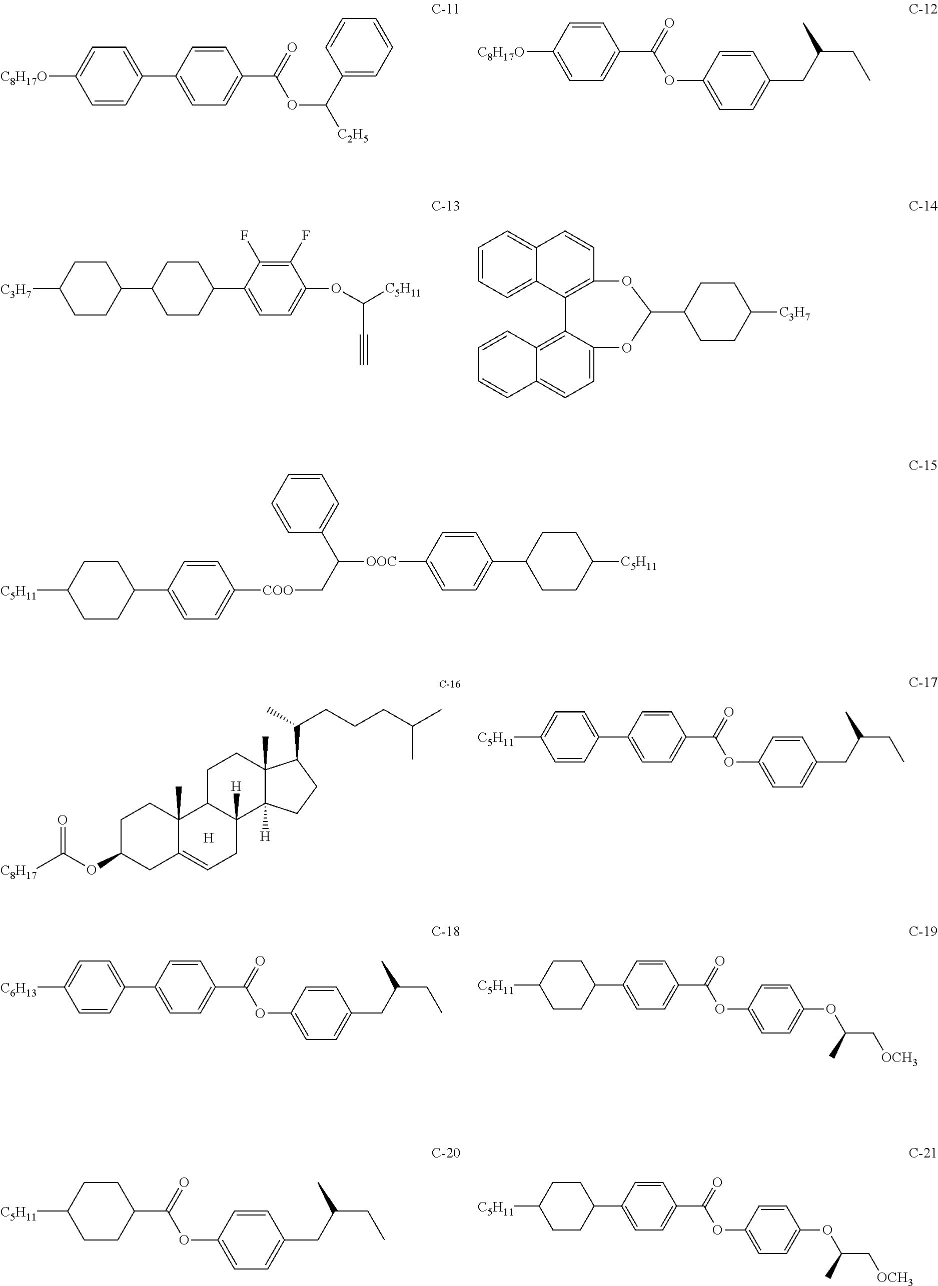

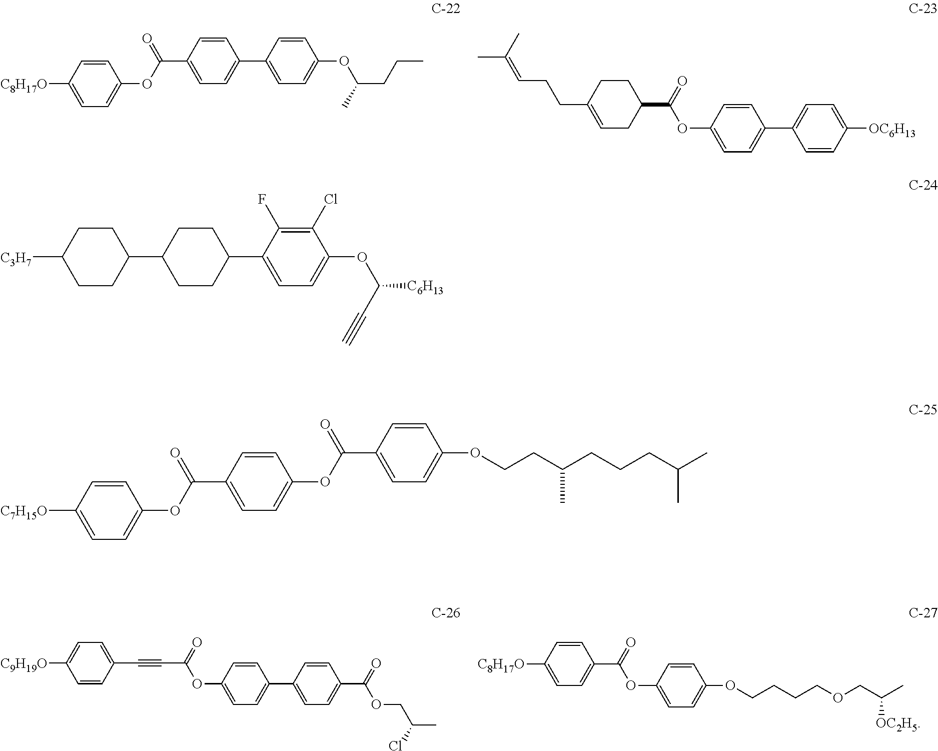

In some embodiments, the liquid crystal composition further includes a polymerizable compound and a self-alignment additive. When preparing the liquid crystal layer using the liquid crystal composition provided in the embodiments of the disclosure, the self-alignment additive and the polymerizable compound can form an alignment layer, thereby simplifying the processes of the alignment layer and reducing the manufacturing cost.

In some embodiments, the polymerizable compound is represented by the following formula II:

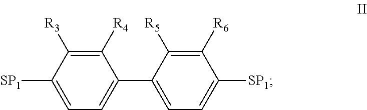

in which R₃, R₄, R₅, and R₆ are independently selected from —H, —F, —Cl, —CF₃, an alkyl group having 1-5 carbon atoms, or an alkoxy group having 1-5 carbon atoms; and
SP₁ is independently selected from

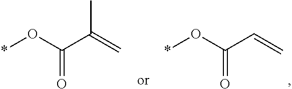

in which * indicates a linking site.

In some embodiments, the polymerizable compound is selected from at least one of a group consisting of compounds represented by the following formulae II-1 to II-50:

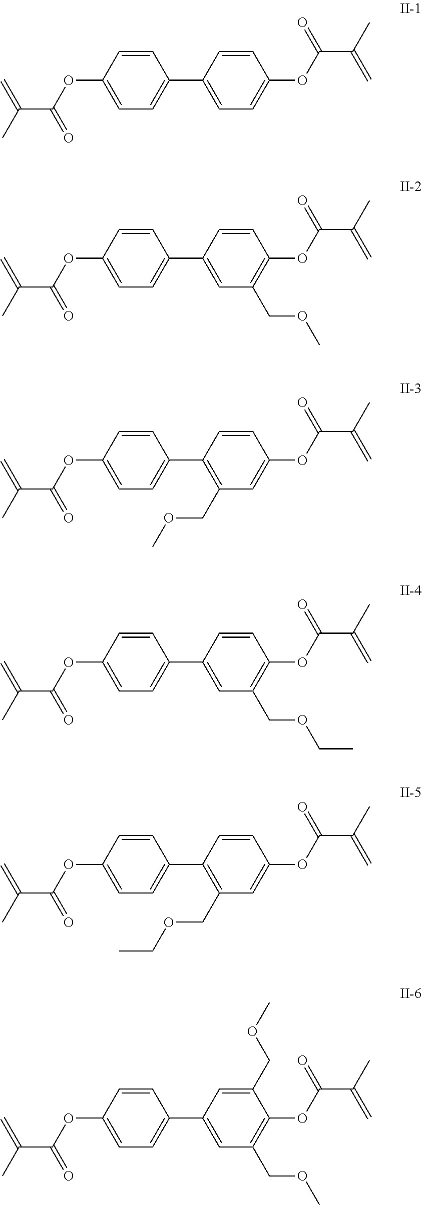

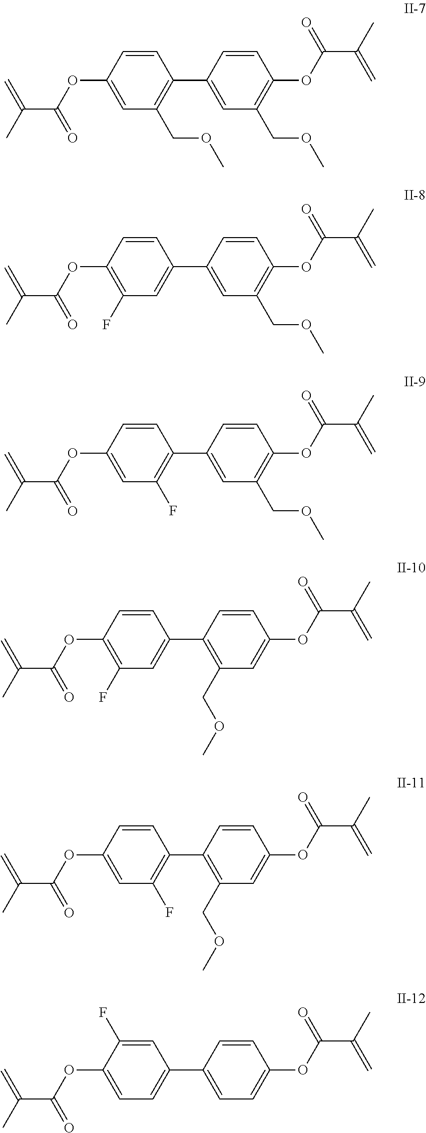

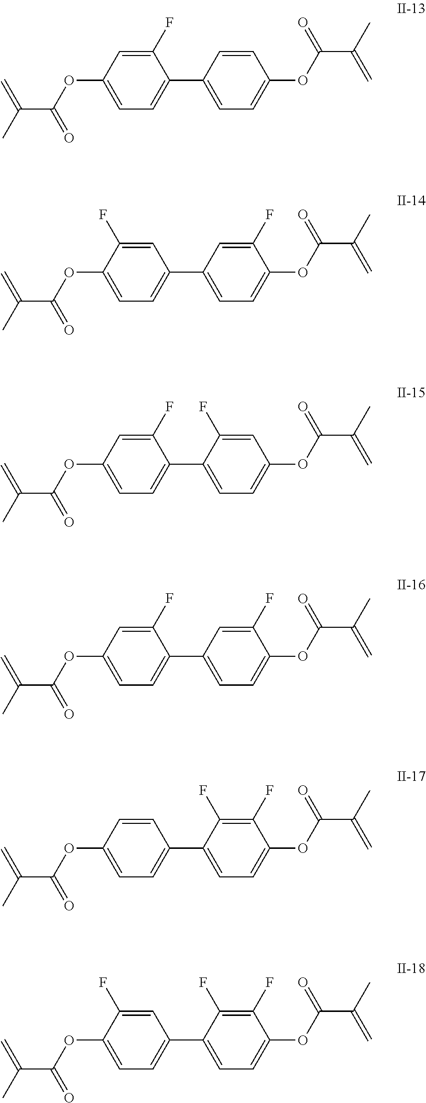

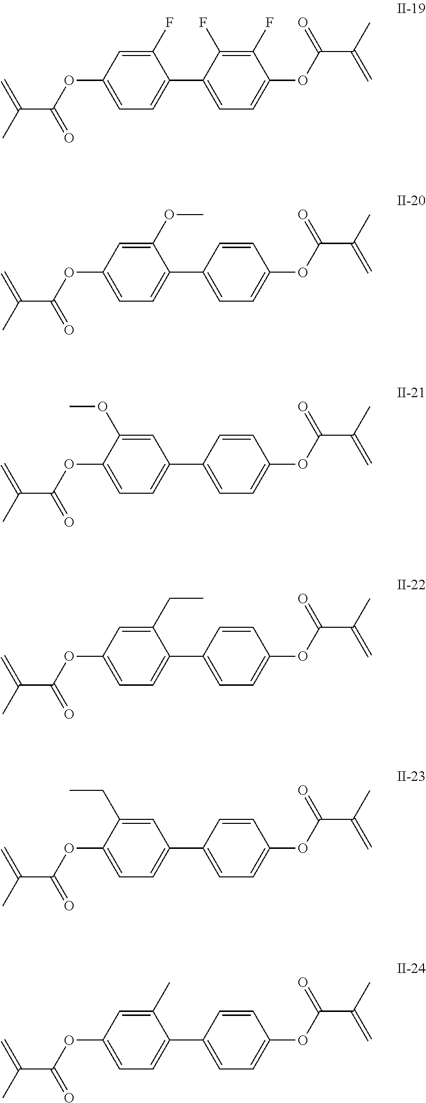

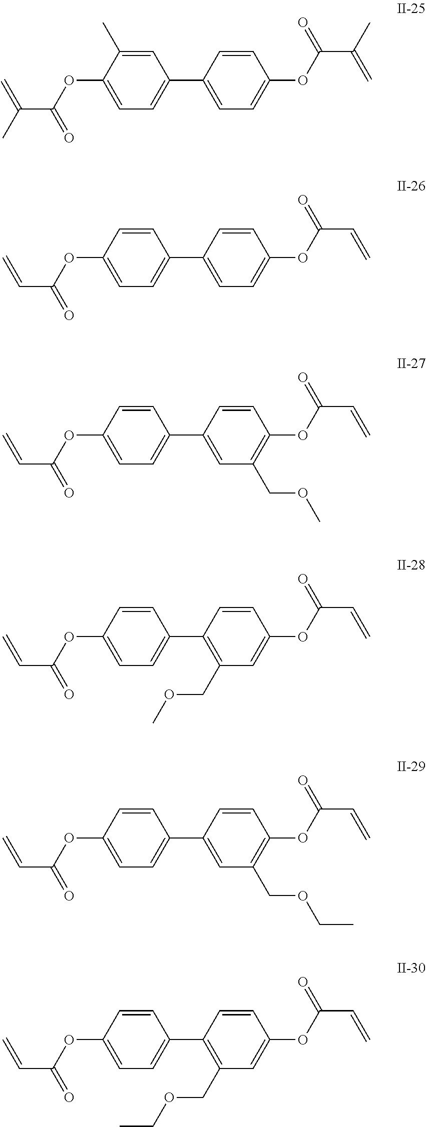

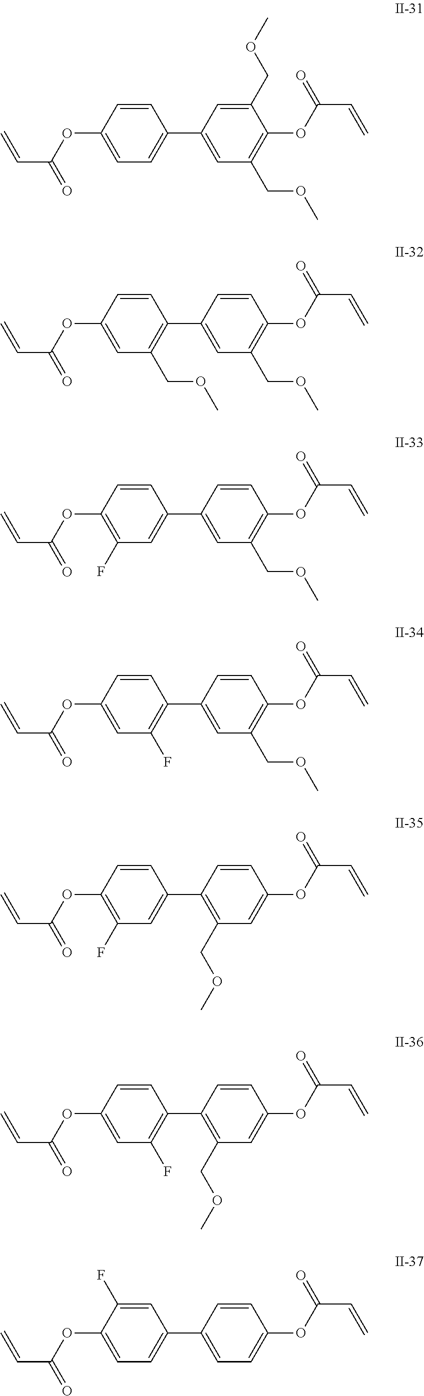

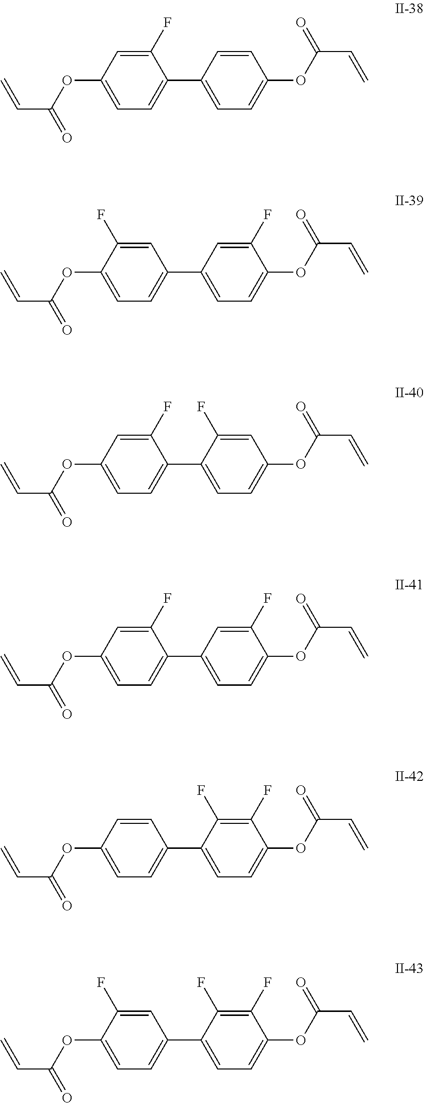

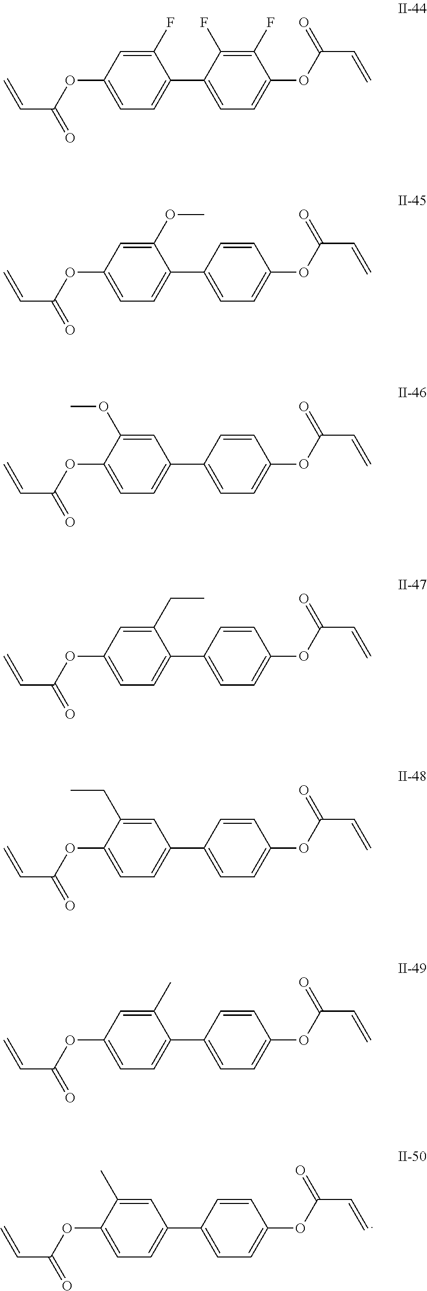

In some embodiments, the self-alignment additive includes a first self-alignment additive represented by the following formula III:

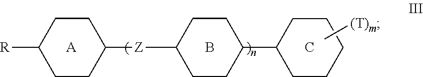

in which

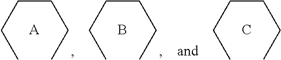

are independently selected from a substituted or unsubstituted aromatic group having 6-10 carbon atoms, or a substituted or unsubstituted cycloalkyl group having 6-10 carbon atoms.

In some embodiments,

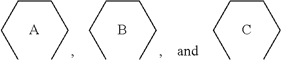

are independently selected from cyclohexyl, unsubstituted phenyl, or phenyl substituted by an alkyl group having 1-5 carbon atoms, for example, phenyl substituted by methyl or ethyl.

In formula III, R is selected from —H, a halogen atom, an alkyl group having 1-25 carbon atoms, an alkoxy group having 1-25 carbon atoms, in which one or more —CH₂— groups in R are not replaced, or, one or more —CH₂— groups in R are independently replaced by —O—, —S—, —CO—, —C(O)O—, —OC(O)—, —CH₂—CH₂—, —CH₂O—, or —OCH₂—, and heteroatoms therein directly linked to C are not directly linked to each other; and one or more H atoms in R are unsubstituted, or, one or more H atoms in R are independently substituted by F, Cl, Br, or I.

In formula III, Z is selected from —O—, —S—, —CO—, —CO—O—, —OCO—, —O—CO—O—, —OCH₂—, —CH₂O—, or —(CH₂)ₙ₁—, in which n1 is selected from 1, 2, 3, or 4.

In some embodiments, Z is selected from a single bond or ethyl.

In formula III, T is selected from

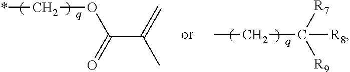

in which R₇, R₈, and R₉ are independently selected from —OH, an alkyl group having 1-8 carbon atoms, and one or more end groups in the alkyl group having 1-8 carbon atoms are not replaced or replaced by —OH; one or more —CH₂— groups in T are not replaced or replaced by —O—; q is any integer from 0 to 8; and * indicates a linking site.

In some embodiments, one or more —CH₂— groups not connected together in T are not replaced, or, one or more —CH₂— groups not connected together in T are independently replaced by —O—.

In formula III, n is selected from 0, 1, 2, or 3, and m is selected from 1, 2, 3, or 4.

In some embodiments, the first self-alignment additive is selected from at least one of a group consisting of compounds represented by the following formulae III-1 to III-78:

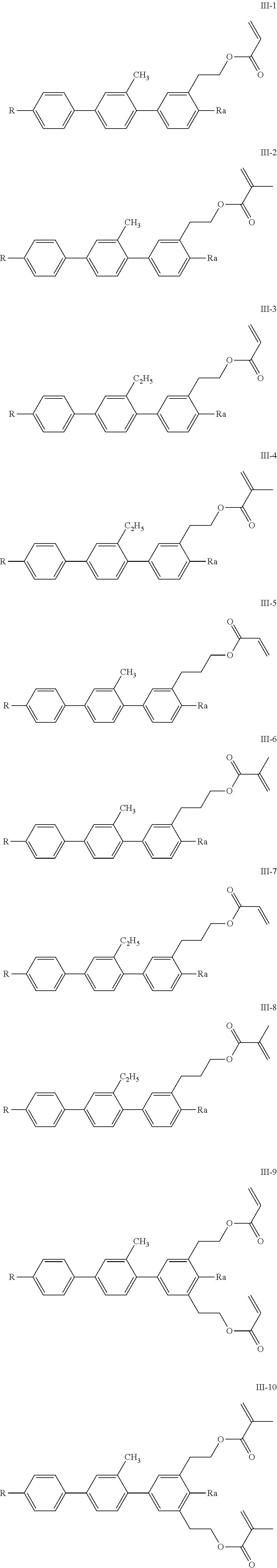

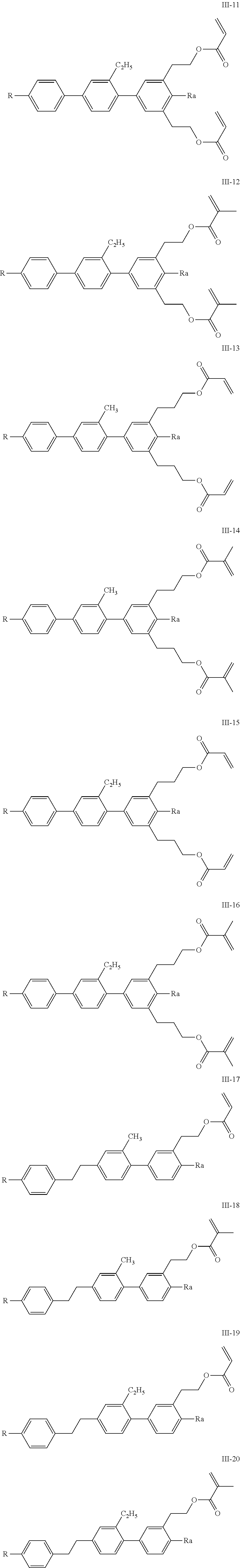

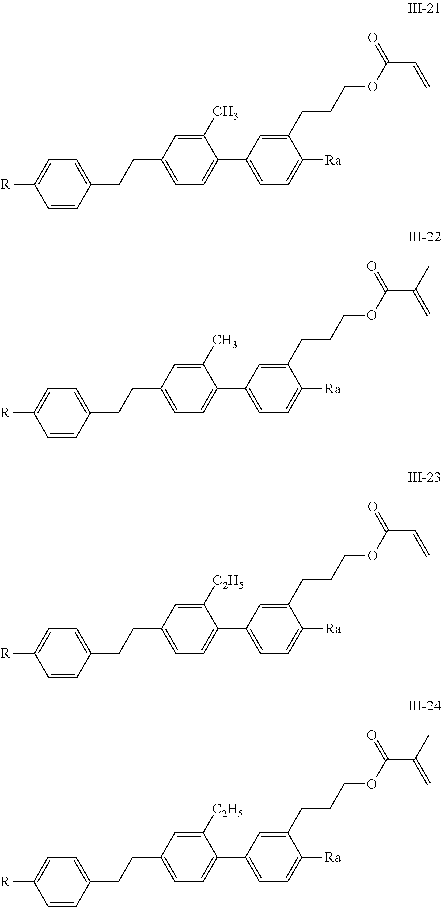

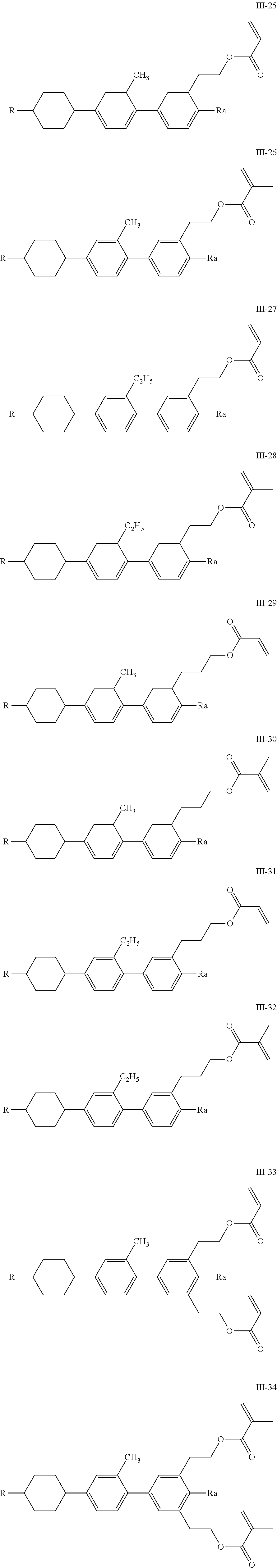

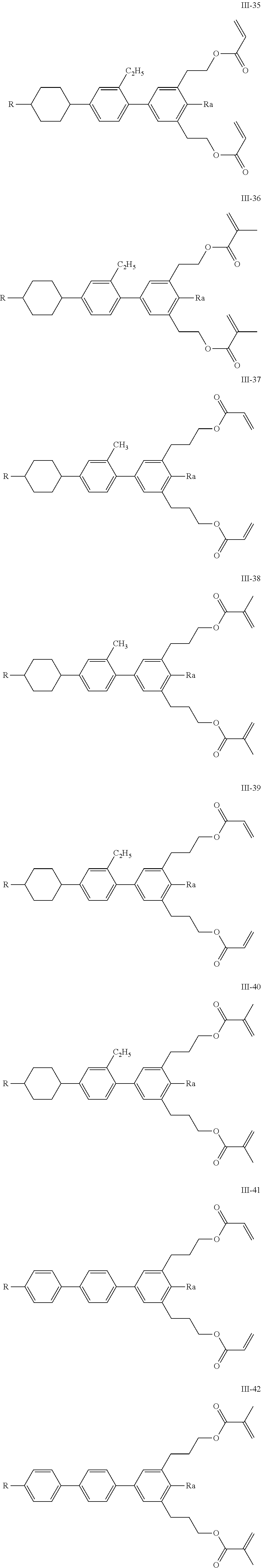

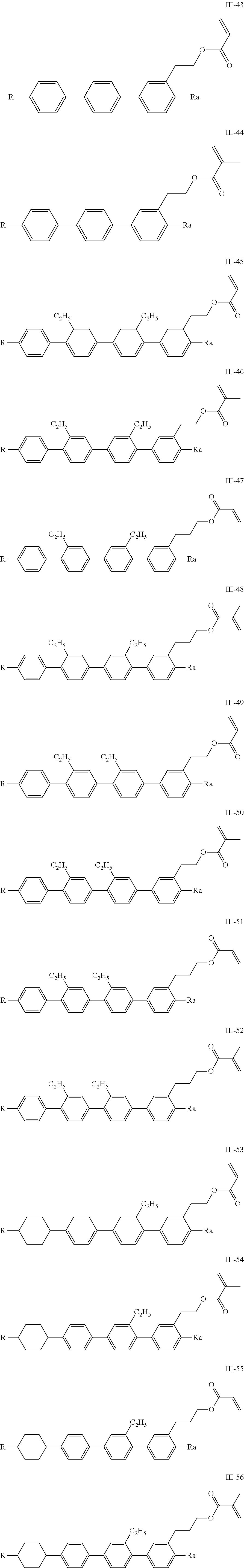

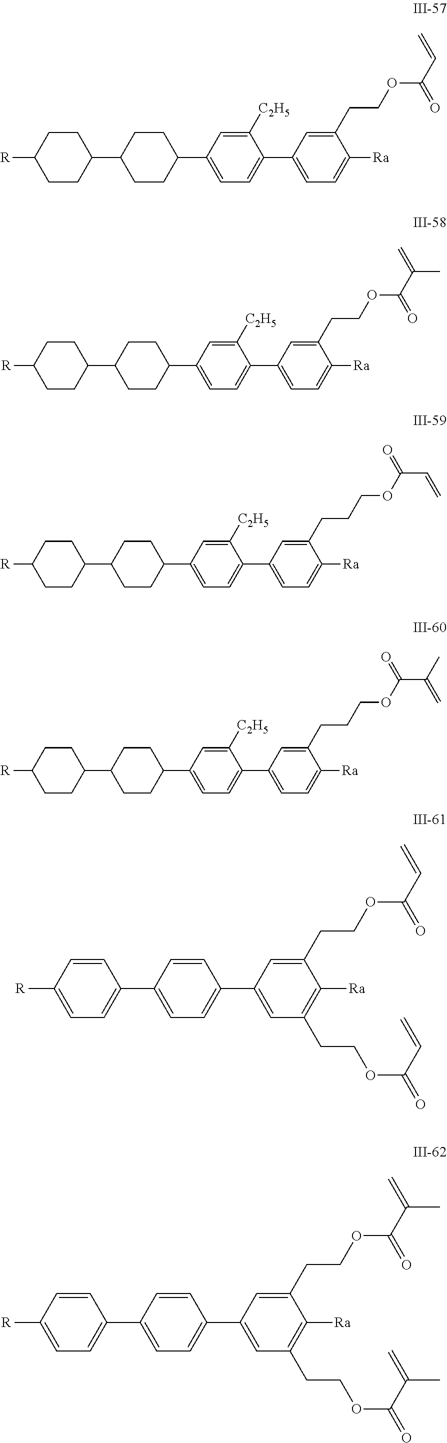

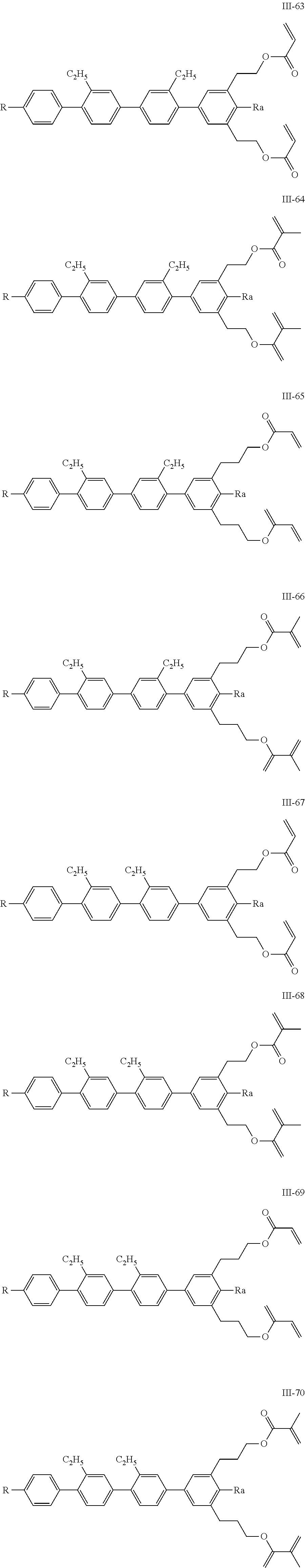

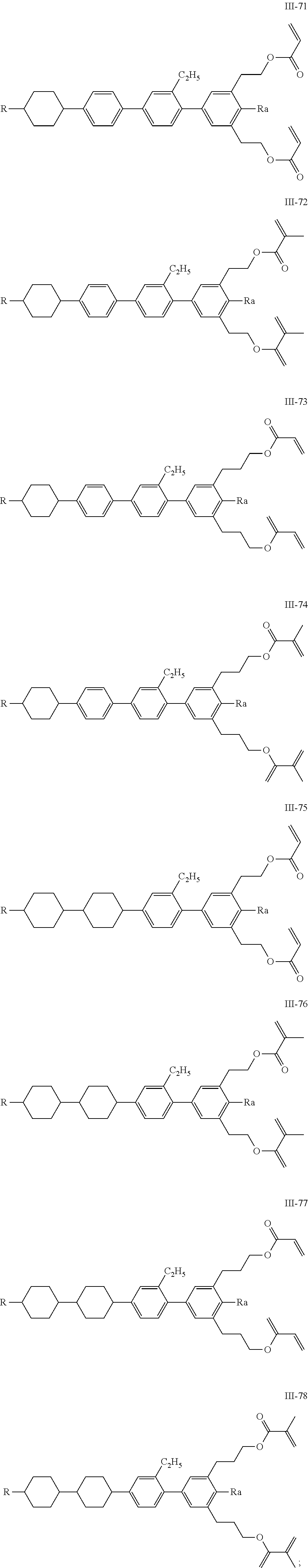

in which Ra is

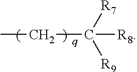

In some embodiments, definitions of R₇, R₈, R₉, and q in

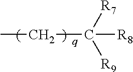

from which Ra is selected are the same as the definitions of R₇, R₈, R₉, and q in

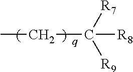

from which Z is selected.

In some embodiments, the self-alignment additive in the liquid crystal composition further includes a second self-alignment additive represented by the following formula IV.

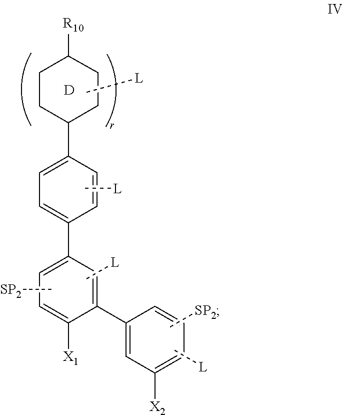

in which

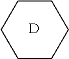

is selected from a fused ring, a spiro ring, a bridged ring, a cyclohexylidene group, a cyclohexenylene group, an epoxycyclohexyl group, or a phenylene group, and r is selected from 1 or 2.

In some embodiments,

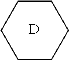

is cyclohexyl.

In formula IV, R₁₀ is selected from an alkyl group having 1-10 carbon atoms, an alkoxy group having 1-10 carbon atoms, a chain alkenyl group having 2-10 carbon atoms, or a chain alkenyloxy group having 2-10 carbon atoms; one or more H atoms in R₁₀ are unsubstituted, or, one or more H atoms in R₁₀ are independently substituted by F, Cl, Br, or I; and one or more —CH₂— groups not connected together in R₁₀ are not replaced, or, one or more —CH₂— groups not connected together in R₁₀ are independently replaced by a cyclopentylidene group, a cyclobutylidene group, a cyclopropylidene group, or —O—.

In some embodiments, R₁₀ is selected from at least one of an alkyl group having 1-5 carbon atoms and a cycloalkyl group having 1-5 carbon atoms.

In formula IV, L is independently selected from —F, —Cl, —H, an alkyl group having 1-10 carbon atoms, an alkoxy group having 1-10 carbon atoms, a chain alkenyl group having 2-10 carbon atoms, or a chain alkenyloxy group having 2-10 carbon atoms; one or more H atoms in L are unsubstituted, or, one or more H atoms in L are independently substituted by F, Cl, Br, or I; and one or more —CH₂— groups not connected together in L are not replaced, or, one or more —CH₂— groups not connected together in L are independently replaced by a cyclopentylidene group, a cyclobutylidene group, or a cyclopropylidene group.

In some embodiments, L is independently selected from —F or an alkyl group having 1-5 carbon atoms.

In formula IV, SP₂ is independently selected from

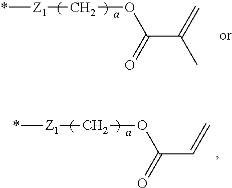

in which Z₁ is independently selected from a single bond, —O—, —S—, —CO—, —C(O)O—, —OC(O)—, —CF₂O—, —OCF₂—, —CH₂—CH₂—, —CH₂O—, —OCH₂—, —CH═CH—, an alkylidene group having 1-10 carbon atoms, an alkenylidene group having 2-10 carbon atoms, or an alkynyl group having 2-10 carbon atoms; one or more —CH₂— groups not connected together in SP₂ are not replaced, or, one or more —CH₂— groups not connected together in SP₂ are independently replaced by —O—, —S—, —CO—, —C(O)O—, —OC(O)—, —CF₂O—, —OCF₂—, —CH₂—CH₂—, —CH₂O—, —OCH₂—, —CH═CH—, or —C≡C—; one or more H atoms in SP₂ are unsubstituted, or, one or more H atoms in SP₂ are independently substituted by F, Cl, Br, or I; and a is any integer from 1 to 10.

In formula IV, X₁ and X₂ are independently selected from —H, —SP₃—OH,

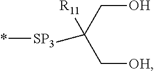

or an alkyl group having 1-10 carbon atoms, in which one or more —CH₂— groups not connected together in the alkyl group having 1-10 carbon atoms are not replaced, or one or more —CH₂— groups not connected together in the alkyl group having 1-10 carbon atoms are independently replaced by a cyclopentylidene group, a cyclobutylidene group, a cyclopropylidene group, or —O—; R₁₁ is selected from an unsubstituted alkyl group having 1-5 carbon atoms or an alkyl group having 1-5 carbon atoms substituted by fluorine; and SP₃ is selected from an ether group, an alkyl group, an alkoxy group, an alkenyl group, or an alkenyloxy group. * indicates a linking site.

In some embodiments, at least one of X₁ and X₂ is —SP₃—OH.

In some embodiments, the second self-alignment additive is selected from at least one of a group consisting of compounds represented by the following formulae IV-1 to IV-54.

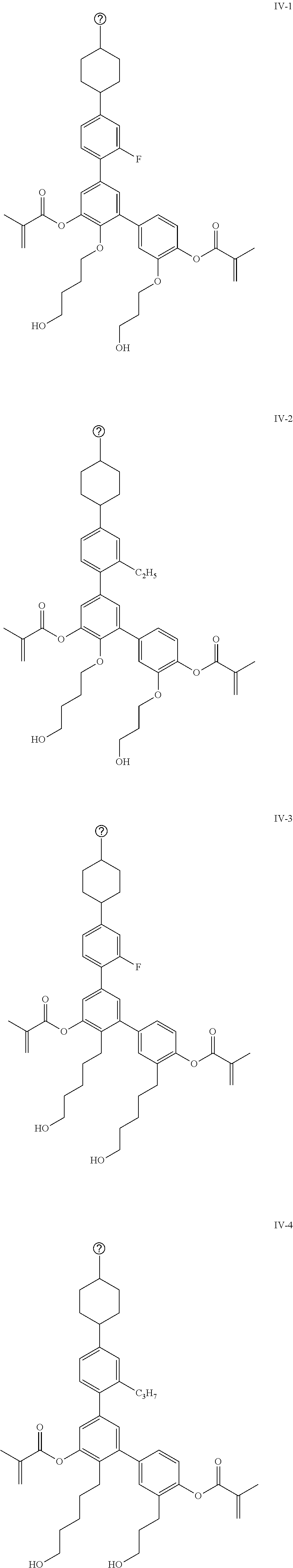

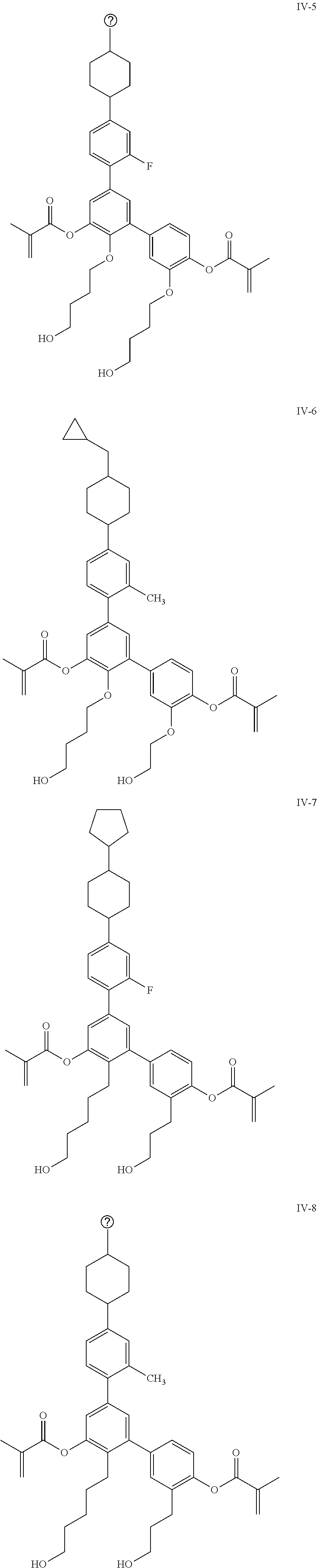

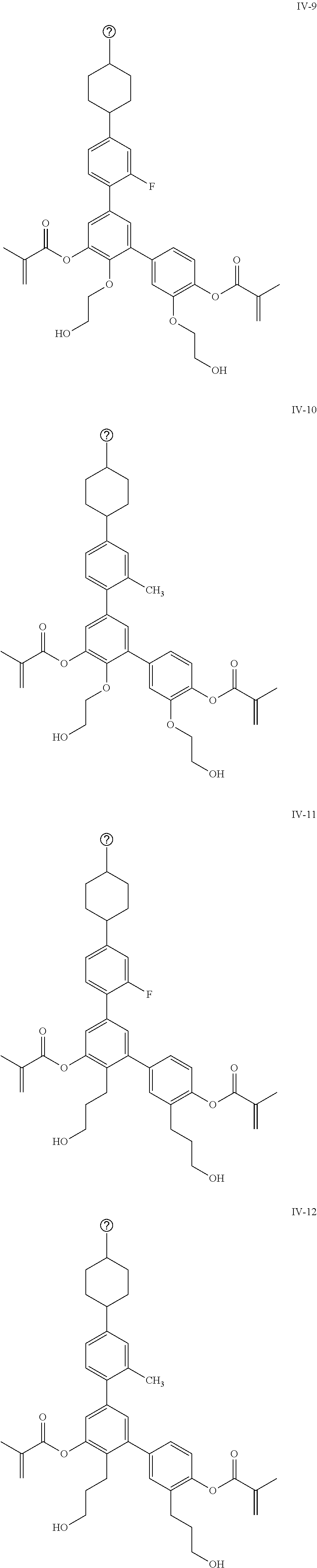

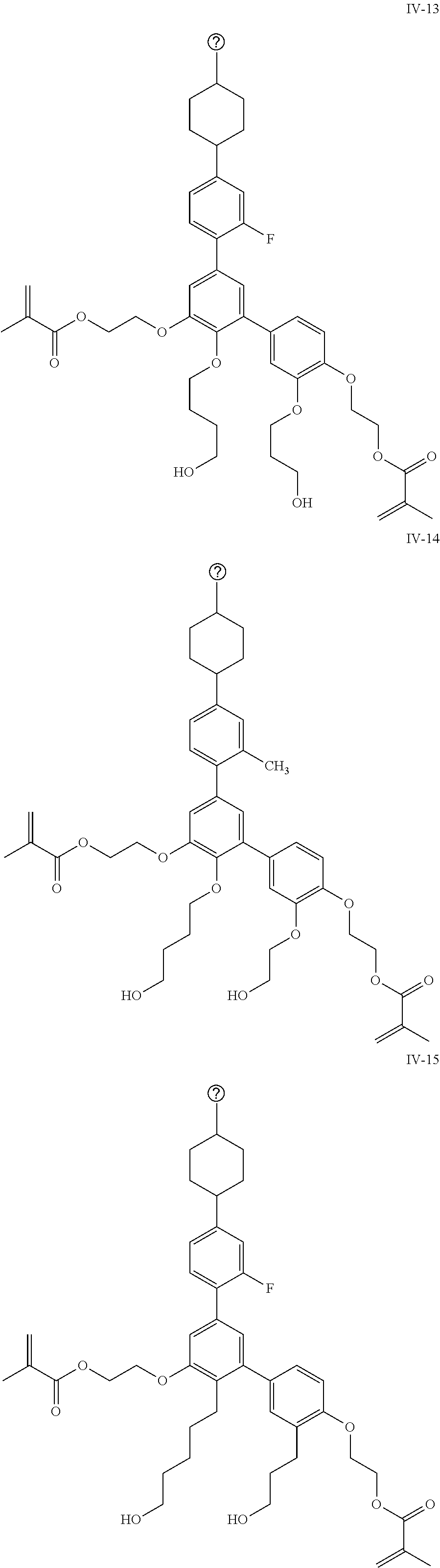

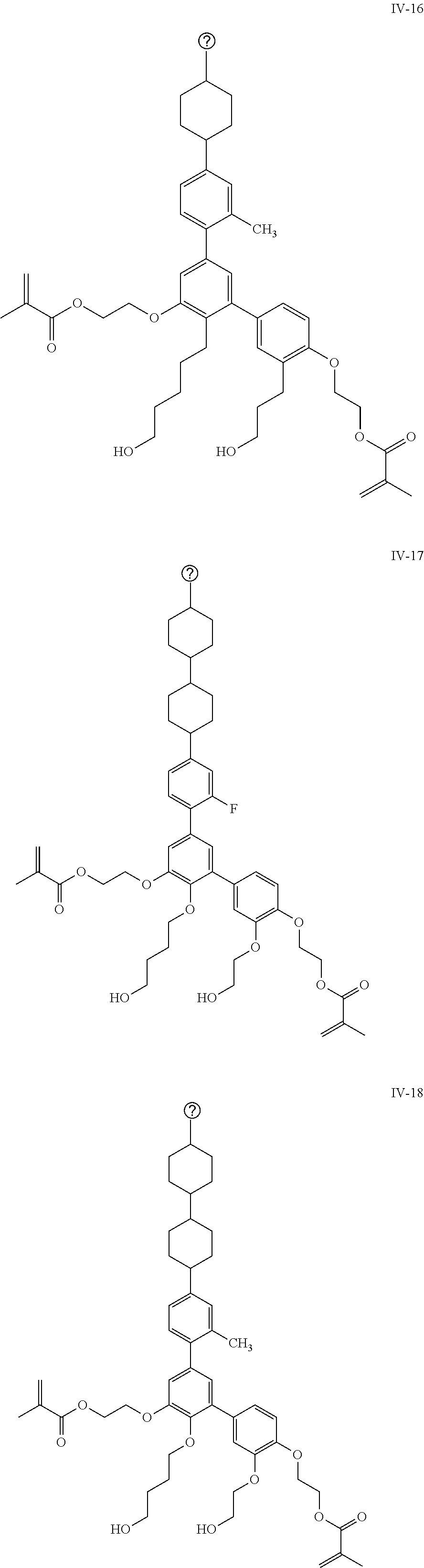

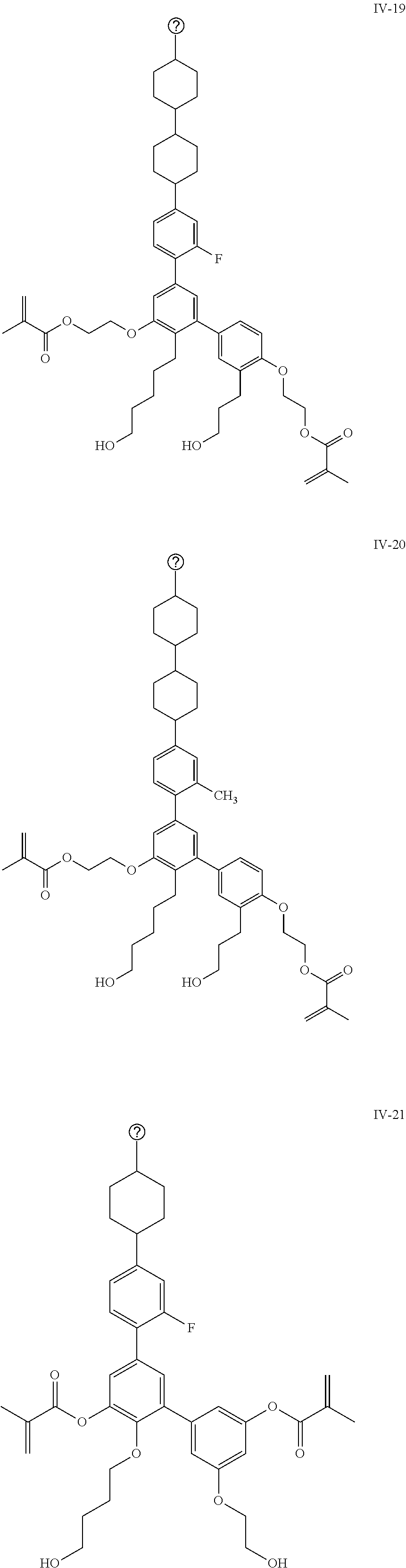

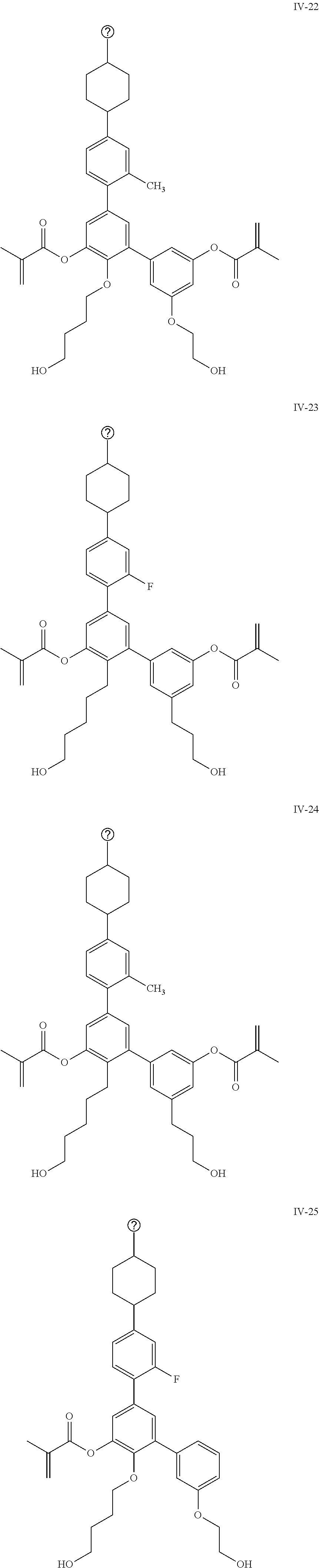

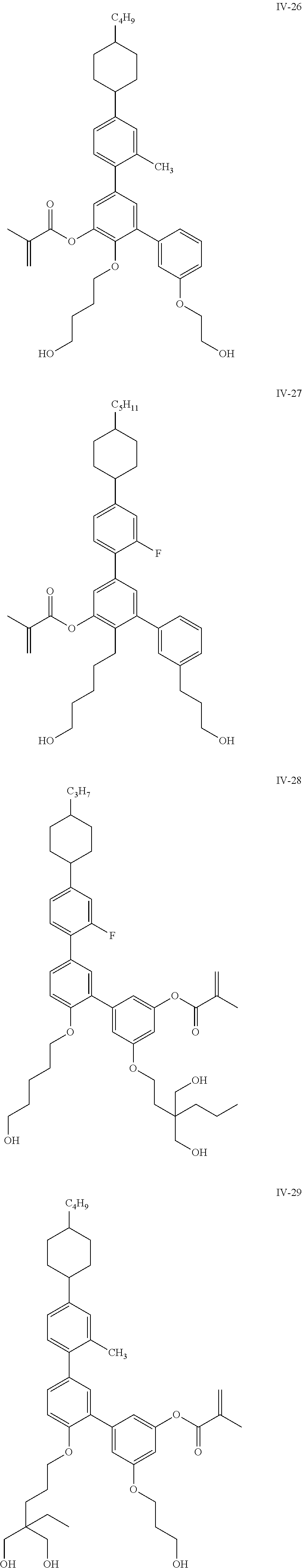

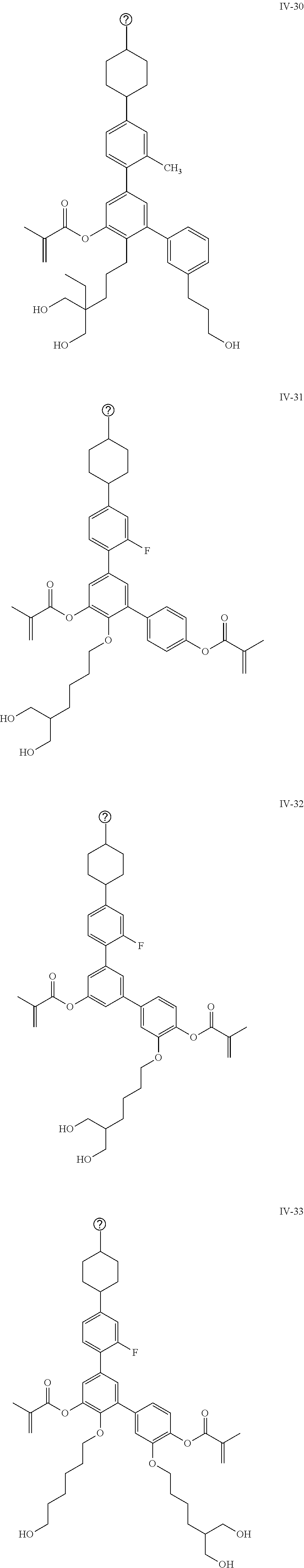

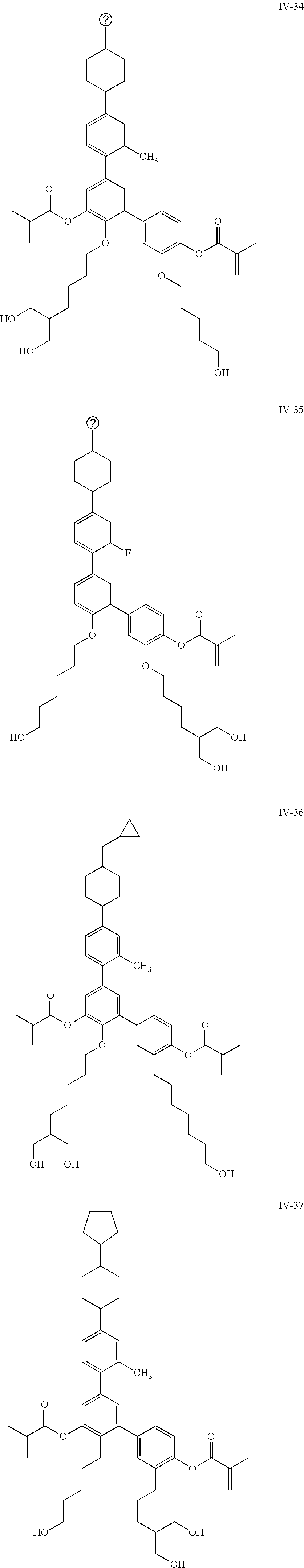

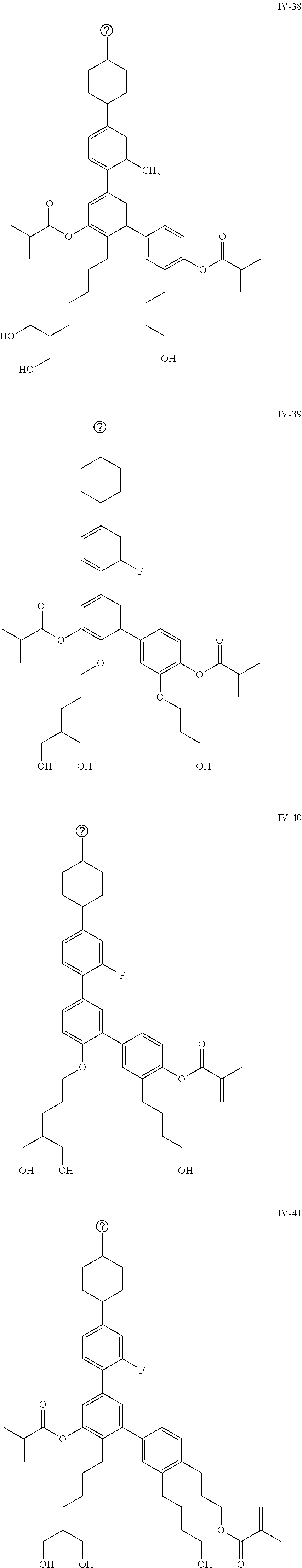

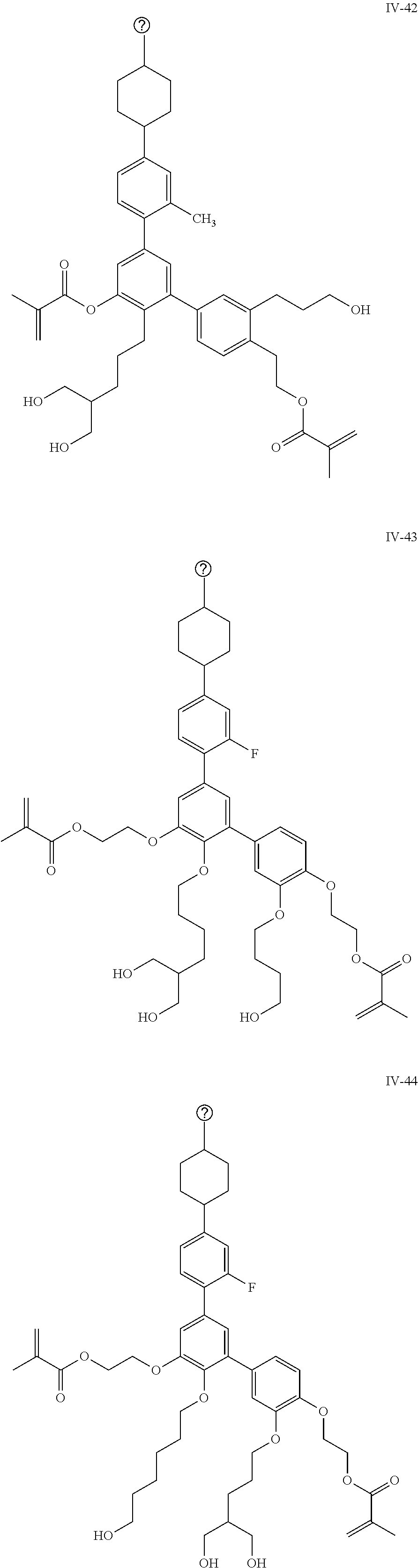

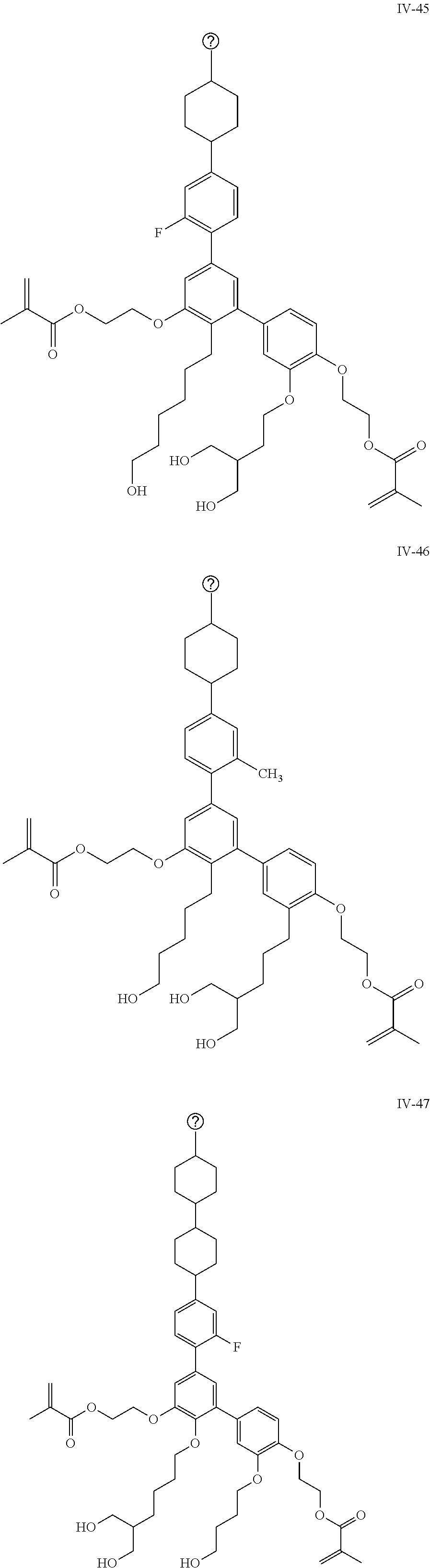

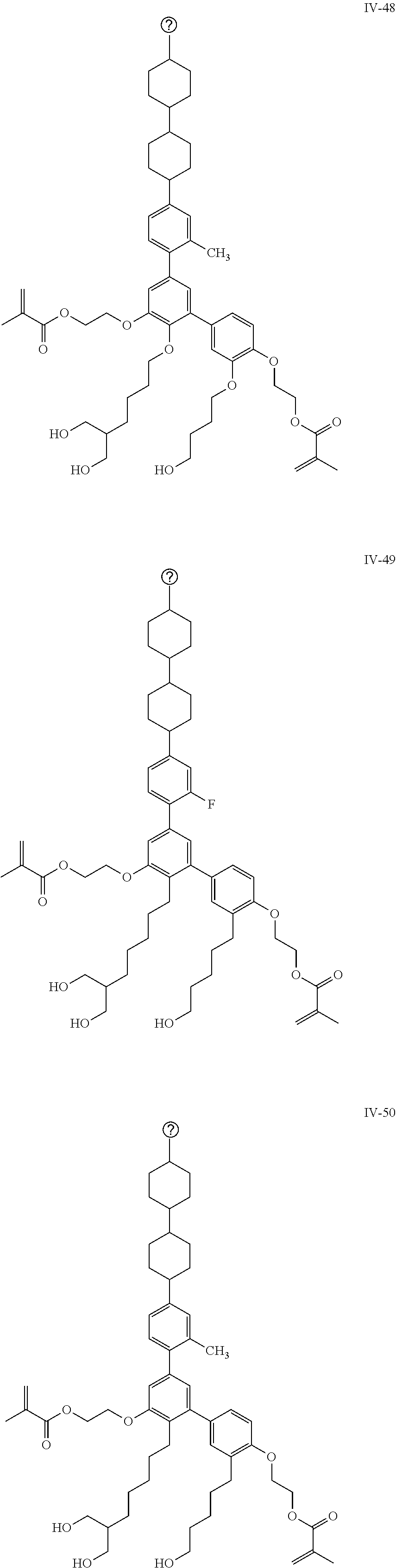

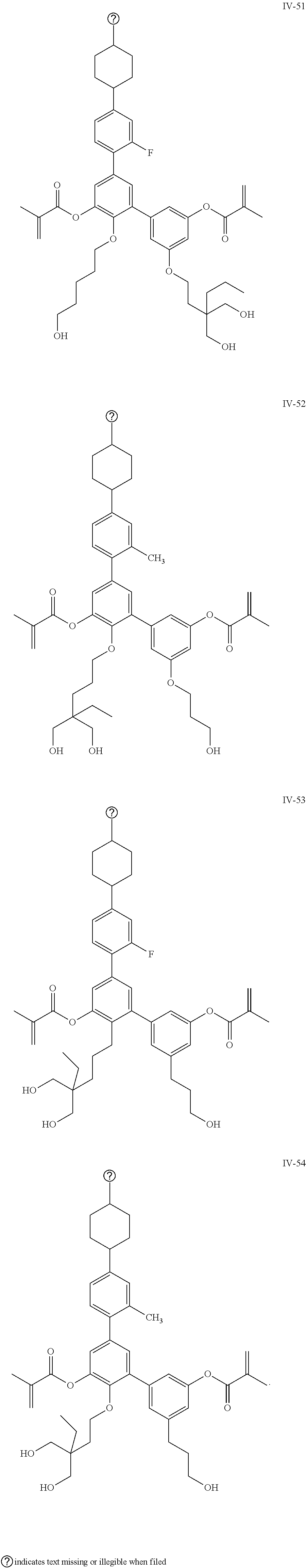

In some embodiments, the liquid crystal composition includes at least one of the first self-alignment additive and the second self-alignment additive.

In some embodiments, the chiral agent in the liquid crystal composition ranges from 0.0100 to 2.0% by mass on a basis of the total mass of the liquid crystal composition, for example, 0.01%, 0.05%, 0.1%, 0.15%, or 0.2%; the polymerizable compound in the liquid crystal composition ranges from 0.01% to 2.0% by mass on a basis of the total mass of the liquid crystal composition, for example, 0.01%, 0.05%, 0.1%, 0.15% or 0.2%; the first self-alignment additive in the liquid crystal composition ranges from 0.1% to 1.5% by mass on a basis of the total mass of the liquid crystal composition, for example, 0.01%, 0.05%, 0.1% or 0.15%; and the second self-alignment additive in the liquid crystal composition ranges from 0.1 to 1.5% by mass on a basis of the total mass of the liquid crystal composition, for example, 0.01%, 0.05%, 0.1% or 0.15%.

In some embodiments of the disclosure, the liquid crystal composition includes two or more of any one of the above-mentioned compounds represented by the same formula. For example, when the liquid crystal composition includes two liquid crystal compounds, the two liquid crystal compounds are two different compounds represented by the formula I.

In some embodiments, the liquid crystal composition is used to prepare a VA liquid crystal display panel. Since the liquid crystal composition includes the chiral agent, which provides chiral centers for the liquid crystal composition, the liquid crystal molecules in the liquid crystal layer prepared from the liquid crystal composition can generate a horizontal spiral deflection under the action of voltage, improving light leakage at gaps of electrodes of the VA liquid crystal display panel. Therefore, the liquid crystal molecules in the liquid crystal layer prepared from the liquid crystal composition have both vertical deflection and horizontal rotation, so that the display panel including the liquid crystal layer have both high contrast characteristics of the VA display panel and high transmittance characteristics of a twisted nematic (TN) display panel, effectively improving the transmittance of the display panel prepared from the liquid crystal composition.

The following Examples 1-4 and Comparative Example of the disclosure provide different exemplary combinations of the above-mentioned compounds in the liquid crystal composition, obtaining the property parameters of the liquid crystal compositions.

The method for preparing the liquid crystal compositions provided in Examples 1-4 and Comparative Example includes the following steps S1, S2, and S3.

In step S1, a mixture was obtained by weighing and mixing different components of the liquid crystal composition in the required mass percentage. For example, different components of the liquid crystal composition were weighed and mixed sequentially in an order of melting points from low to high.

In step S2, the mixture was stirred and heated at a temperature ranging from 60° C. to 100° C., so as to thoroughly dissolve and mix the components of the liquid crystal composition; and

In step S3, the mixture was cooled to room temperature and encapsulated to obtain the liquid crystal composition.

In step S2, the mixture was heated at a temperature of 60° C., 70° C., 80° C., 90° C., or 100° C.

In the following parameters of Examples 1-4 and Comparative Example, Tni (unit: ° C.) indicates a clearing point of the liquid crystal composition, Δn indicates an optical anisotropy of the liquid crystal composition at temperature of 25° C., nₑ indicates refractive index of extraordinary ray, γ1 (unit: mPa s) indicates rotational viscosity of the liquid crystal composition at temperature of 25° C., Δε indicates a dielectric anisotropy of the liquid crystal composition at temperature of 25° C., ε^{⊥} indicates a dielectric constant of the liquid crystal composition in a direction perpendicular to a long axis of the liquid crystals, K₁₁ indicates a splaying elastic coefficient of the liquid crystal composition, K₃₃ indicates a bending elastic coefficient of the liquid crystal composition, Pitch indicates pitch of screws of the liquid crystals, and Tr indicates the transmittance of the display panel prepared from the liquid crystal composition at temperature of 25° C.

In the liquid crystal composition provided in Example 1, Compounds 1-10 are liquid crystal materials, in which the Compounds 4 and 5 are liquid crystal compounds represented by formula I, Compound 11 is a first self-alignment additive represented by formula III, and Compound 12 is a chiral agent. On a basis of the total mass of the liquid crystal composition, the Compounds 1-10 are 99.85% by mass, the Compound 11 is 0.1% by mass, and the Compound 12 is 0.05% by mass. The Compounds 1 to 12 in the liquid crystal composition provided in Example 1 are shown in Table 1 as to their structures and amounts by mass.

TABLE 1

| Com- | | Amount by |
|---|---|---|
| pound | Structure | mass (%) |
| Com- pound 1 | 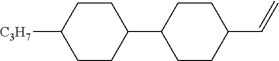 | 32 |
| Com- pound 2 | 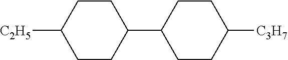 | 3 |
| Com- pound 3 | 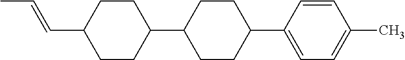 [SMILES: C/C=C/C1CCC(C2CCC(c3ccc(C)cc3)CC2)CC1] | 6 |
| Com- pound 4 | 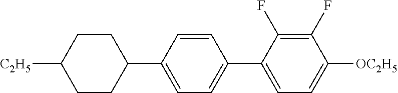 [SMILES: CCOc1ccc(-c2ccc(C3CCC(CC)CC3)cc2)c(F)c1F] | 7 |
| Com- pound 5 | 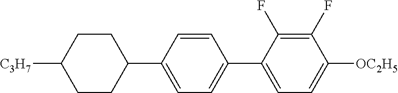 | 10 |
| Com- pound 6 | 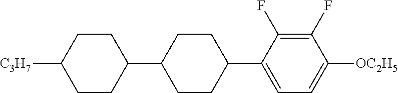 | 12 |
| Com- pound 7 | 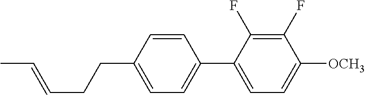 [SMILES: C/C=C/CCc1ccc(-c2ccc(OC)c(F)c2F)cc1] | 6 |
| Com- pound 8 | 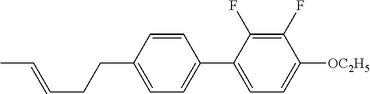 [SMILES: C/C=C/CCc1ccc(-c2ccc(OCC)c(F)c2F)cc1] | 10 |
| Com- pound 9 | 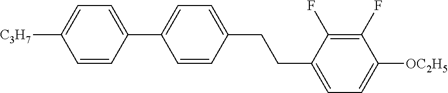 | 6 |
| Com- pound 10 | 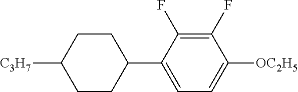 | 8 |
| Com- pound 11 | 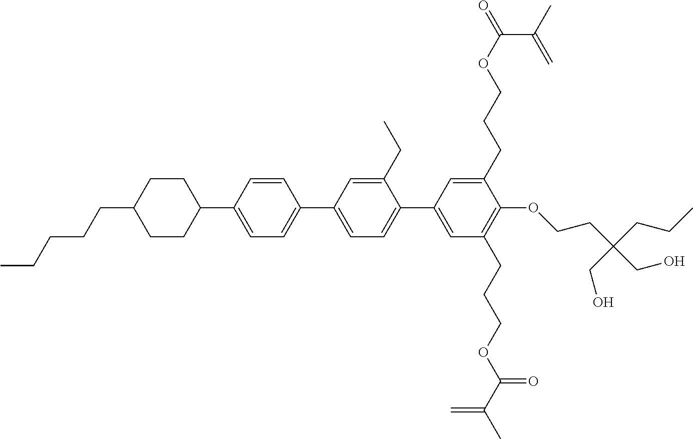 [SMILES: C=C(C)C(=O)OCCCc1cc(-c2ccc(-c3ccc(C4CCC(CCCCC)CC4)cc3)cc2CC)cc(CCCOC(=O)C(=C)C)c1OCCC(CO)(CO)CCC] | 0.1 |
| Com- pound 12 | 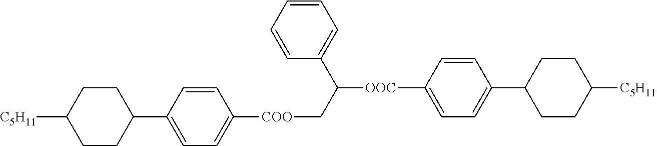 | 0.05 |

The liquid crystal composition provided in Example 1 has the following property parameters: Tni of 78° C., γ1 of 66 mPa·s, Δn of 0.1508, nₑ of 1.6543, Δε of −3.2, ε^{⊥} of 6.1, K₁₁ of 13.89, K₃₃ of 14.81, Pitch of 26 μm, and Tr of 6.65%. There is no crystal precipitation when the liquid crystal composition is stayed at −20° C. for 480 hours.

In the liquid crystal composition provided in Example 2, Compounds 1-10 are liquid crystal materials, in which the Compound 3 is a liquid crystal compound represented by formula I, Compound 11 is a first self-alignment additive represented by formula III, Compound 12 is a second self-alignment additive represented by formula IV, and Compound 13 is a chiral agent. On a basis of the total mass of the liquid crystal composition, the Compounds 1-10 are 99.2% by mass, the Compound 11 is 0.2% by mass, the Compound 12 is 0.3% by mass, and the Compound 13 is 0.3% by mass. The Compounds 1 to 13 in the liquid crystal composition provided in Example 2 are shown in Table 2 as to their structures and amounts by mass.

TABLE 2

| | | Amount by |
|---|---|---|
| Compound | Structure | mass (%) |
| Compound 1 | 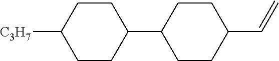 | 32 |
| Compound 2 | 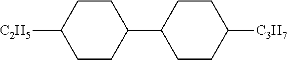 | 5 |
| Compound 3 | 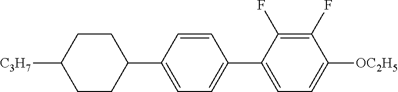 | 10 |
| Compound 4 | 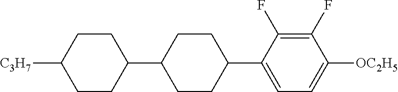 | 8 |
| Compound 5 | 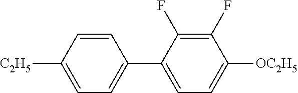 [SMILES: CCOc1ccc(-c2ccc(CC)cc2)c(F)c1F] | 9 |
| Compound 6 | 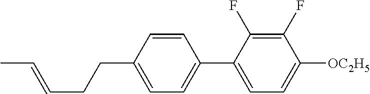 [SMILES: C/C=C/CCc1ccc(-c2ccc(OCC)c(F)c2F)cc1] | 12 |
| Compound 7 | 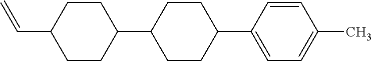 [SMILES: C=CC1CCC(C2CCC(c3ccc(C)cc3)CC2)CC1] | 6 |
| Compound 8 | 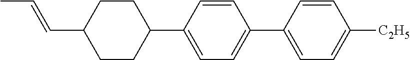 [SMILES: C/C=C/C1CCC(c2ccc(-c3ccc(CC)cc3)cc2)CC1] | 3 |
| Compound 9 | 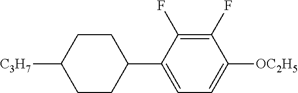 | 12 |
| Compound 10 | 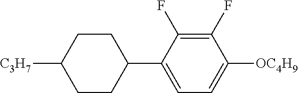 | 3 |
| Compound 11 | 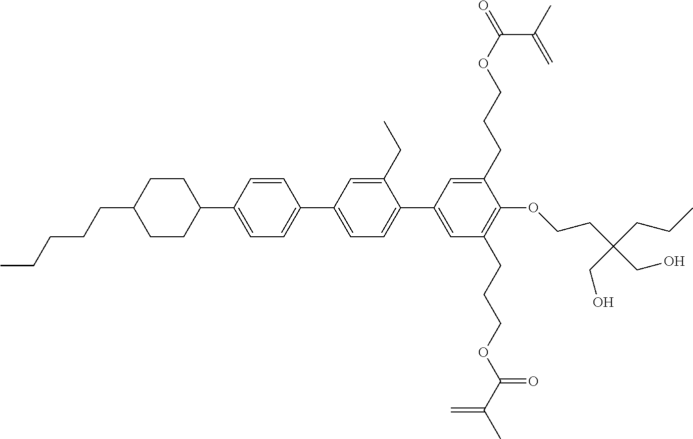 [SMILES: C=C(C)C(=O)OCCCc1cc(-c2ccc(-c3ccc(C4CCC(CCCCC)CC4)cc3)cc2CC)cc(CCCOC(=O)C(=C)C)c1OCCC(CO)(CO)CCC] | 0.2 |
| Compound 12 | 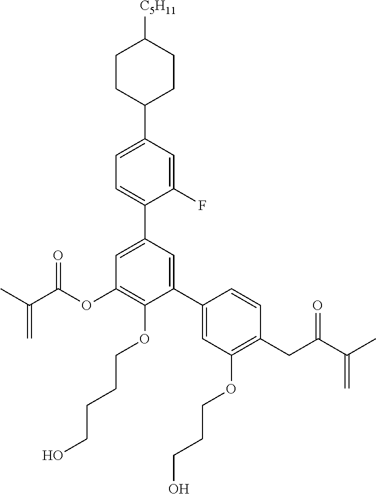 | 0.3 |
| Compound 13 | 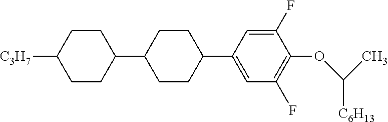 | 0.3 |

The liquid crystal composition provided in Example 2 has the following property parameters: Tni of 76° C., γ1 of 76 mPa s, Δn of 0.1437, nₑ of 1.6122, Δε of −4.03, ε^{⊥} of 7.89, K₁₁ of 13.95, K₃₃ of 15.85, Pitch of 15 μm, and Tr of 6.60%. There is no crystal precipitation when the liquid crystal composition is stayed at −20° C. for 480 hours.

In the liquid crystal composition provided in Example 3, Compounds 1-10 are liquid crystal materials, in which the Compound 3 is a liquid crystal compound represented by formula I, Compounds 11 and 12 are second self-alignment additives represented by formula IV, and Compound 13 is a chiral agent. On a basis of the total mass of the liquid crystal composition, the Compounds 1-10 are 98.4% by mass, the Compound 11 is 0.4% by mass, the Compound 12 is 0.4% by mass, and the Compound 13 is 0.8% by mass. The Compounds 1 to 13 in the liquid crystal composition provided in Example 3 are shown in Table 3 as to their structures and amounts by mass.

TABLE 3

| Compound | Structure | Amount by mass (%) |
|---|---|---|
| Compound 1 | 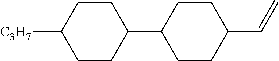 | 30 |
| Compound 2 | 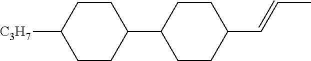 | 5 |
| Compound 3 | 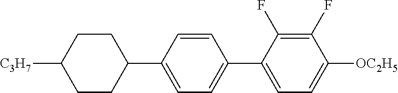 | 9.5 |
| Compound 4 | 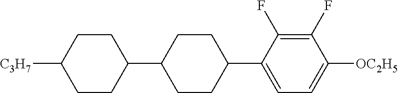 | 8 |
| Compound 5 | 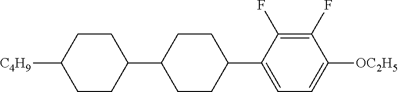 | 9.5 |
| Compound 6 | 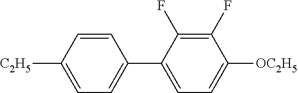 [SMILES: CCOc1ccc(-c2ccc(CC)cc2)c(F)c1F] | 14 |
| Compound 7 | 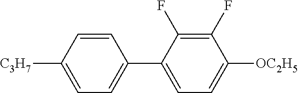 | 4 |
| Compound 8 | 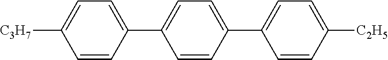 | 2 |
| Compound 9 | 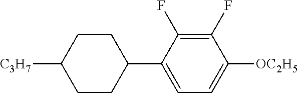 | 15 |
| Compound 10 | 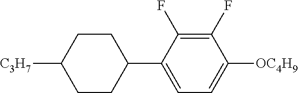 | 3 |
| Compound 11 | 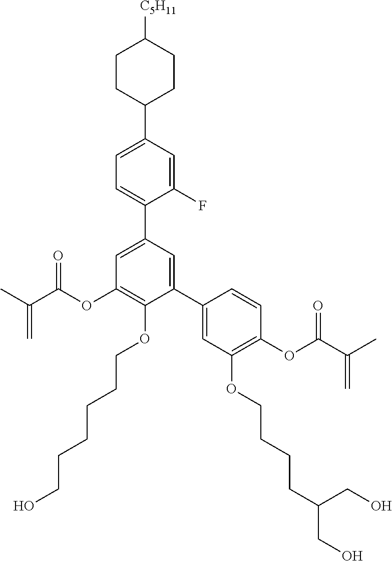 | 0.4 |
| Compound 12 | 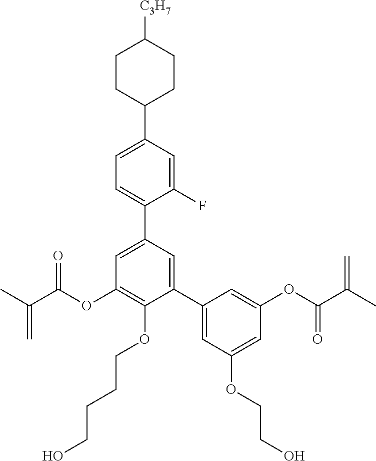 | 0.4 |
| Compound 13 | 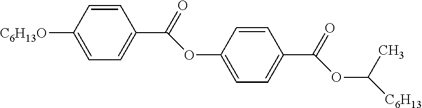 | 0.8 |

The liquid crystal composition provided in Example 3 has the following property parameters: Tni of 80° C., γ1 of 82 mPa s, Δn of 0.127, nₑ of 1.5915, Δε of −4.16, ε^{⊥} of 7.78, K₁₁ of 13.91, K₃₃ of 16.92, Pitch of 8.6 μm, and Tr of 6.49%. There is no crystal precipitation when the liquid crystal composition is stayed at −20° C. for 480 hours.

In the liquid crystal composition provided in Example 4, Compounds 1-11 are liquid crystal materials, in which the Compounds 3-5 are liquid crystal compounds represented by formula I, Compounds 12 and 13 are first self-alignment additives represented by formula III, and Compound 14 is a chiral agent. On a basis of the total mass of the liquid crystal composition, the Compounds 1-11 are 97.4% by mass, the Compound 12 is 0.6% by mass, the Compound 13 is 0.6% by mass, and the Compound 14 is 1.4% by mass. The Compounds 1 to 14 in the liquid crystal composition provided in Example 4 are shown in Table 4 as to their structures and amounts by mass.

TABLE 4

| | | Amount by |
|---|---|---|
| Compound | Structure | mass (%) |
| Compound 1 | 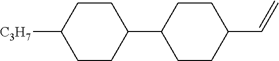 | 30 |
| Compound 2 | 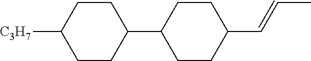 | 6 |
| Compound 3 | 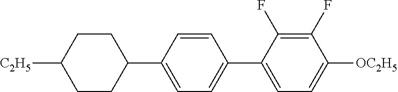 [SMILES: CCOc1ccc(-c2ccc(C3CCC(CC)CC3)cc2)c(F)c1F] | 5 |
| Compound 4 | 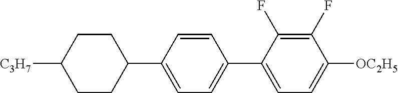 | 9 |
| Compound 5 | 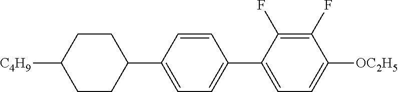 | 6 |
| Compound 6 | 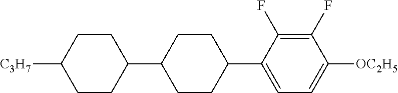 | 9 |
| Compound 7 | 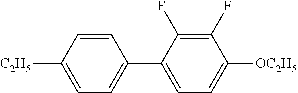 [SMILES: CCOc1ccc(-c2ccc(CC)cc2)c(F)c1F] | 14 |
| Compound 8 | 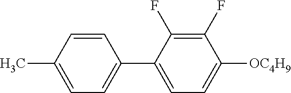 | 4 |
| Compound 9 | 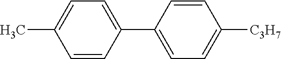 | 3 |
| Compound 10 | 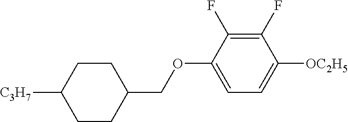 | 11 |
| Compound 11 | 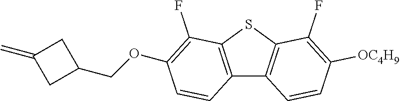 | 3 |
| Compound 12 | 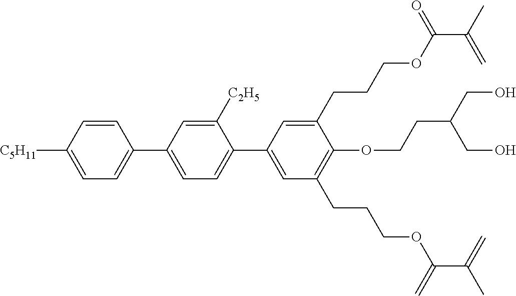 | 0.6 |
| Compound 13 | 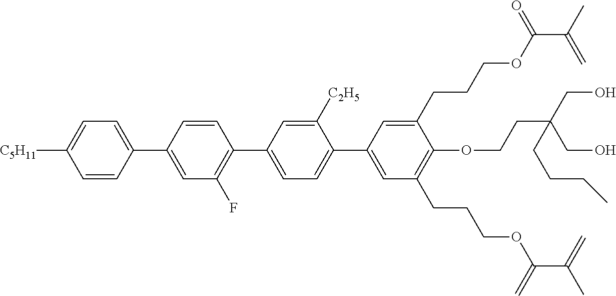 | 0.6 |
| Compound 14 | 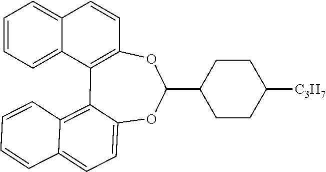 | 1.4 |

The liquid crystal composition provided in Example 4 has the following property parameters: Tni of 79° C., γ1 of 85 mPa·s, Δn of 0.1348, nₑ of 1.6015, Δε of −4.26, ε^{⊥} of 8.14, K₁₁ of 14.65, K₃₃ of 16.59, Pitch of 3.5 μm, and Tr of 6.35%. There is no crystal precipitation when the liquid crystal composition is stayed at −20° C. for 480 hours.

In the liquid crystal composition provided in Comparative Example, Compounds 1-10 are all liquid crystal materials, and the Compounds 1-10 are 100% by mass on a basis of the total mass of the liquid crystal composition. The Compounds 1-10 in the liquid crystal composition provided in Comparative Example are shown in Table 5 as to their structures and amounts by mass.

TABLE 5

| Compound | Structure | Amount by mass (%) |
|---|---|---|
| Compound 1 | 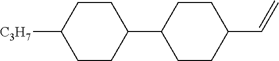 | 32 |
| Compound 2 | 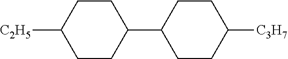 | 3 |
| Compound 3 | 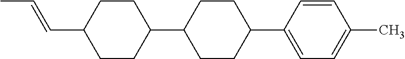 [SMILES: C/C=C/C1CCC(C2CCC(c3ccc(C)cc3)CC2)CC1] | 6 |
| Compound 4 | 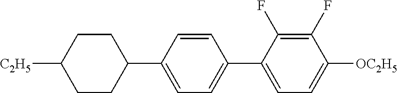 [SMILES: CCOc1ccc(-c2ccc(C3CCC(CC)CC3)cc2)c(F)c1F] | 7 |
| Compound 5 | 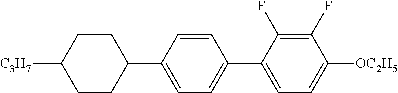 | 10 |
| Compound 6 | 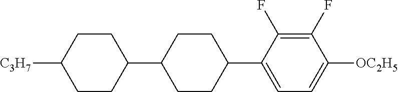 | 12 |
| Compound 7 | 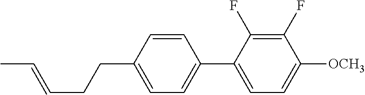 [SMILES: C/C=C/CCc1ccc(-c2ccc(OC)c(F)c2F)cc1] | 6 |
| Compound 8 | 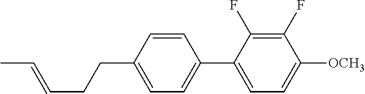 [SMILES: C/C=C/CCc1ccc(-c2ccc(OC)c(F)c2F)cc1] | 10 |
| Compound 9 | 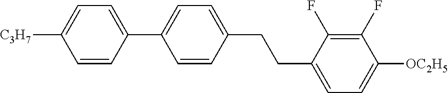 | 6 |
| Compound 10 | 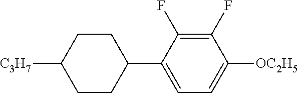 | 8 |

The liquid crystal composition provided in Comparative Example has the following property parameters: Tni of 78° C., γ1 of 66 mPa·s, Δn of 0.1501, nₑ of 1.6535, Δε of −3.2, ε^{⊥} of 6.1, K₁₁ of 13.83, K₃₃ of 14.91, and Tr of 6.05%. There is no crystal precipitation when the liquid crystal composition is stayed at −20° C. for 480 hours.

As can be seen from the above Tables 1-5, since the liquid crystal compositions of Examples 1-4 include the chiral agent, the transmittance Tr in Examples 1-4 is greater than the transmittance in Comparative Example, indicating that the transmittance of the display panel prepared from the liquid crystal composition can be effectively increased by the addition of the chiral agent. Moreover, since the liquid crystal compositions of Examples 1-4 include the self-alignment additive (at least one of the first self-alignment additive and the second self-alignment additive), the self-alignment additive can polymerize through the polymerizable compound to form an alignment layer during the manufacturing process, reducing the processes of original alignment films, simplifying the processes, and reducing the manufacturing cost.

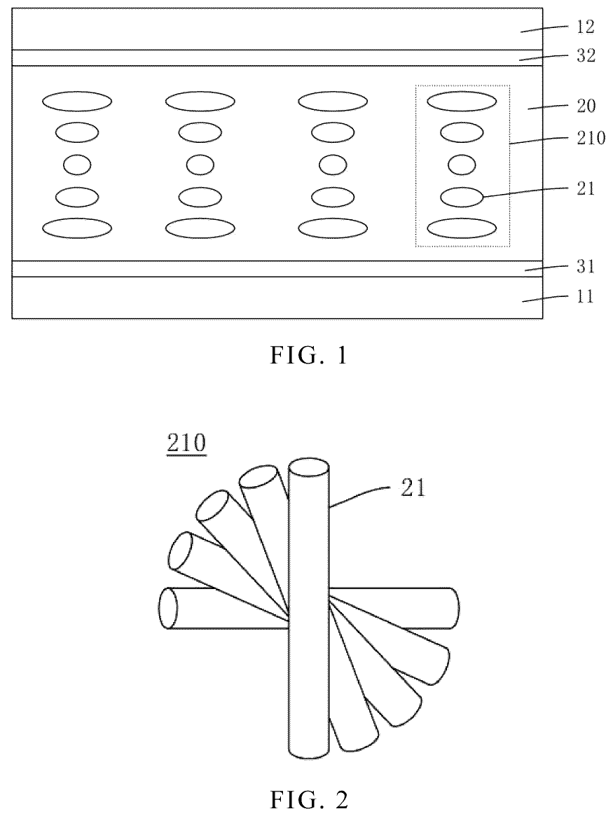

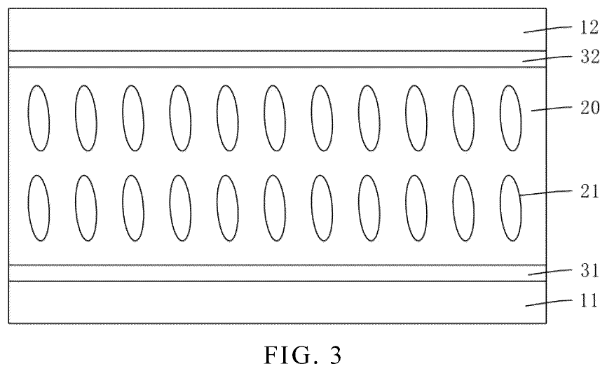

As illustrated in FIG. 1, FIG. 2, and FIG. 3, some embodiments of the disclosure further provide a display panel including a first substrate 11, a second substrate 12, and a liquid crystal layer 20.

The first substrate 11 and the second substrate 12 are disposed opposite to each other, and the liquid crystal layer 20 is disposed between the first substrate 11 and the second substrate 12. The liquid crystal layer 20 is prepared from the liquid crystal compound and the chiral agent in the liquid crystal composition as described in any one of the above-mentioned embodiments.

In some embodiments, the display panel further includes a first alignment layer 31 and a second alignment layer 32, the first alignment layer 31 is disposed on a side of the first substrate 11 close to the liquid crystal layer 20, and the second alignment layer 32 is disposed on a side of the second substrate 12 close to the liquid crystal layer 20. The liquid crystal layer 20 is disposed between the first alignment layer 31 and the second alignment layer 32. The first alignment layer 31 and the second alignment layer 32 are formed by the polymerization of the self-alignment additive in the liquid crystal composition as described in any one of the above-mentioned embodiments.

In some embodiments, the liquid crystal layer 20 includes a plurality of liquid crystal molecules 21. When the liquid crystal composition provided in the embodiments of the disclosure is used to prepare a VA liquid crystal display panel, the first alignment layer 31 and the second alignment layer 32 can provide an initial alignment direction for the liquid crystal molecules 21, and the initial alignment direction is perpendicular to the first substrate 11 and the second substrate 12.

In some embodiments, the display panel is switched between a first mode and a second mode. When the display panel is configured in the first mode, the liquid crystal layer 20 includes a plurality of liquid crystal alignment groups 210, each liquid crystal alignment group 210 includes a plurality of liquid crystal molecules 21 arranged in a direction from the first substrate 11 to the second substrate 12, and orthographic projections of two adjacent liquid crystal molecules 21 in the liquid crystal arrangement group 210 on the first substrate 11 intersect with each other. When the display panel is configured in the second mode, the liquid crystal molecules 21 are arranged in a direction perpendicular to the first substrate 11 or the second substrate 12; alternatively, the liquid crystal molecules 21 are arranged in a direction close to a direction perpendicular to the first substrate 11 or the second substrate 12.

Based on the above, in the embodiments of the disclosure, since the liquid crystal composition includes the chiral agent, which provides chiral centers for the liquid crystal composition, the liquid crystal molecules in the liquid crystal layer prepared from the liquid crystal composition can generate a horizontal spiral deflection under the action of voltage, improving light leakage at gaps of electrodes of the VA liquid crystal display panel. Therefore, the liquid crystal molecules in the liquid crystal layer prepared from the liquid crystal composition have both vertical deflection and horizontal rotation, so that the display panel including the liquid crystal layer have both high contrast characteristics of the VA display panel and high transmittance characteristics of the TN display panel, effectively improving the transmittance of the display panel prepared from the liquid crystal composition.

Some embodiments of the disclosure further provide a display device including the display panel as described in any one of the above-mentioned embodiments.

In some embodiments, the display device further includes a backlight module, and the display panel is disposed on a light output side of the backlight module.

It can be understood that since the display device provided by the embodiments of the disclosure includes the same display panel as described in any one of the above-mentioned embodiments, the display device has the same beneficial effects as the display panel as described in any one of the above-mentioned embodiments, and will not be repeated herein.

In the disclosure, the terms “first” and “second” are used only for the purpose of description, and cannot be understood as indicating or implying relative importance or implying the number of features indicated. Therefore, the features limited to “first” and “second” may explicitly or implicitly include one or more features. Moreover, the term “a plurality of” refers to two or more than two, unless otherwise specified.

In the above embodiments, the description of each embodiment has its own emphasis, and for parts not described in detail in a certain embodiment, please refer to relevant description of other embodiments.

The embodiments, examples, and related technical features of the disclosure may be combined and replaced with each other without conflict.

The above are merely preferred embodiments of the disclosure, and do not limit the disclosure in any form. Any simple modifications, equivalent changes, and modifications made to the above embodiments according to the technical essence of the disclosure without departing from the contents of the technical solutions of the disclosure still fall within the scope of the technical solutions of the disclosure.

1. A liquid crystal composition comprising a liquid crystal compound and a chiral agent, wherein the liquid crystal compound is represented by the following formula I: 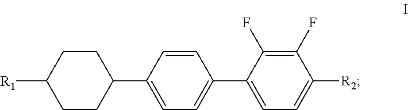
wherein R₁ and R₂ are independently selected from —H, —F, —Cl, —Br, —I, —CN, —SCN, —NCS, —SF₅, an alkyl group having 1-10 carbon atoms, an alkoxy group having 1-10 carbon atoms, an alkenyl group having 2-10 carbon atoms, an alkenyloxy group having 2-10 carbon atoms, an alkynyl group having 2-10 carbon atoms, or an alkynyloxy having 2-10 carbon atoms;
provided that when R₁ and R₂ have one or more end groups, the one or more end groups are not substituted, or, the one or more end groups are independently substituted by —CN or —CF₃;
when R₁ and R₂ have one or more —CH₂— groups, the one or more —CH₂— groups are not substituted, or, the one or more —CH₂— groups are independently substituted by —O—, —S—, —CO—, —C(O)O—, —OC(O)—, —CF₂O—, —OCF₂—, —CH₂—CH₂—, —CH₂O—, —OCH₂—, —CH═CH—, or —C≡C—, and heteroatoms therein directly linked to C are not directly linked to each other; and
when R₁ and R₂ have one or more H atoms, the one or more H atoms are not replaced, or, the one or more H atoms are independently replaced with F, Cl, Br, or I,
wherein the liquid crystal composition further comprises a second self-alignment additive represented by the following formula IV: 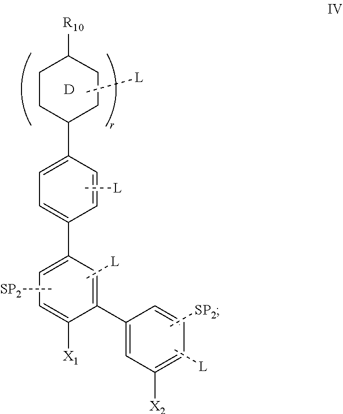
wherein 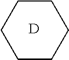
is selected from a fused ring, a spiro ring, a bridged ring, a cyclohexylidene group, a cyclohexenylene group, an epoxycyclohexyl group, or a phenylene group, and r is selected from 1 or 2;
R₁₀ is selected from an alkyl group having 1-10 carbon atoms, an alkoxy group having 1-10 carbon atoms, a chain alkenyl group having 2-10 carbon atoms, or a chain alkenyloxy group having 2-10 carbon atoms: provided that when R₁₀ has one or more H atoms, the one or more H atoms are replaced, or, the one or more H atoms are independently replaced with F, Cl, Br, or I; and when R₁₀ has one or more —CH₂— groups not connected together, the one or more —CH₂— groups not connected are not substituted, or, the one or more —CH₂— groups not connected together are independently substituted by a cyclopentylidene group, a cyclobutylidene group, a cyclopropylidene group, or —O—;
L is independently selected from —F, —Cl, —H, an alkyl group having 1-10 carbon atoms, an alkoxy group having 1-10 carbon atoms, a chain alkenyl group having 2-10 carbon atoms, or a chain alkenyloxy group having 2-10 carbon atoms: provide that when L has one or more H atoms, the one or more H atoms are not replaced, or, the one or more H atoms are independently replaced with F, Cl, Br, or I; and when R₁₀ has one or more —CH₂— groups not connected together, the one or more —CH₂— groups not connected are not substituted, or, the one or more —CH₂— groups not connected together are independently substituted by a cyclopentylidene group, a cyclobutylidene group, or a cyclopropylidene group;
SP₂ is independently selected from 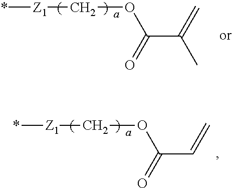
wherein Z₁ is independently selected from a single bond, —O—, —S—, —CO—, —C(O)O—, —OC(O)—, —CF₂O—, —OCF₂—, —CH₂—CH₂—, —CH₂O—, —OCH₂—, —CH═CH—, an alkylidene group having 1-10 carbon atoms, an alkenylidene group having 2-10 carbon atoms, or an alkynyl group having 2-10 carbon atoms; provide that when the SP₂ has one or more —CH₂— groups not connected together, the one or more —CH₂— groups not connected together are not substituted, or, the one or more —CH₂— groups not connected together are independently substituted by —O—, —S—, —CO—, —C(O)O—, —OC(O)—, —CF₂O—, —OCF₂—, —CH₂—CH₂—, —CH₂O—, —OCH₂—, —CH═CH—, or —C≡C—; when SP₂ has one or more H atoms, the one or more H atoms are not replaced, or, the one or more H atoms are independently replaced with F, Cl, Br, or I; and a is an integer from 1 to 10;
X₁ and X₂ are independently selected from —SP₃—OH; and wherein SP₃ is selected from an ether group; and
* indicates a linking site for linking SP₂ with 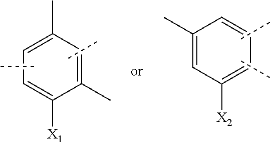
in the formula IV.

2. The liquid crystal composition of claim 1, wherein the liquid crystal composition has an optical anisotropy greater than or equal to 0.12 and less than or equal to 0.17.

3. The liquid crystal composition of claim 1, wherein the liquid crystal compound is selected from at least one of a group consisting of compounds represented by the following formulae I-1 to I-25:

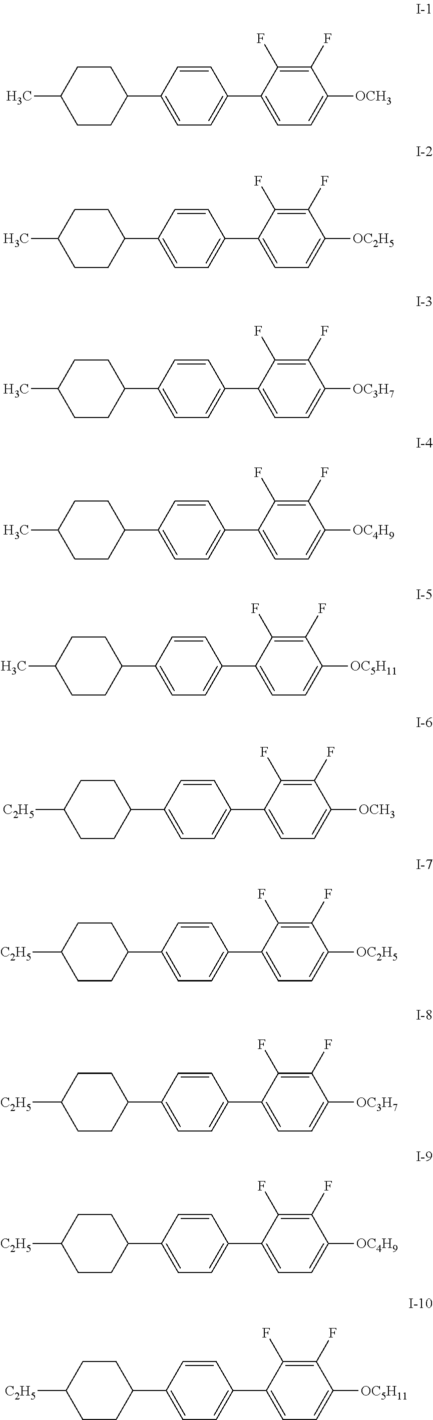

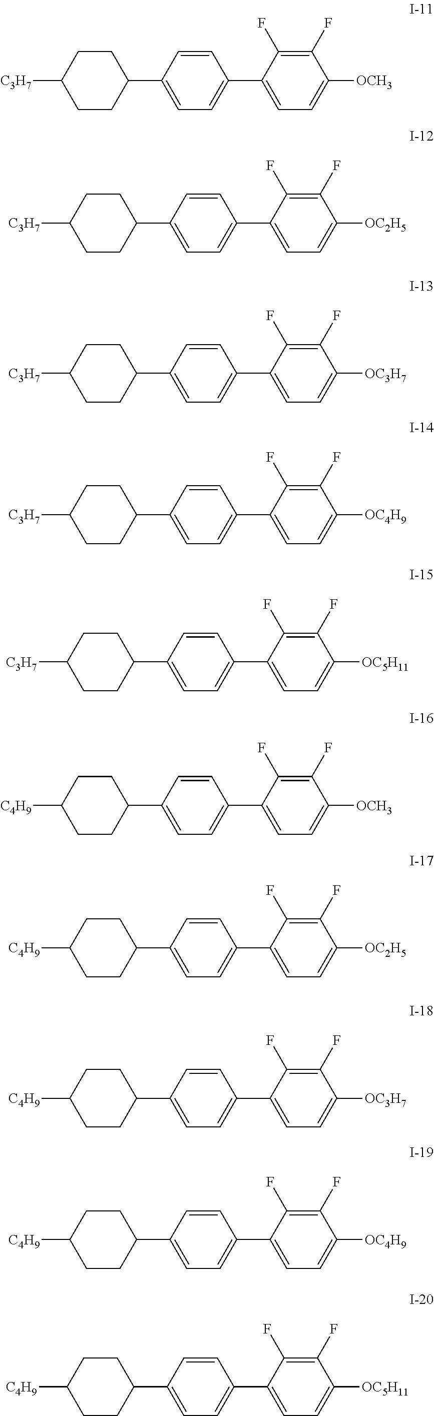

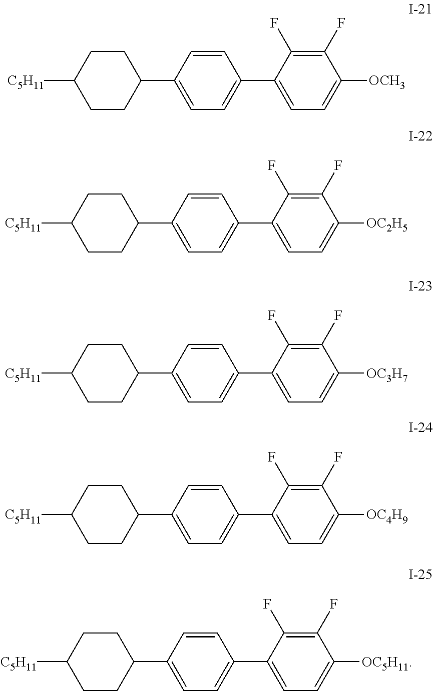

4. The liquid crystal composition of claim 1, wherein the chiral agent is selected from at least one of a group consisting of compounds represented by the following formulae C-1 to C-27:

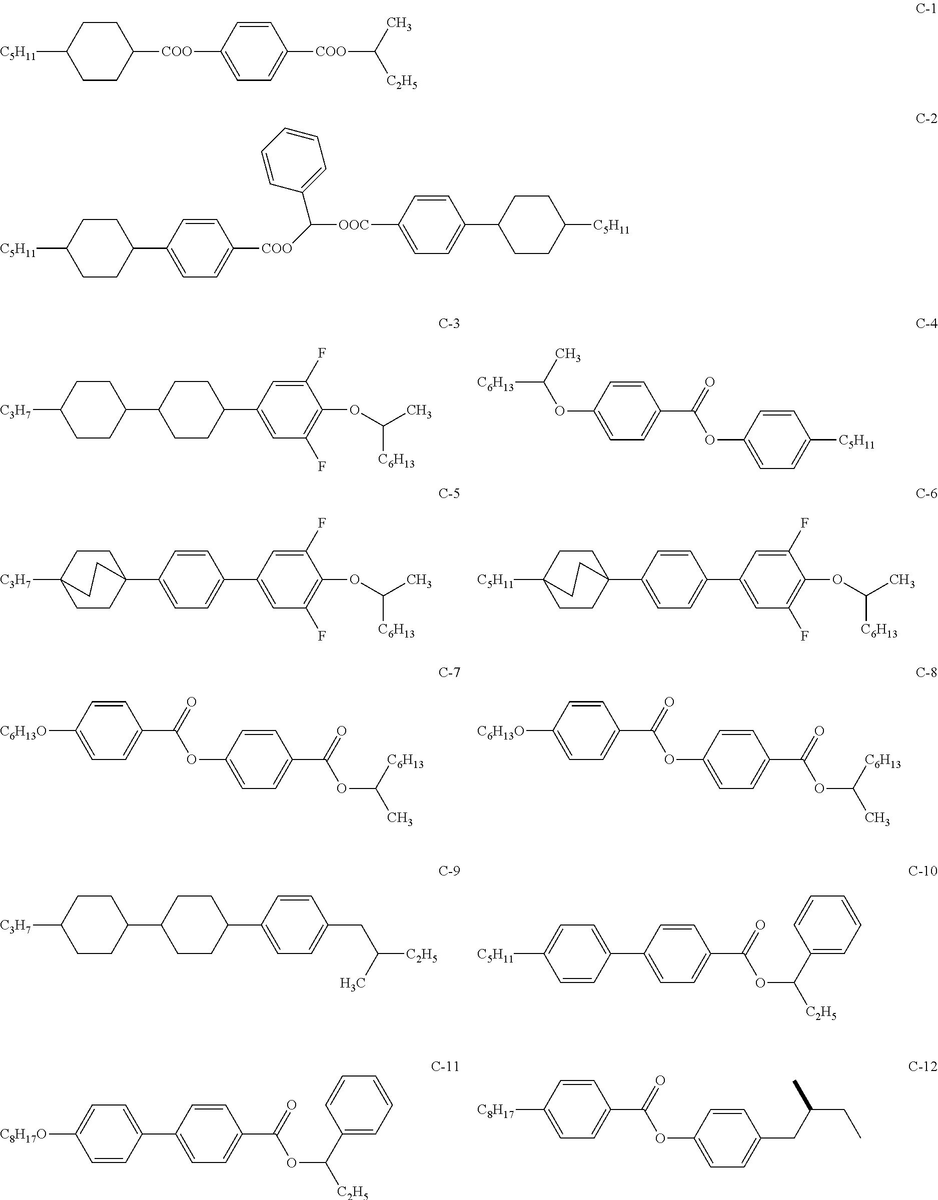

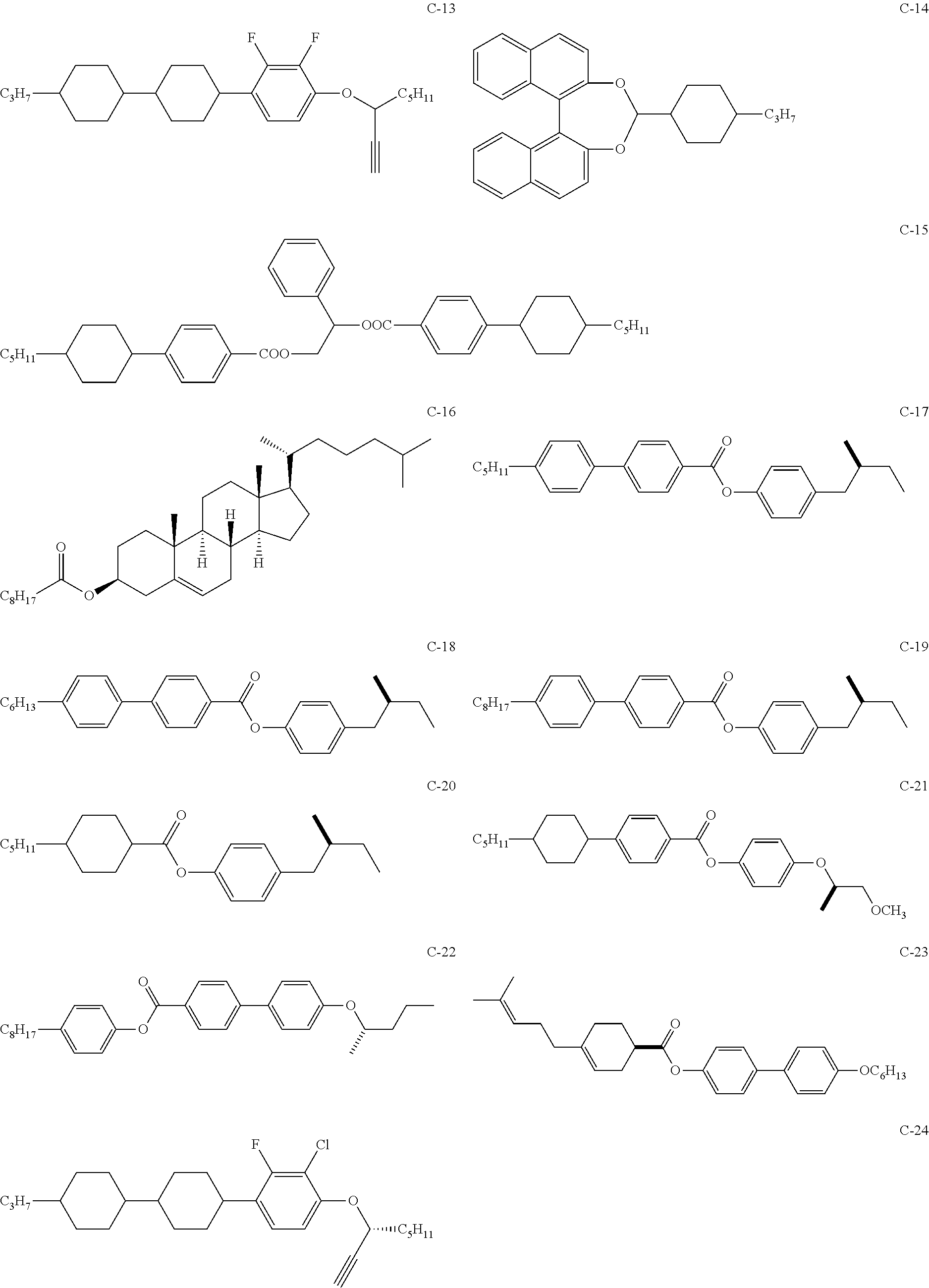

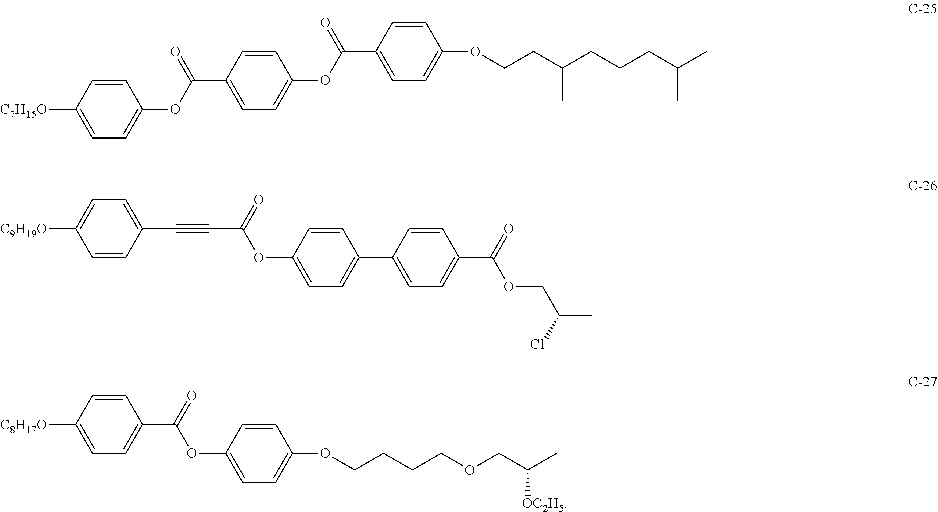

5. The liquid crystal composition of claim 1, wherein the chiral agent in the liquid crystal composition ranges from 0.01% to 2.0% by mass.

6. The liquid crystal composition of claim 1, further comprising a polymerizable compound represented by the following formula II: 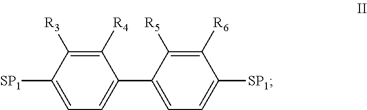
wherein R₃, R₄, R₅, and R₆ are independently selected from —H, —F, —Cl, —CF₃, an alkyl group having 1-5 carbon atoms, or an alkoxy group having 1-5 carbon atoms; and
SP₁ is independently selected from 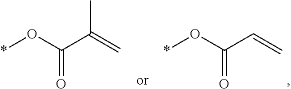
wherein * indicates a linking site for linking SP₁ with 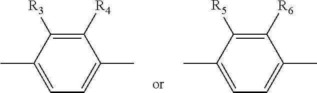
in the formula II.

7. The liquid crystal composition of claim 6, wherein the polymerizable compound is selected from at least one of a group consisting of compounds represented by the following formulae II-1 to II-50:

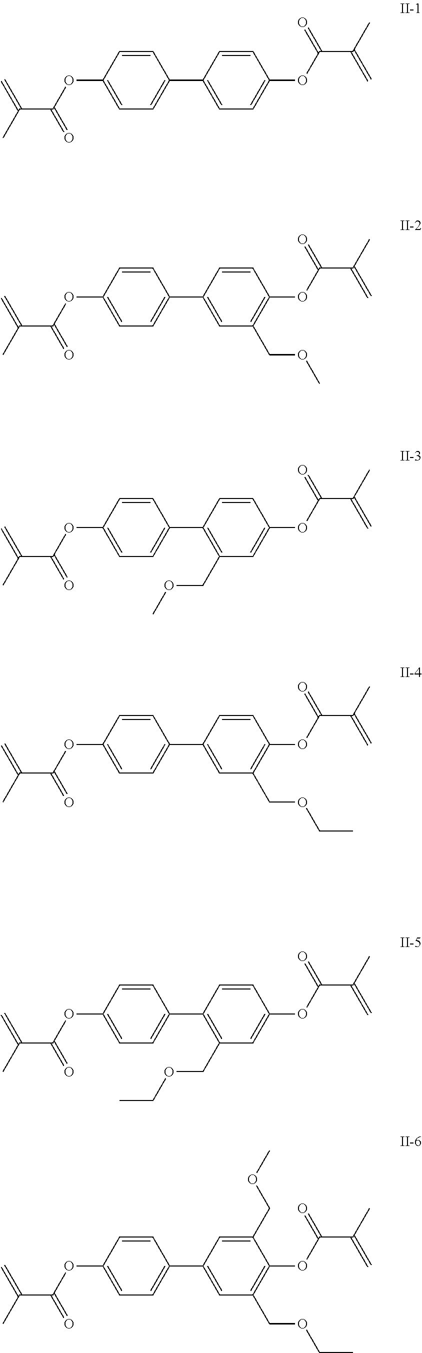

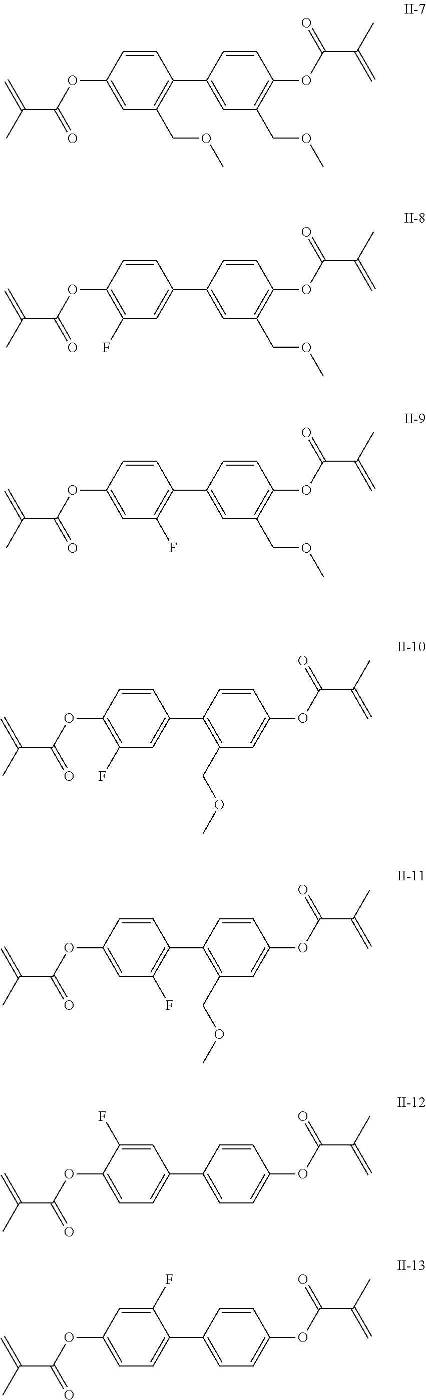

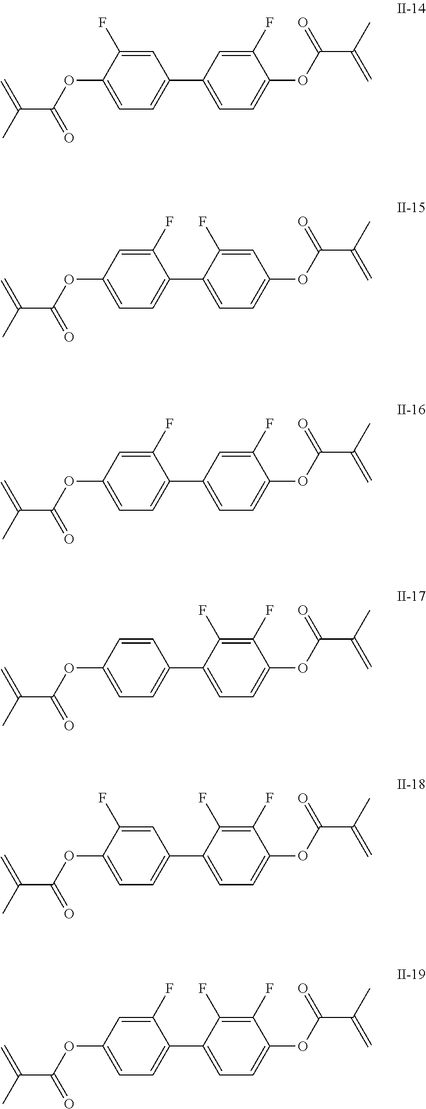

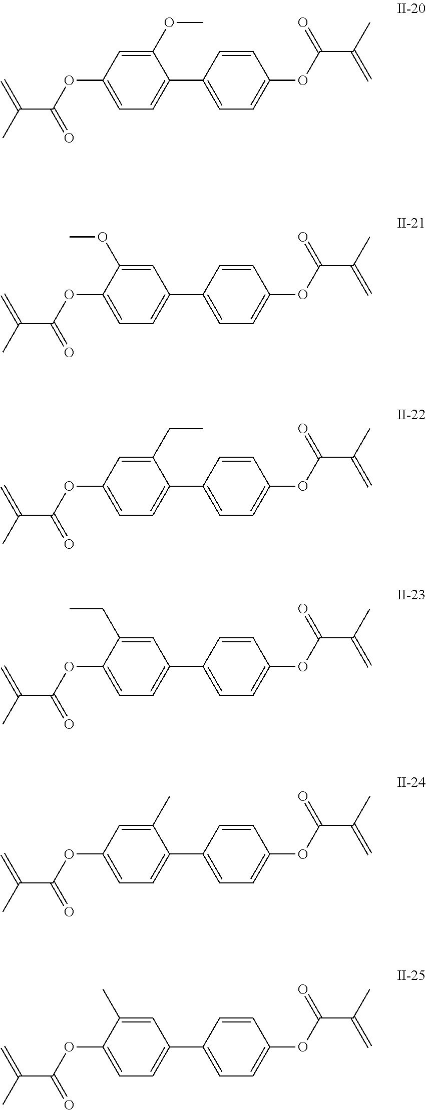

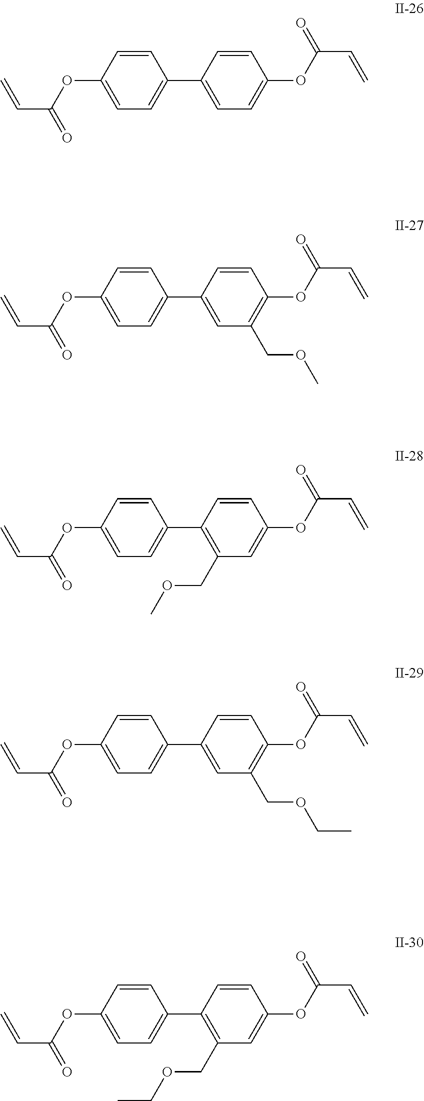

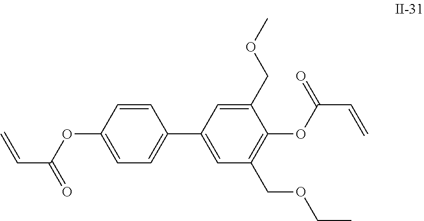 [SMILES: C=CC(=O)Oc1ccc(-c2cc(COC)c(OC(=O)C=C)c(COCC)c2)cc1]

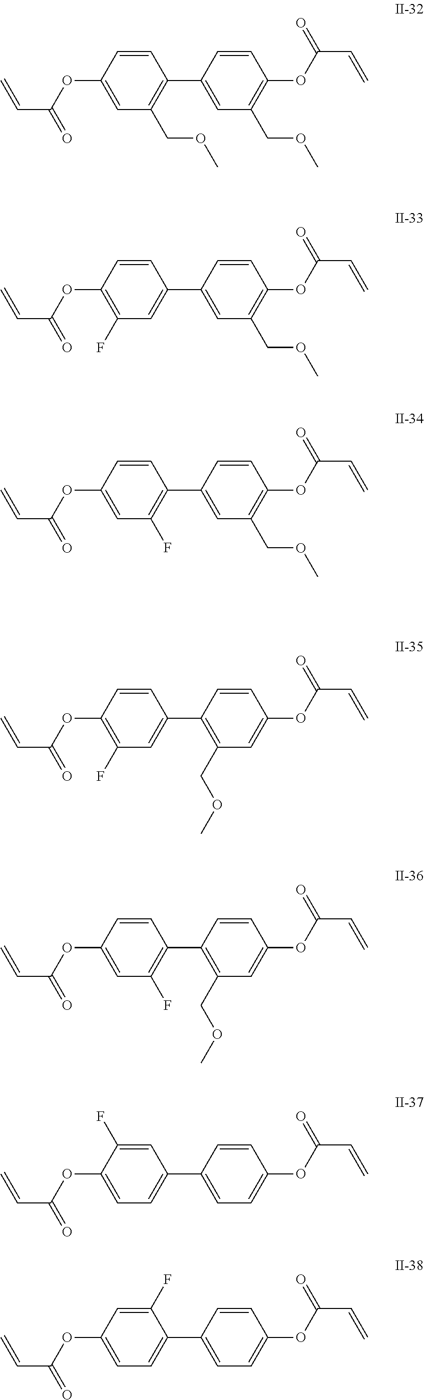

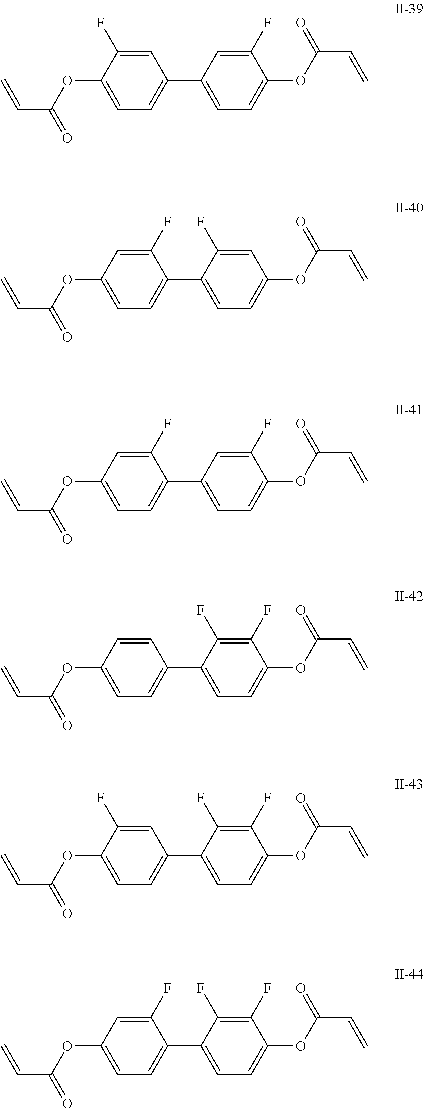

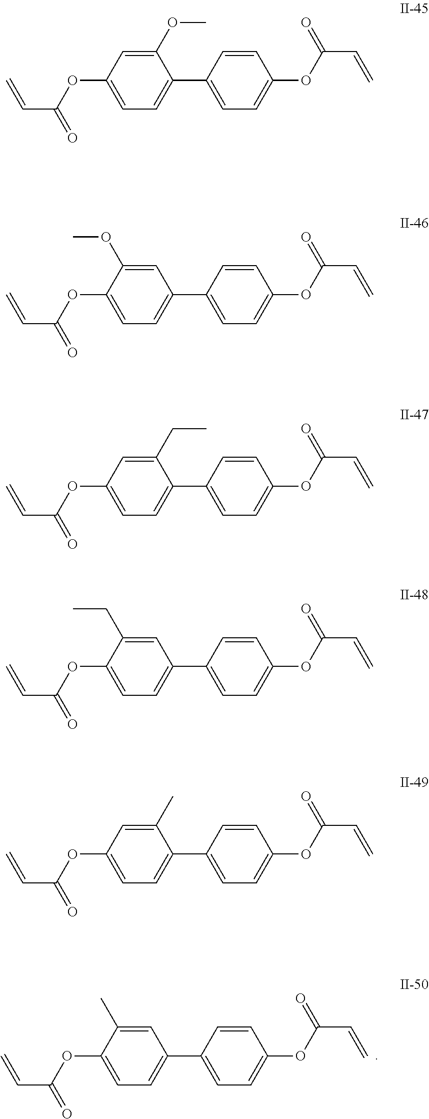

8. The liquid crystal composition of claim 6, wherein the polymerizable compound in the liquid crystal composition ranges from 0.01% to 2.0% by mass.

9. The liquid crystal composition of claim 1, further comprising a first self-alignment additive represented by the following formula III: 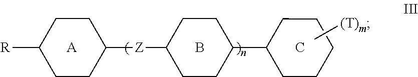
wherein 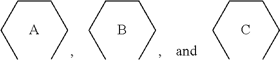
are independently selected from a substituted or unsubstituted aromatic group having 6-10 carbon atoms, or a substituted or unsubstituted cycloalkyl group having 6-10 carbon atoms;
R is selected from —H, a halogen atom, an alkyl group having 1-25 carbon atoms, an alkoxy group having 1-25 carbon atoms; provided that when R has one or more —CH₂— groups, the one or more —CH₂— groups are not substituted, or, the one or more —CH₂— groups in R are independently substituted by —O—, —S—, —CO—, —C(O)O—, —OC(O)—, —CH₂—CH₂—, —CH₂O—, or —OCH₂—, and heteroatoms therein directly linked to C are not directly linked to each other; and when R has one or more H atoms, the one or more H atoms are not replaced, or, the one or more H atoms in R are independently replaced with F, Cl, Br, or I;
Z is selected from —O—, —S—, —CO—, —CO—O—, —OCO—, —O—CO—O—, —OCH₂—, —CH₂O—, or —(CH₂)ₙ₁—, wherein n1 is selected from 1, 2, 3, or 4;
T is selected from 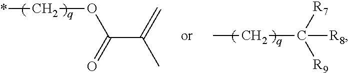
wherein R₇, R₈, and R₉ are independently selected from —OH, an alkyl group having 1-8 carbon atoms, and provide that when the alkyl group having 1-8 carbon atoms has one or more end groups, the one or more end groups are not substituted or substituted by —OH; when T has one or more —CH₂— groups, the one or more —CH₂— groups are not substituted or substituted by —O—; q is an integer from 0 to 8; and * indicates a linking site for linking T with 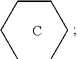
n is selected from 0, 1, 2, or 3; and
m is selected from 1, 2, 3, or 4.

10. The liquid crystal composition of claim 9, wherein the first self-alignment additive is selected from at least one of a group consisting of compounds represented by the following formulae III-1 to III-78: 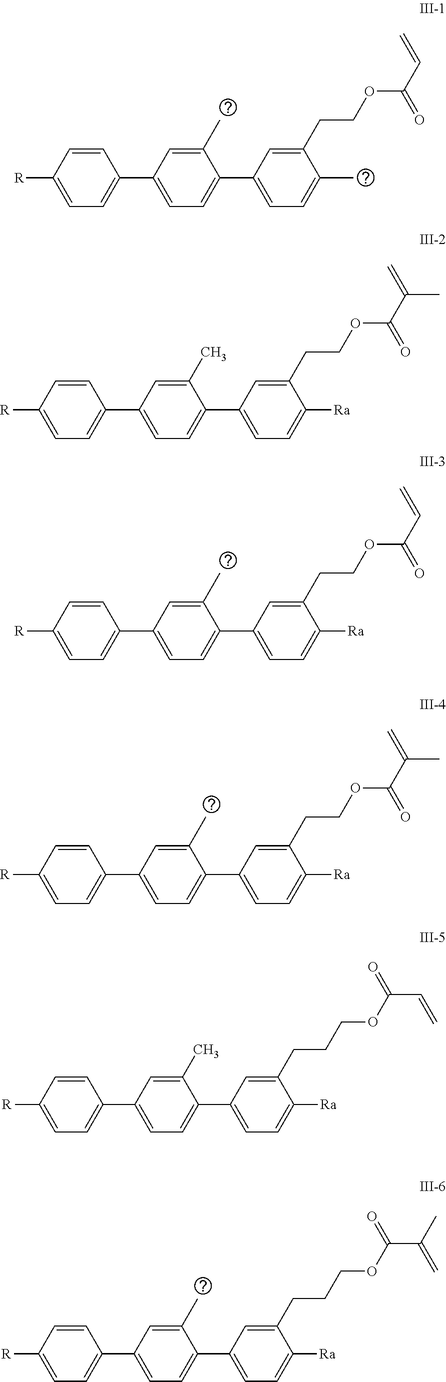 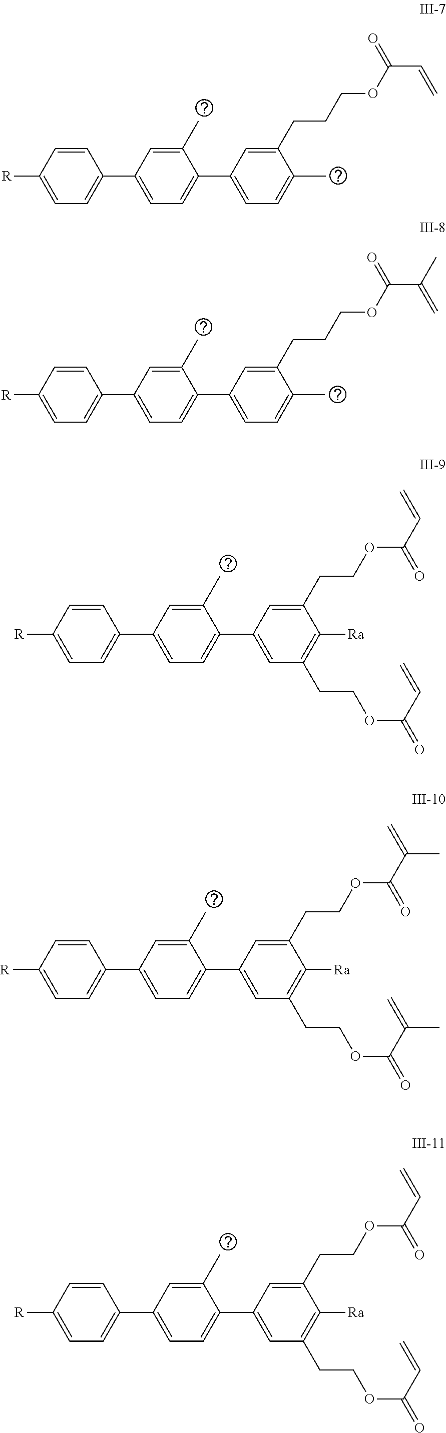 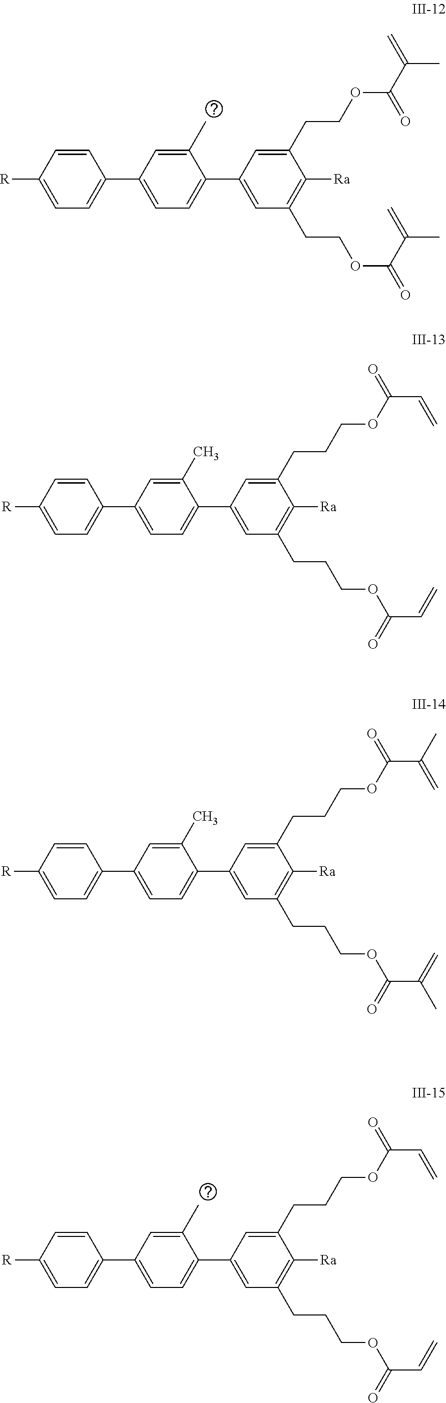 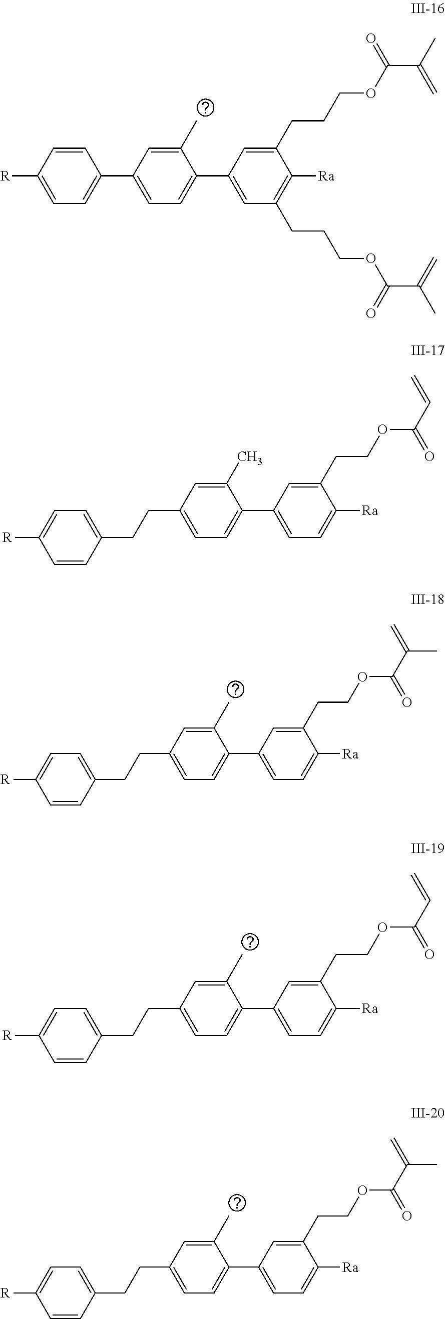 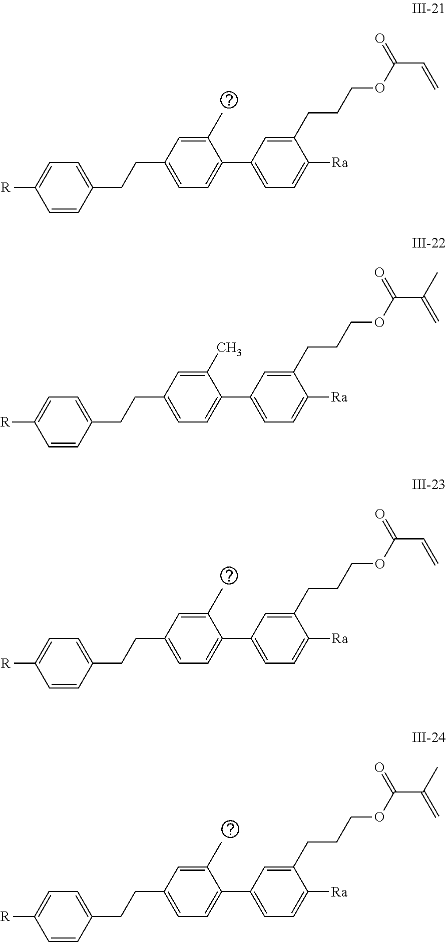 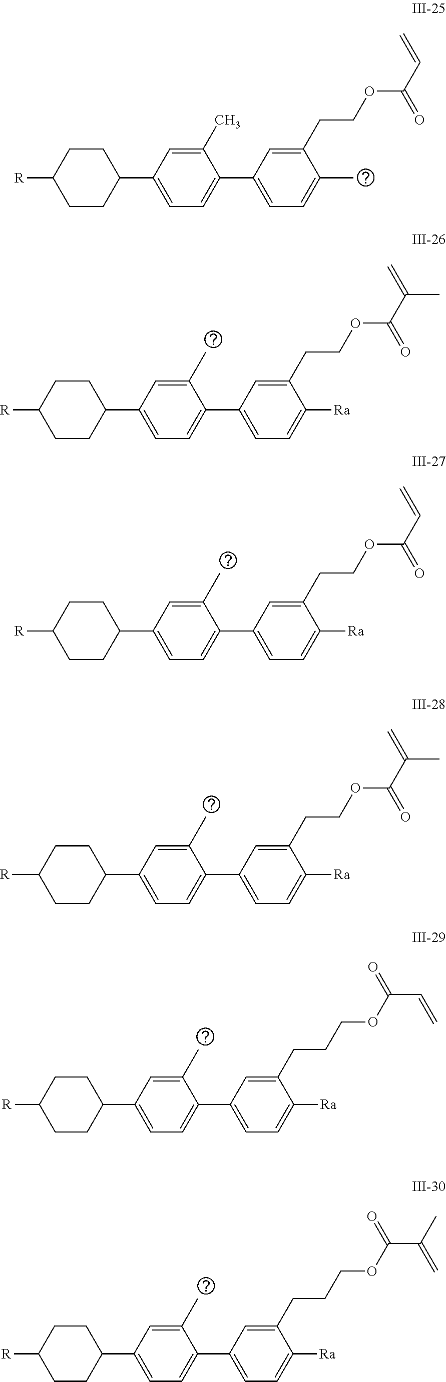 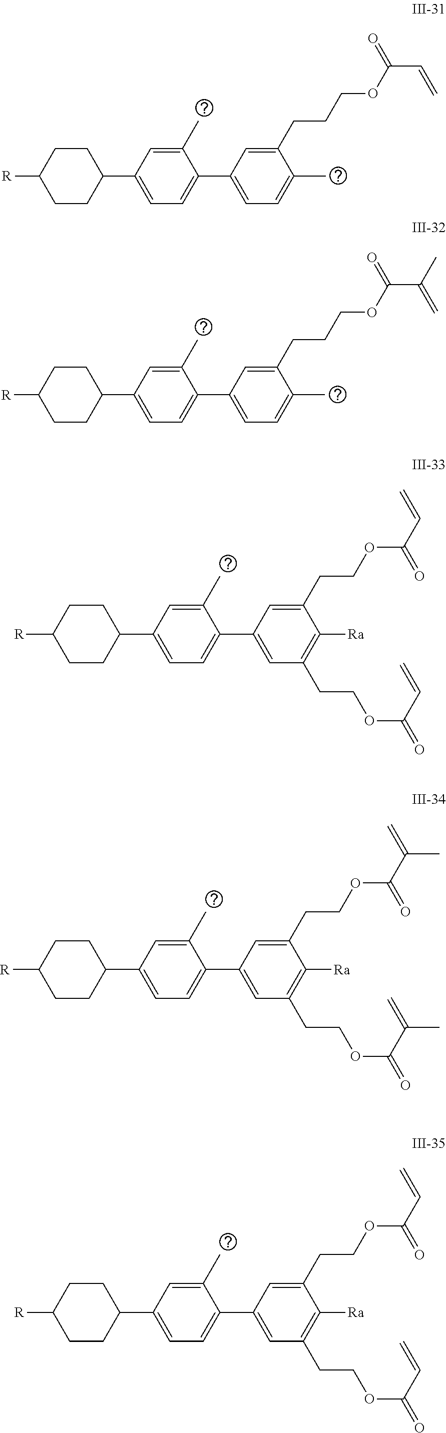 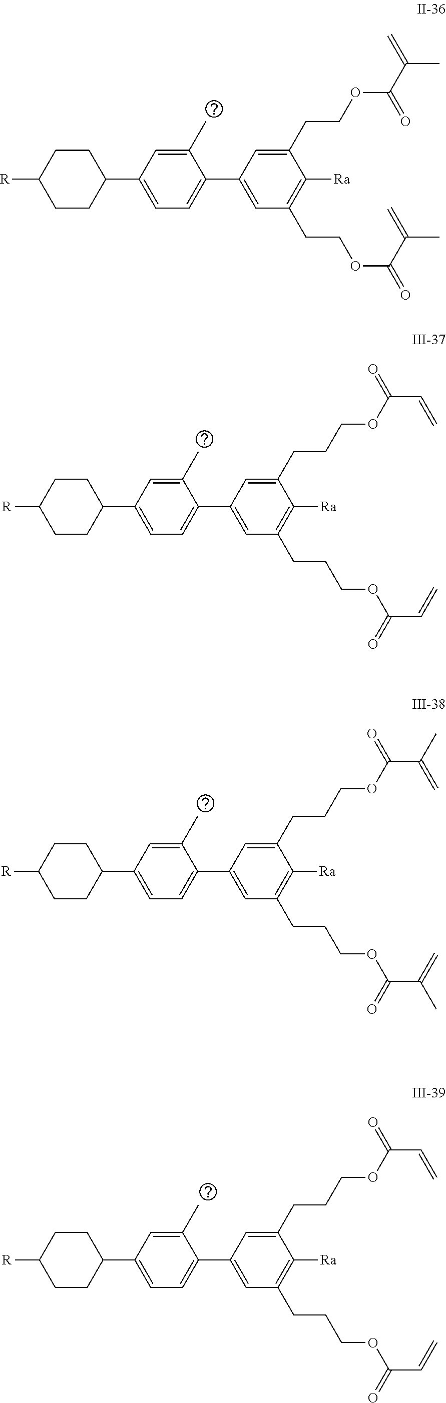 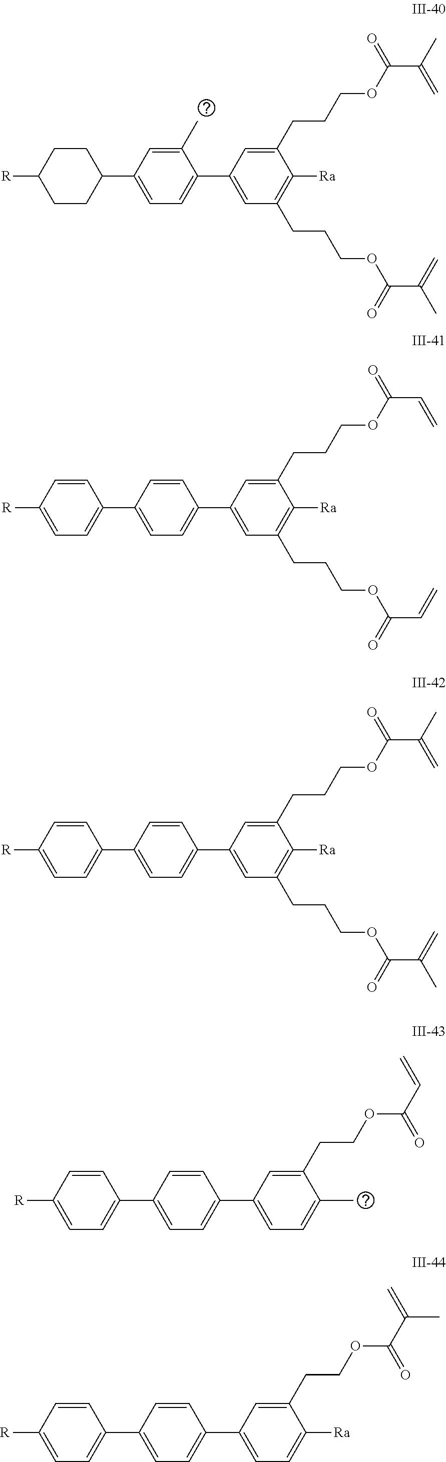 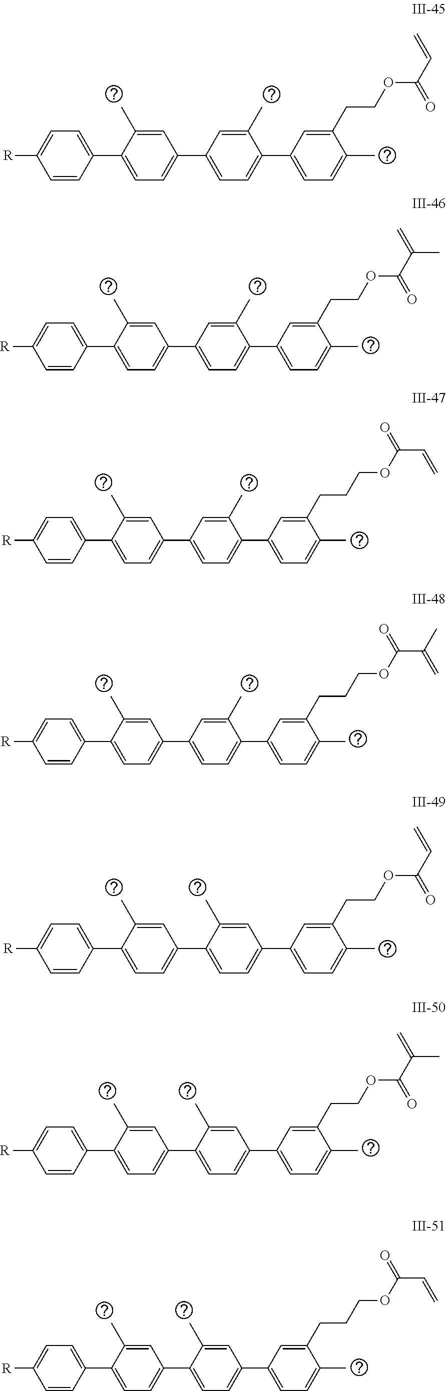 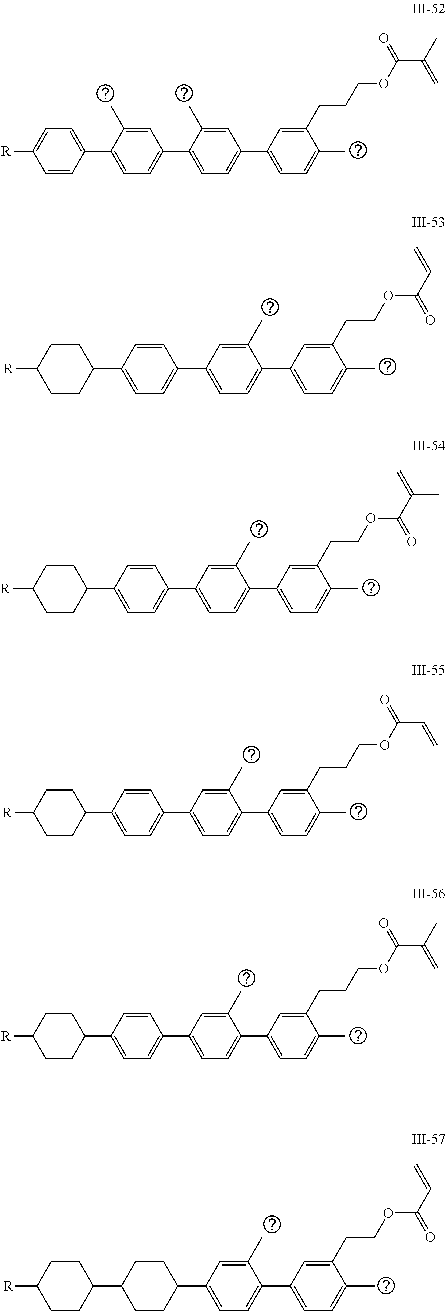 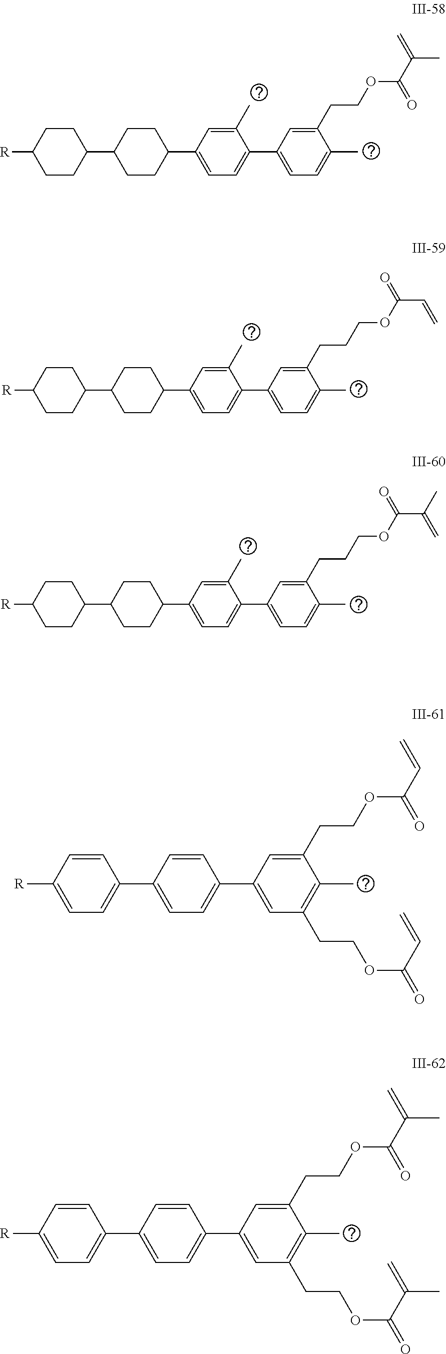 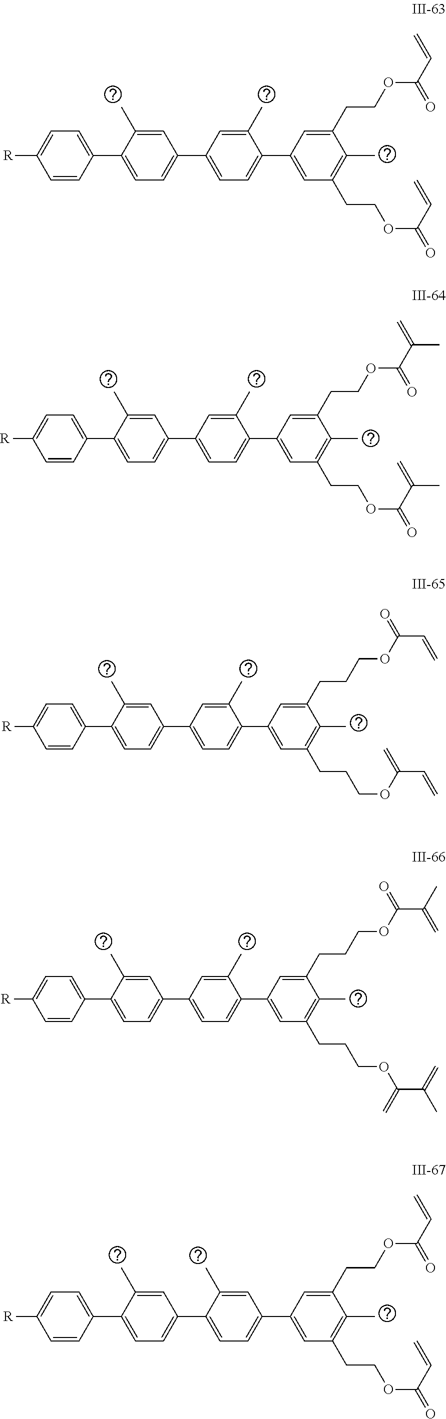 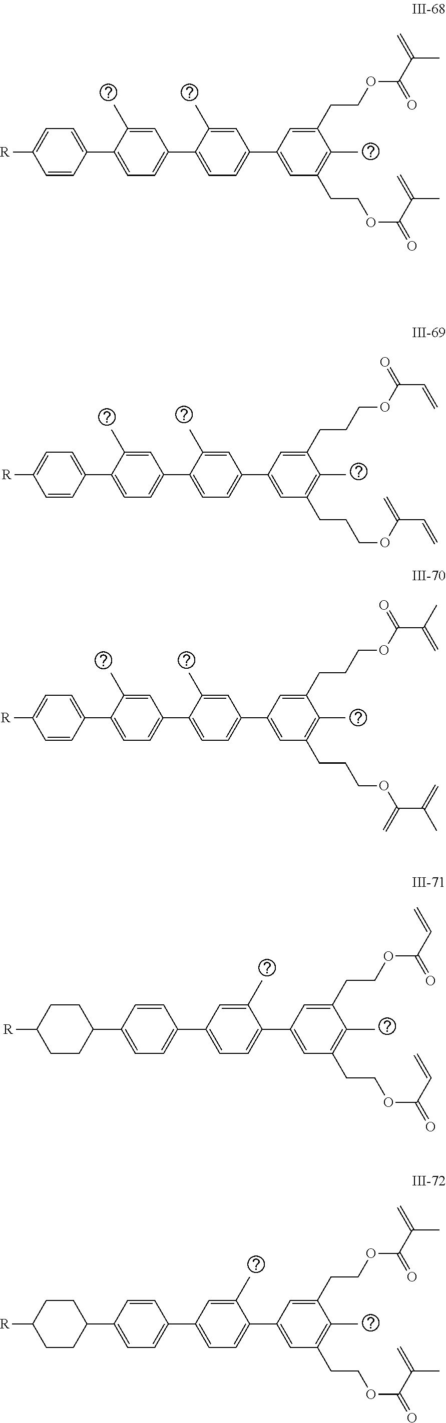 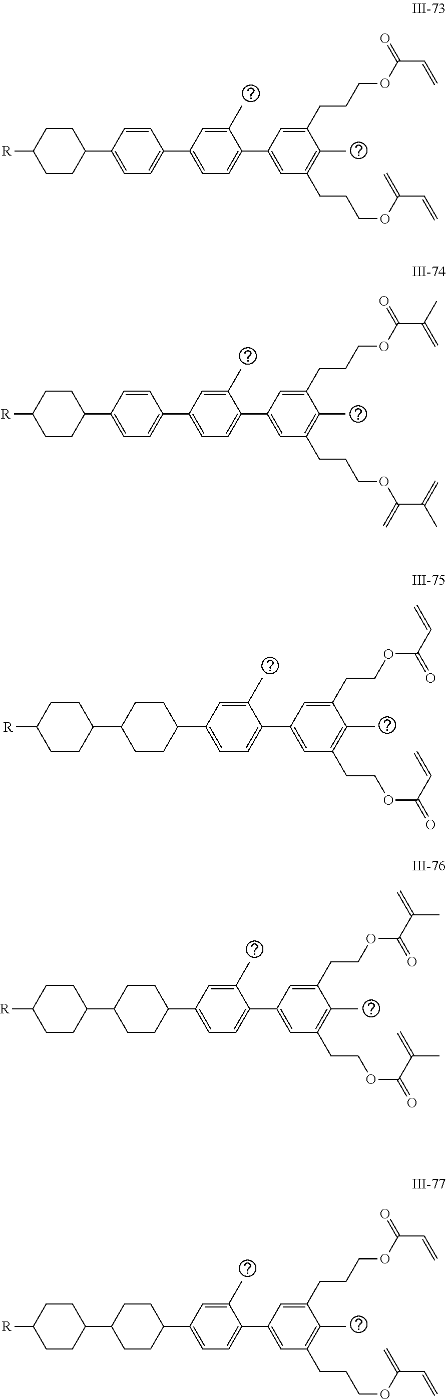 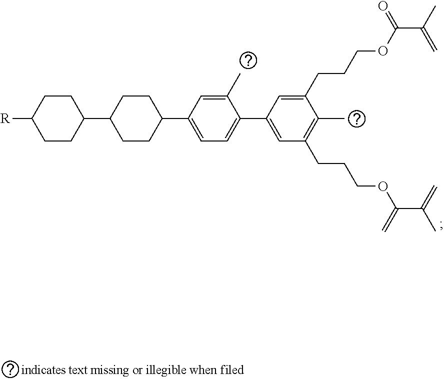
wherein Ra is

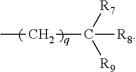

11. The liquid crystal composition of claim 9, wherein the first self-alignment additive in the liquid crystal composition ranges from 0.1% to 1.5% by mass.

12-13. (canceled)

14. The liquid crystal composition of claim 1, wherein the second self-alignment additive is selected from at least one of a group consisting of compounds represented by the following formulae IV-1 to IV-54:

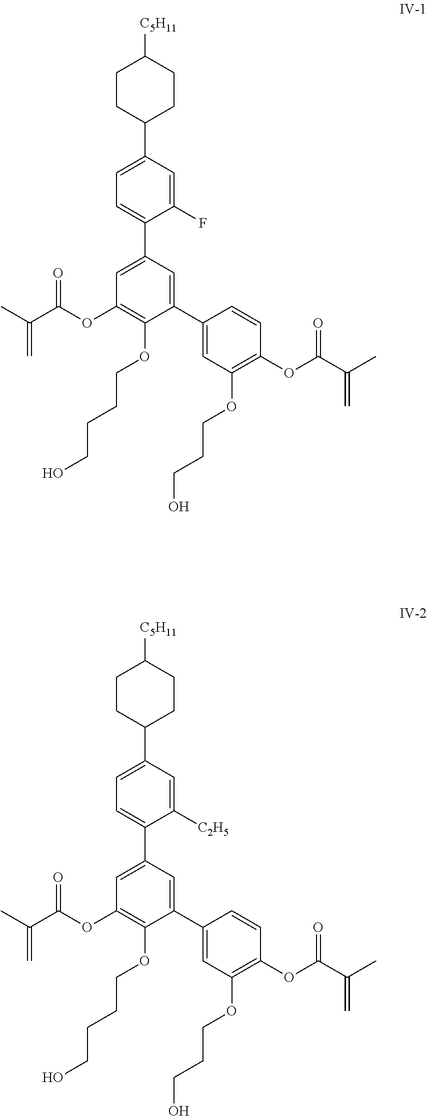

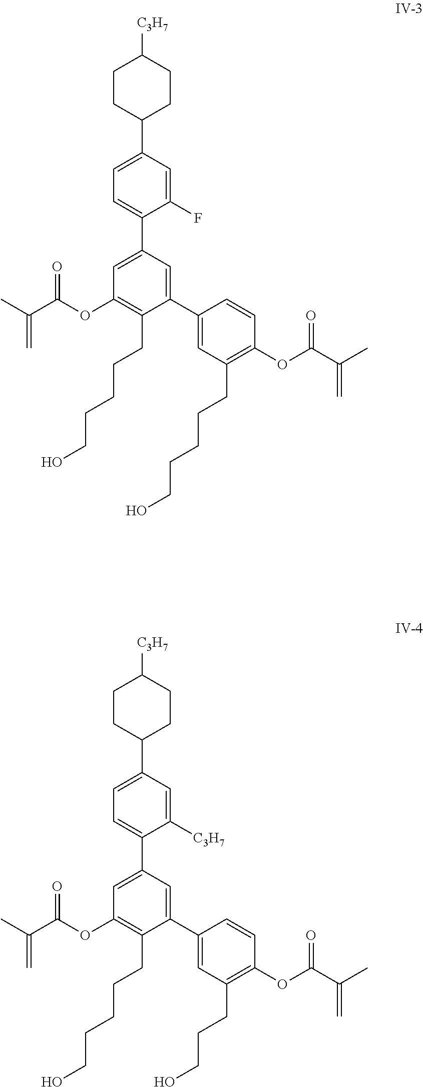

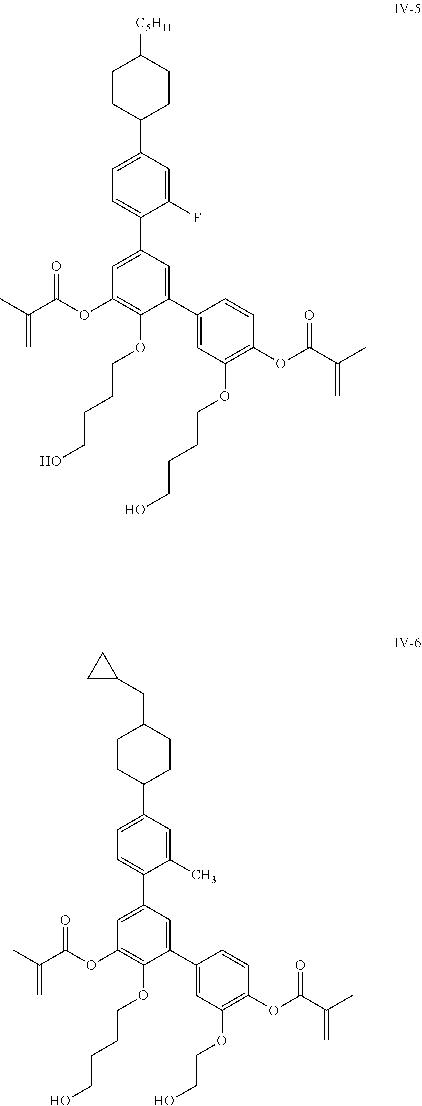

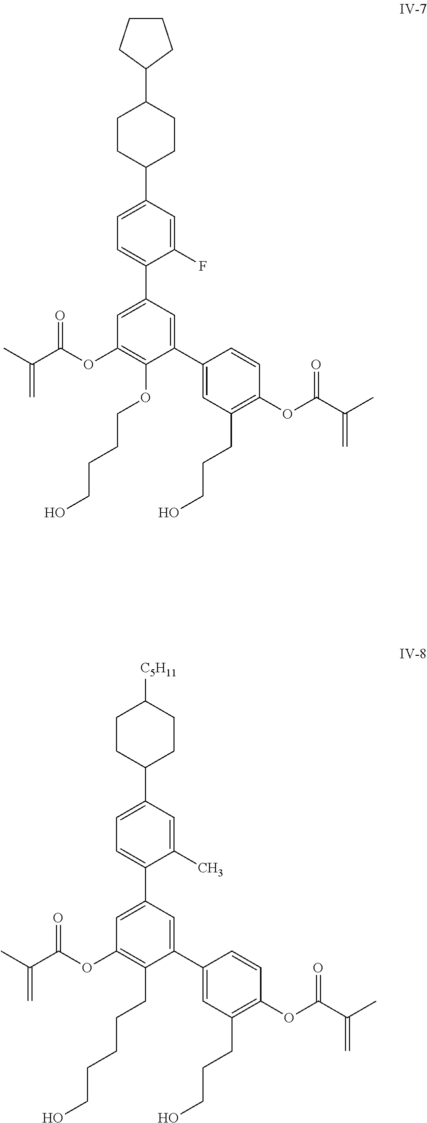

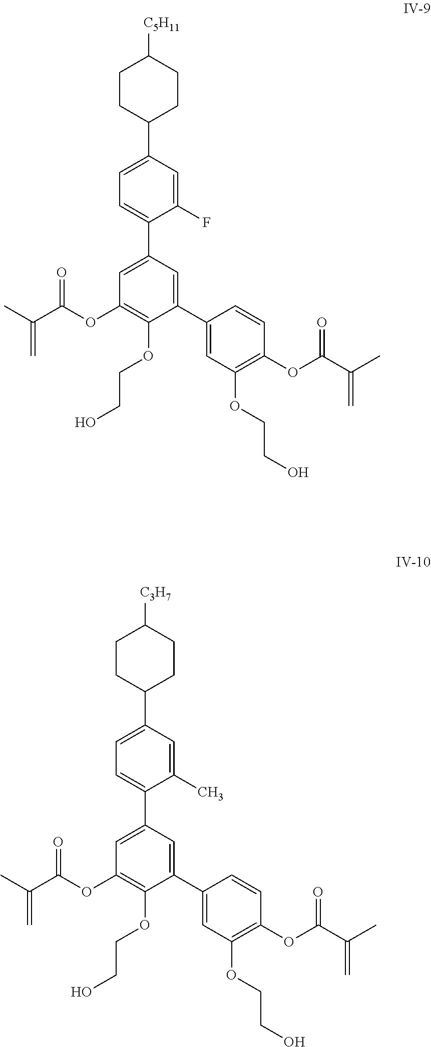

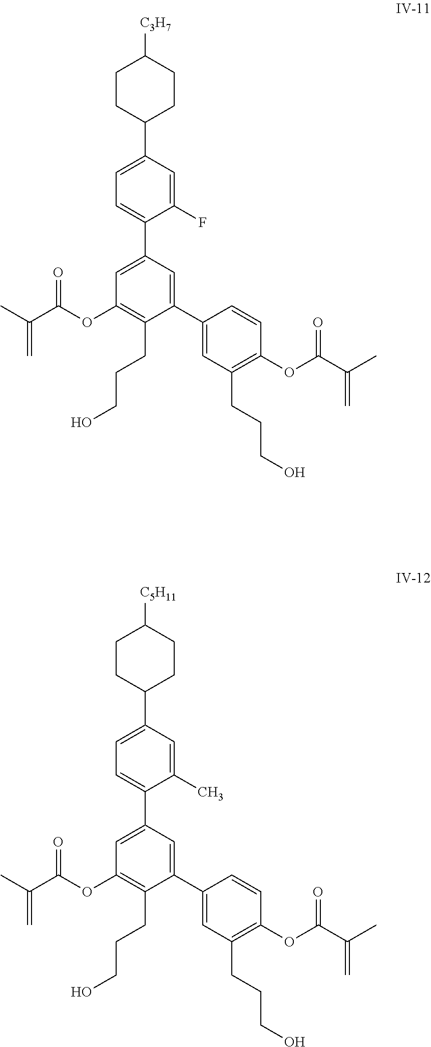

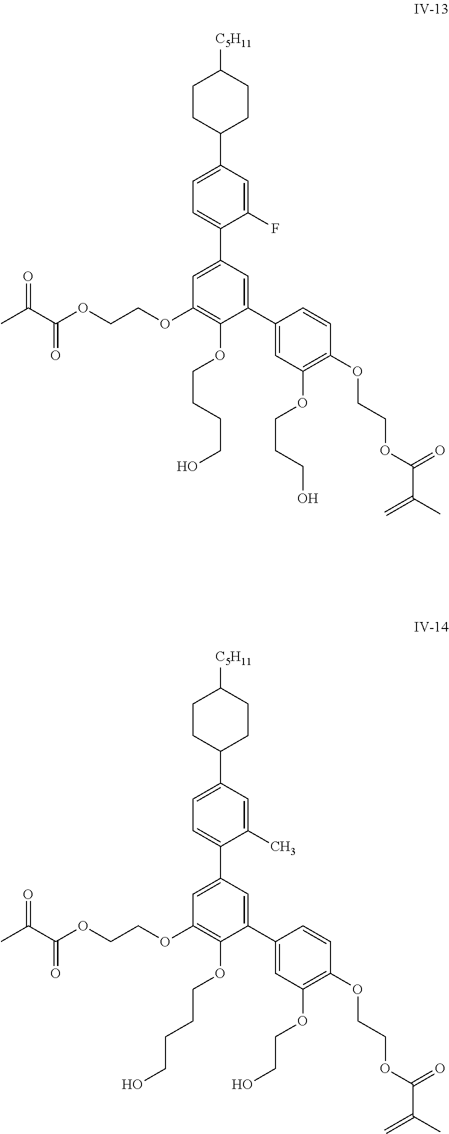

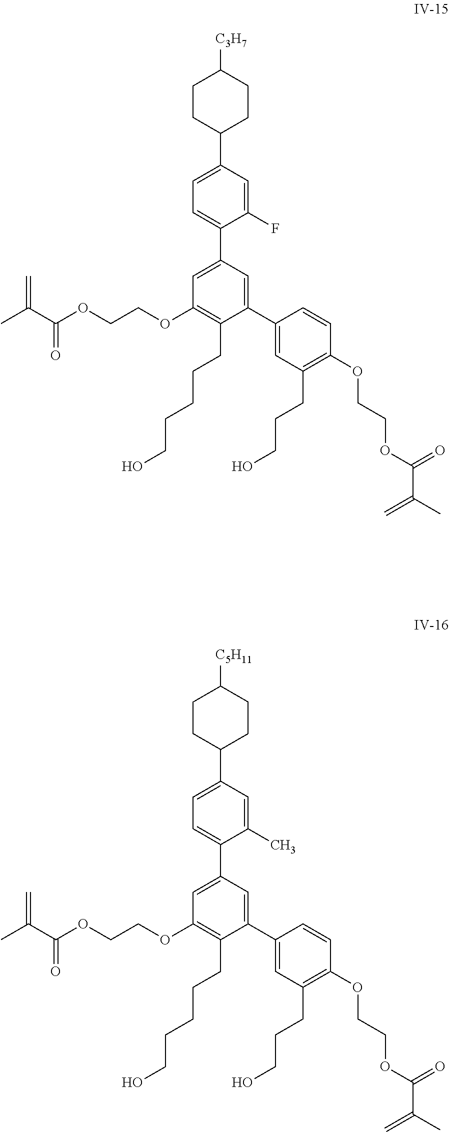

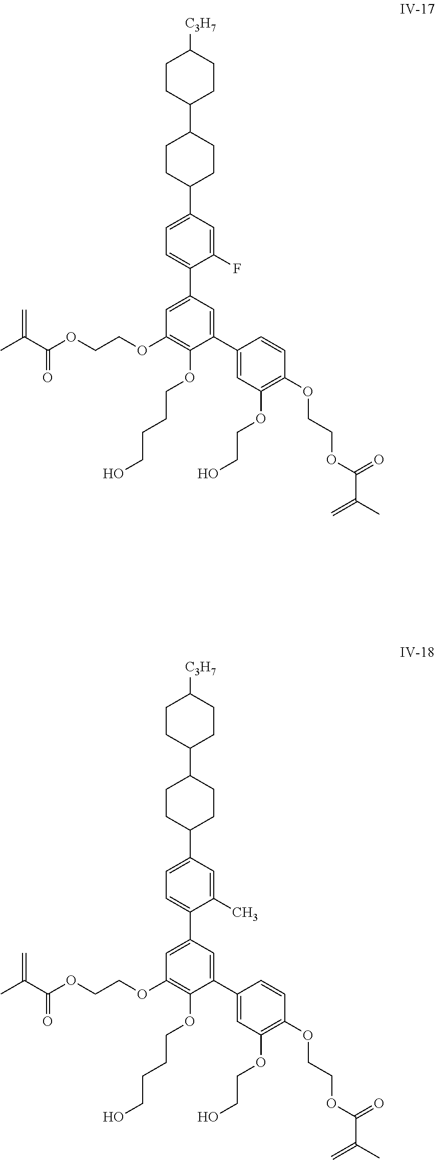

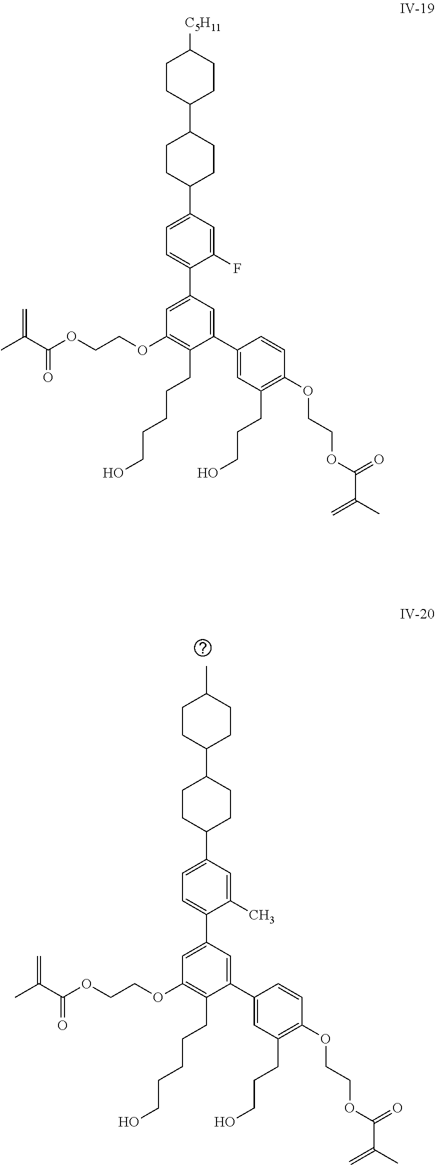

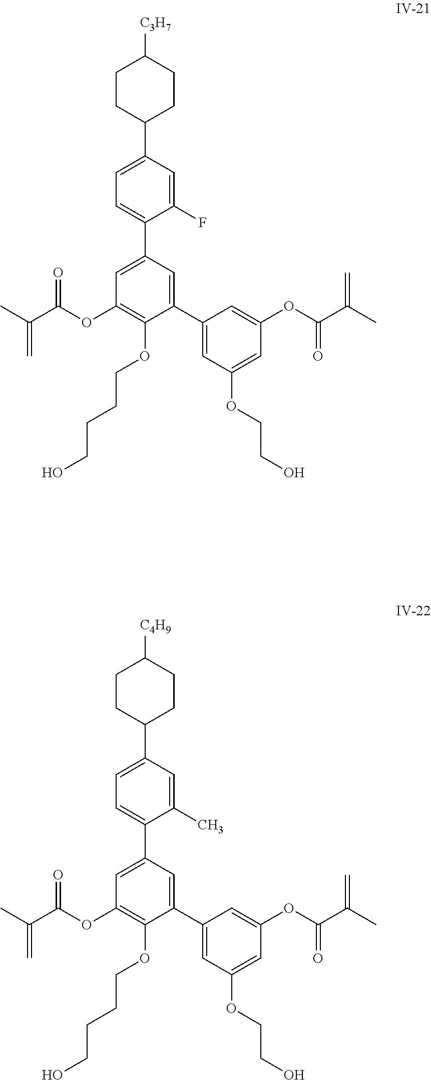

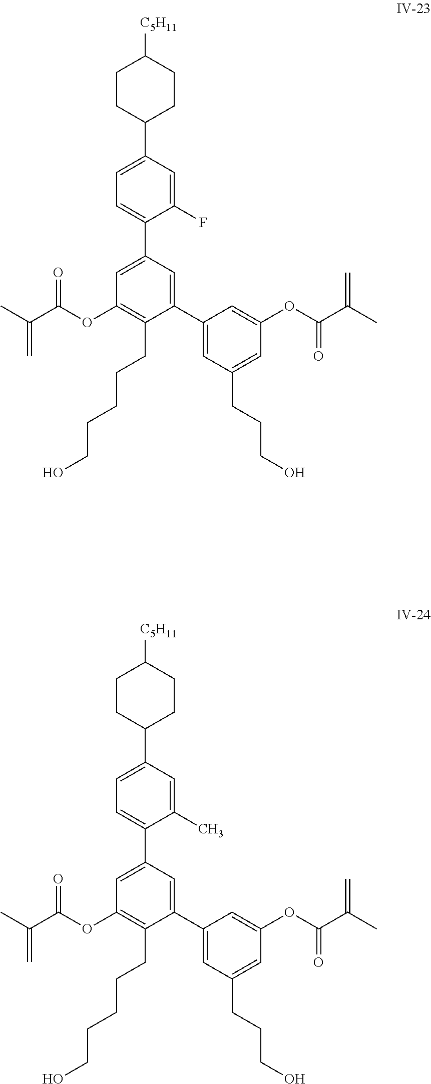

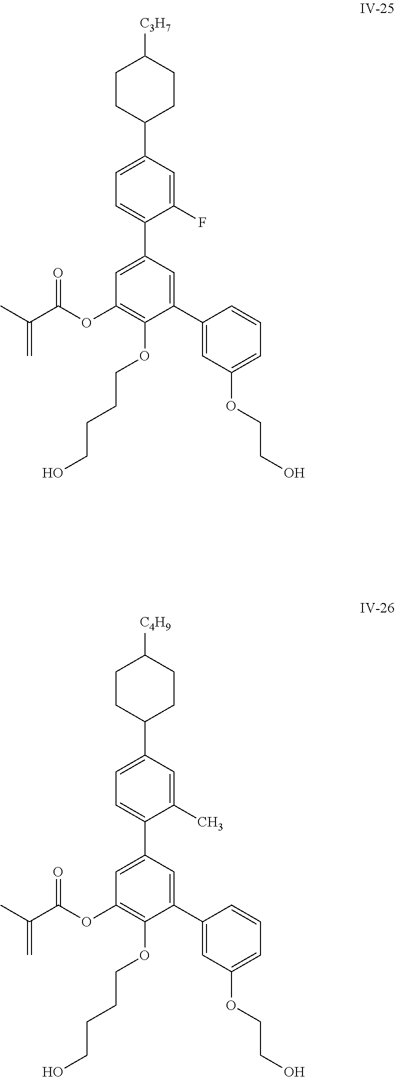

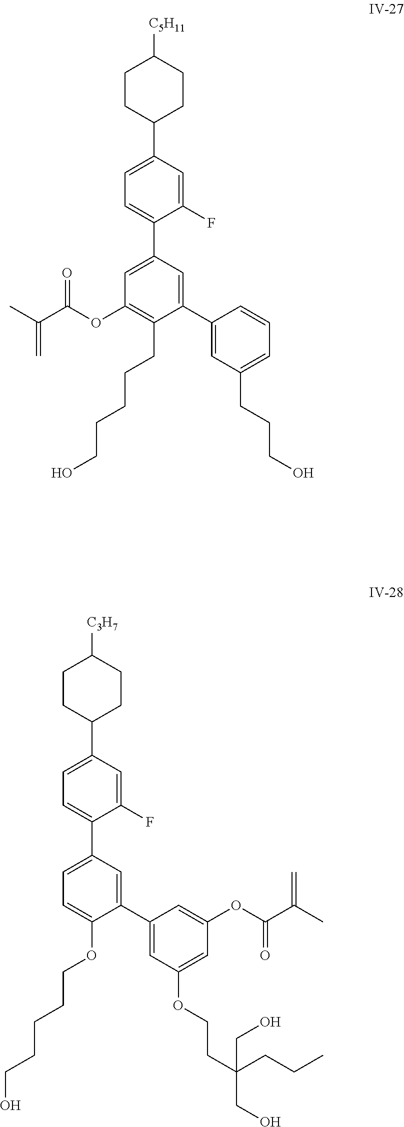

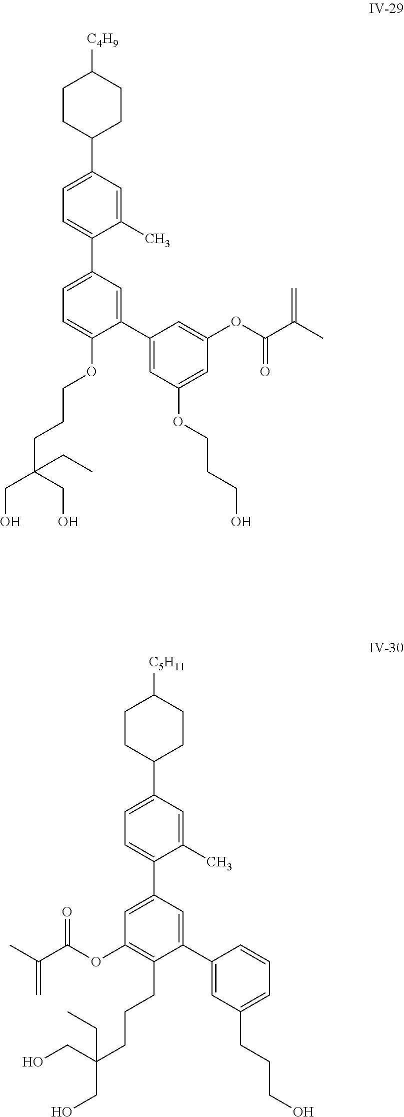

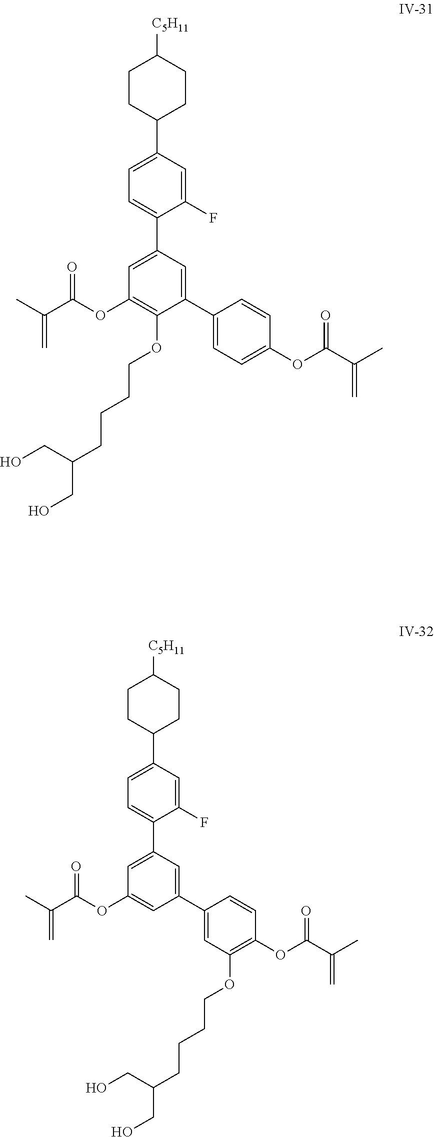

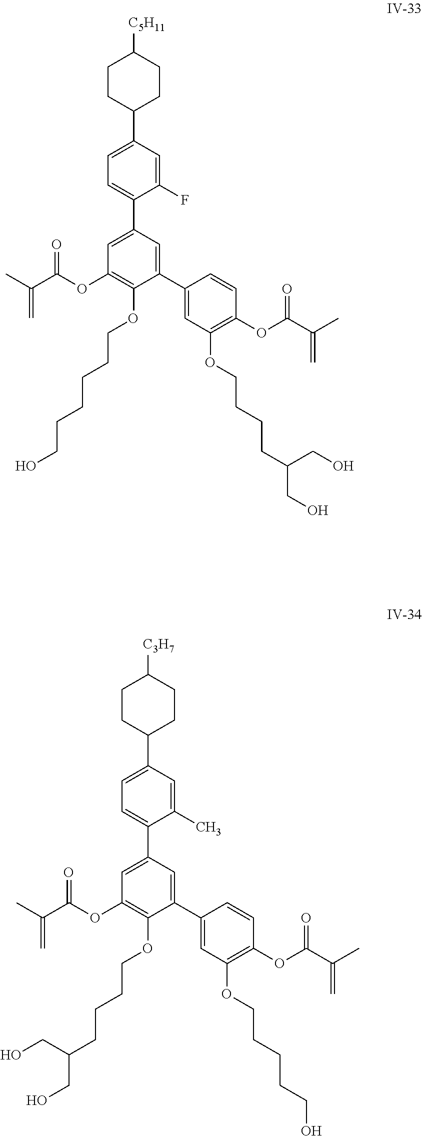

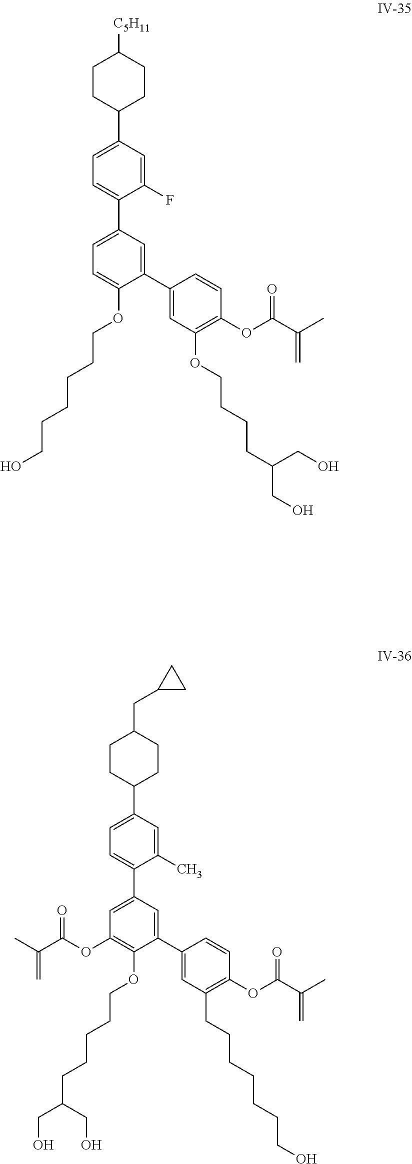

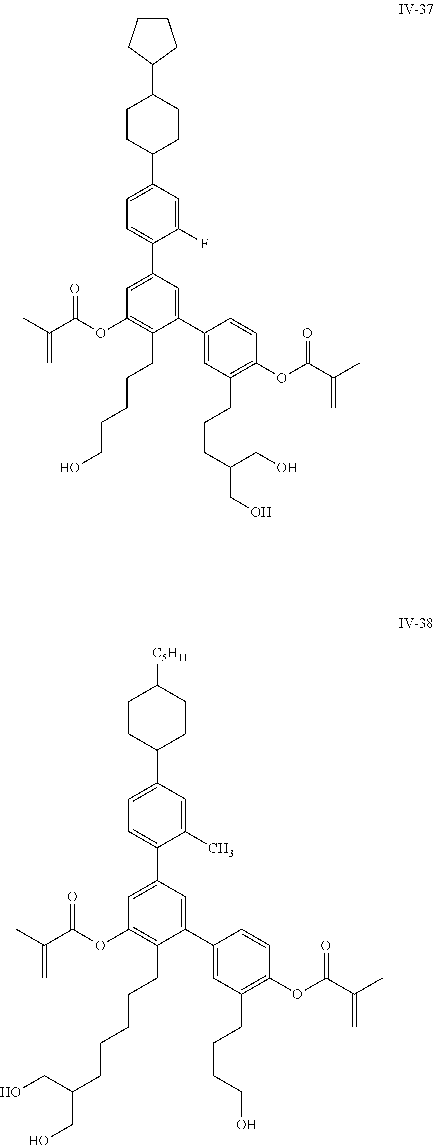

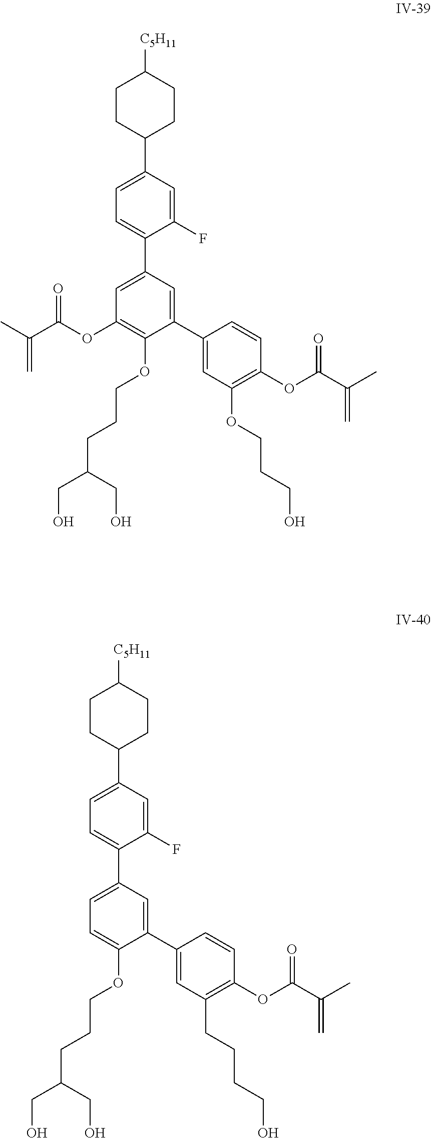

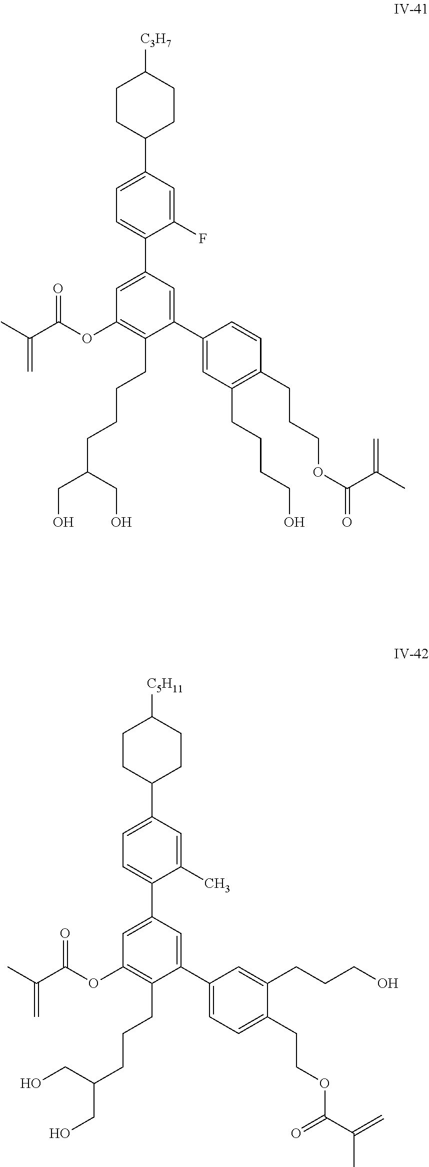

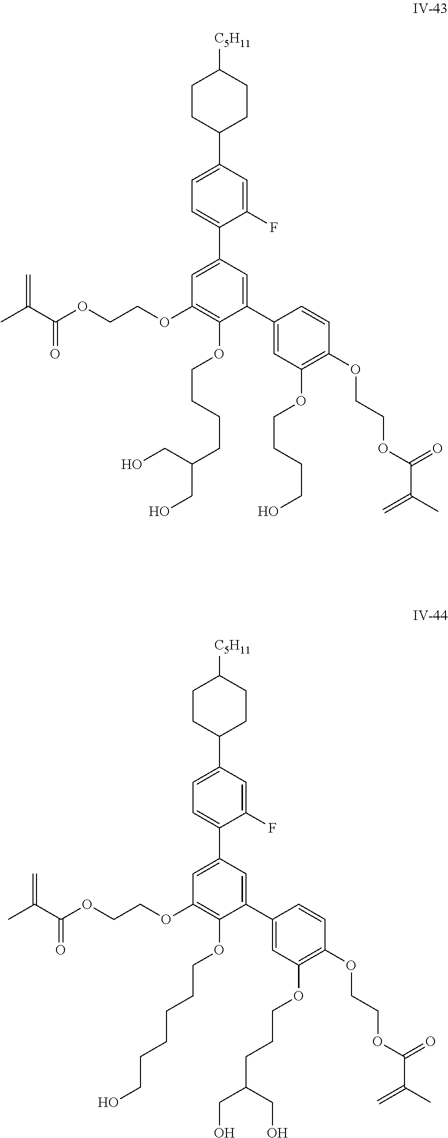

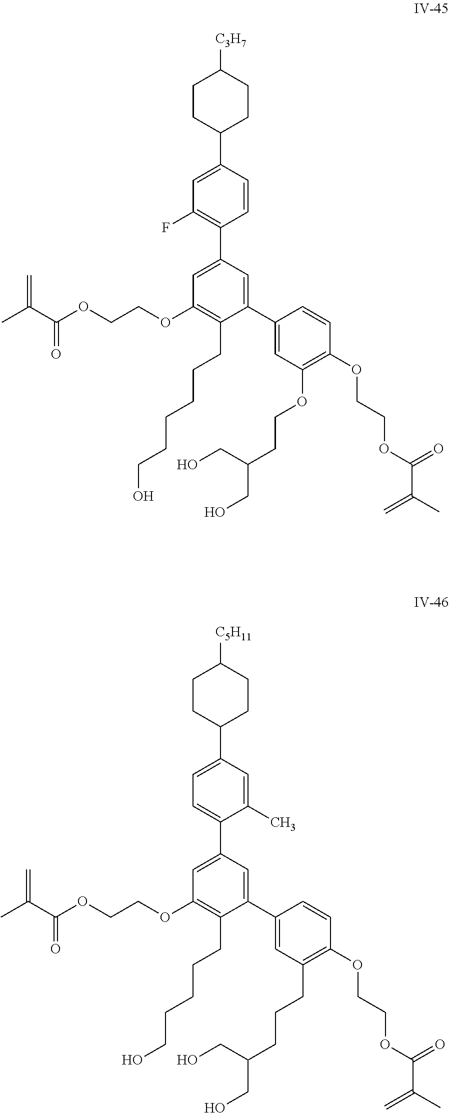

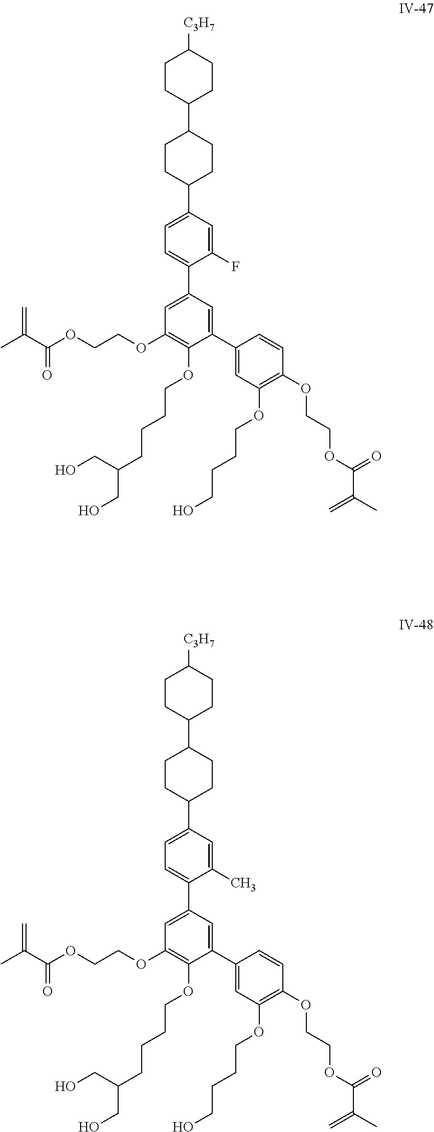

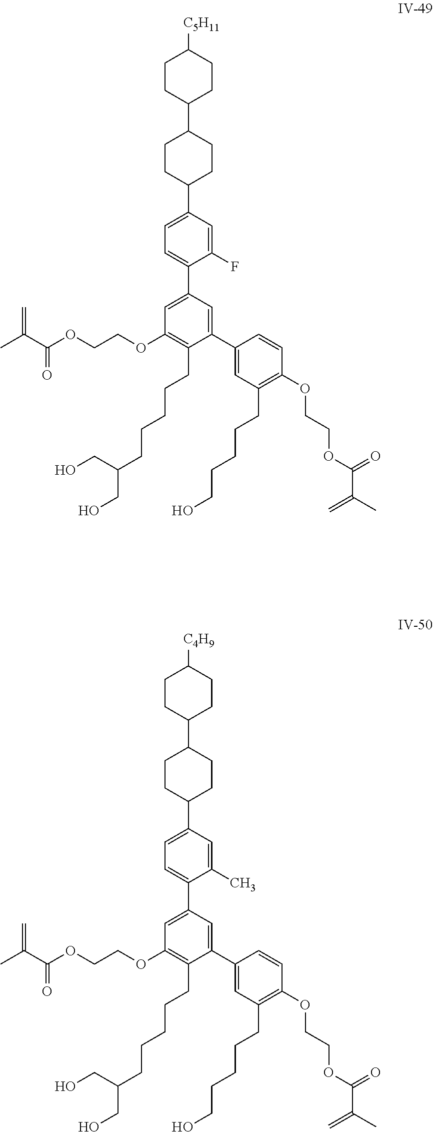

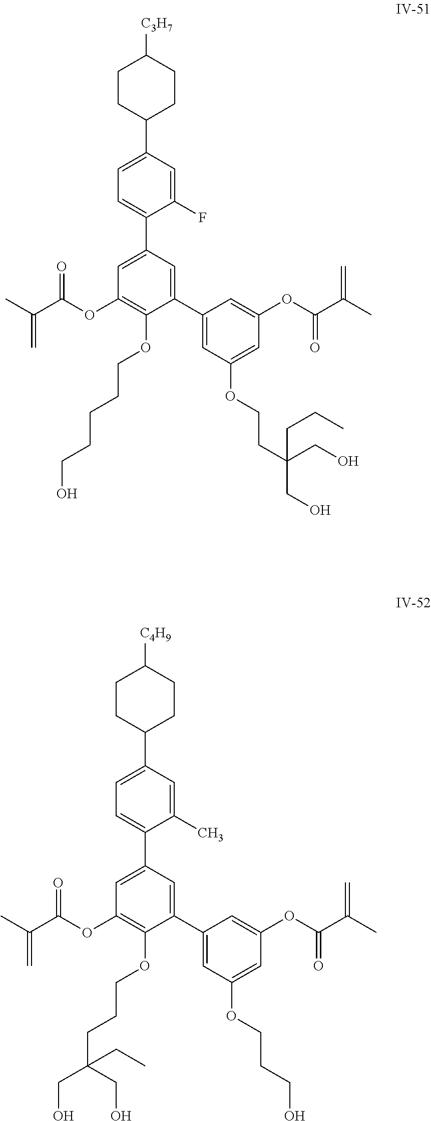

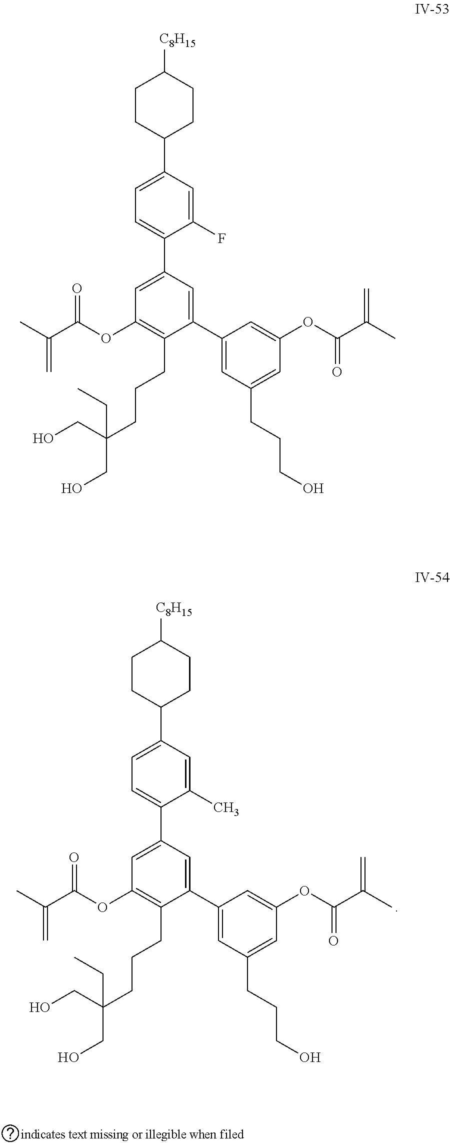

15. The liquid crystal composition of claim 1, wherein the second self-alignment additive in the liquid crystal composition ranges from 0.1% to 1.5% by mass.

16. The liquid crystal composition of claim 1, wherein the liquid crystal composition comprises at least one first self-alignment additive and the second self-alignment additive, wherein the first self-alignment additive is represented by the following formula III: 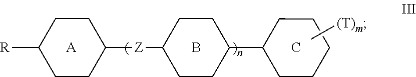
wherein 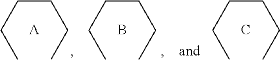
are independently selected from a substituted or unsubstituted aromatic group having 6-10 carbon atoms, or a substituted or unsubstituted cycloalkyl group having 6-10 carbon atoms;
R is selected from —H, a halogen atom, an alkyl group having 1-25 carbon atoms, an alkoxy group having 1-25 carbon atoms; provided that when R has one or more —CH₂— groups, the one or more —CH₂— groups are not substituted, or, the one or more —CH₂— groups in R are independently substituted by —O—, —S—, —CO—, —C(O)O—, —OC(O)—, —CH₂—CH₂—, —CH₂O—, or —OCH₂—, and heteroatoms therein directly linked to C are not directly linked to each other; and provided that when R has one or more H atoms, the one or more H atoms are replaced, or, the one or more H atoms in R are independently replaced with F, Cl, Br, or I;
Z is selected from —O—, —S—, —CO—, —CO—O—, —OCO—, —O—CO—O—, —OCH₂—, —CH₂O—, or —(CH₂)ₙ₁—, wherein n1 is selected from 1, 2, 3, or 4;
T is selected from 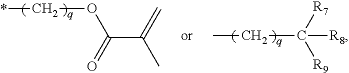
wherein R₇, R₈, and R₉ are independently selected from —OH, an alkyl group having 1-8 carbon atoms, and provide that when the alkyl group having 1-8 carbon atoms has one or more end groups, the one or more end groups are not substituted or substituted by —OH; when T has one or more —CH₂— groups, the one or more —CH₂— groups are not substituted or substituted by —O—; q is an integer from 0 to 8; and * indicates a linking site for linking T with 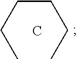
q is any integer from 0 to 8;
n is selected from 0, 1, 2, or 3; and
m is selected from 1, 2, 3, or 4

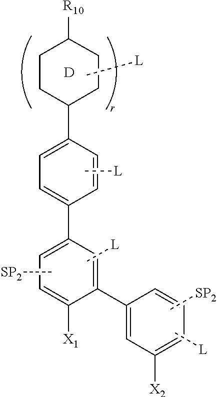

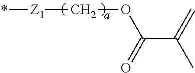

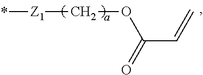

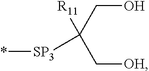

17. The liquid crystal composition of claim 16, wherein the liquid crystal composition comprises the first self-alignment additive and the second self-alignment additive in an amount ranging from 0.1% to 1.5% by mass.

18. The liquid crystal composition of claim 17, wherein the chiral agent in the liquid crystal composition ranges from 0.01% to 2.0% by mass.

19. A display panel comprising:
a first substrate;
a second substrate disposed opposite to the first substrate; and
a liquid crystal layer disposed between the first substrate and the second substrate, wherein the liquid crystal layer is prepared from at least the liquid crystal compound and the chiral agent as claimed in claim 1.

20. The display panel of claim 19, wherein when the display panel is configured in a first mode, the liquid crystal layer comprises a plurality of liquid crystal arrangement groups, and at least one of the liquid crystal arrangement groups comprises a plurality of liquid crystal molecules arranged in a direction from the first substrate to the second substrate; and
wherein orthographic projections of adjacent two of the liquid crystal molecules in one of the liquid crystal arrangement groups on the first substrate intersect with each other.
